(19) United States
(12) Patent Application Publication
(10) Pub. No.: US 2017/0095114 A1
(43) Pub. Date: Apr. 6, 2017

(54) Collapsible Cart

(71) Applicant: O'Shaughnessy Holding Company, LLC, Eden Prairie, MN (US)

(72) Inventors: Michael L. O'Shaughnessy, Eden Prairie, MN (US); Douglas Patton, Irvine, CA (US)

(21) Appl. No.: 15/262,733

(22) Filed: Sep. 12, 2016

Related U.S. Application Data
(63) Continuation-in-part of application No. PCT/US16/22697, filed on Mar. 16, 2016.
(60) Provisional application No. 62/364,769, filed on Jul. 20, 2016.
(60) Provisional application No. 62/133,682, filed on Mar. 16, 2015.

(51) Int. Cl. A47J 37/07; B62B 3/02

(52) U.S. Cl. CPC A47J 37/0763; B62B 3/022; A47J 2037/0777

(57) ABSTRACT

A compact and easy to assemble grill cart to support a collapsible grill cart that includes a base portion, side portions, and a top portion that can be stored in a compact, folded configuration. The collapsible cart can be expanded or unfolded to provide a stable structure that can support a cooking unit, such as a grill, grill insert, or firebox. Such a collapsible grill cart can also include doors that provide enclosed storage space within the expanded cart and wheels to facilitate transportation.

This application claims the benefit of priority to U.S. Provisional Patent Application No. 62/364,769, filed Jul. 20, 2016. This application is also a continuation-in-part of PCT/US16/22697, filed Mar. 16, 2016, which claims the benefit of priority to U.S. Provisional Patent Application No. 62/133,682, filed Mar. 16, 2015, the entire contents of which are incorporated by reference herein.

### FIELD OF THE INVENTION

The field of the invention is grill carts and barbeques.

### BACKGROUND

Grilling is a cooking style that is especially popular in the United States. But grills are not particularly portable or easy to set up, in part because the framework for the grill is large and fastened to the grill in a way that makes assembly and disassembly difficult.

Attempts have been made to design grills that are easy to assemble after unloading from shipping containers. For example, U.S. Pat. No. 8,602,017 (May) describes a grill comprising a firebox assembly, which includes a firebox base and a firebox hood, and a cart assembly. The cart assembly includes a large number of pieces: support assemblies, hinges, and linking members. However, assembly still requires numerous steps, and some parts must be screwed together. Moreover, the firebox assembly cannot be collapsed to reduce the volume of the disassembled grill and cart during storage and shipping.

One solution disclosed in U.S. Pat. No. 8,316,837 (Malumyan) is to mount the grill on a foldable stand. However, even in the folded configuration, the wheels and handle of the grill take-up extra space. Moreover, the stand requires two hands to set-up, and in at least some circumstances, one-handed assembly is desirable.

The closest reference uncovered is U.S. Pat. No. 5,065,734 (Elliott), which discusses a portable grill having collapsible legs (albeit in a reverse manner). In addition, US 2006/02257 (Rinaldo) and US 2004/0020482 (Chen) describe similar concepts.

Thus, a need exists for a portable, easy to set up stand-alone grill cart.

### SUMMARY OF THE INVENTION

The present invention provides apparatus, systems, and methods of an easy to assemble grill cart for a barbeque or other grill. In one aspect of the inventive subject matter, the device preferably includes a base portion, side portions, and a top portion that can be readily stored and transported in a compact conformation in which these portions are essentially parallel to one another. The grill cart can be expanded, for example by unfolding through rotation of the various portions, to provide a stable structure suitable for supporting a cooking unit. In some embodiments a portion of the collapsible grill cart (for example, a top portion) can be incorporated into or coupled to a cooking unit such as a grill, grill insert, or fire box.

In preferred embodiments, the base frame provides a support platform for the other components. For example, the two side frames preferably couple to opposite ends of the base frame, preferably by a hinge or another suitable rotating or pivoting connection. In some embodiments, the base frame has two or four movably coupled support arms.

In one embodiment a collapsible grill cart can be provided as a set of coupled panels. In such an embodiment a single large panel (for example, a back panel) can be provided as a hinged panel that can be unfolded to provide a planar panel that is perpendicular to a base panel. Side panel that are perpendicular to such a back panel can be rotated out from opposing edges of the base panel to couple to a top panel or frame to form an open rigid structure. In some embodiments one or more doors can be coupled to the exposed edges of the side panels to provide an enclosed storage space. In some embodiments a cooking unit can form part of or be coupled to the top portion of the collapsible cart.

In another embodiment of the inventive concept a base portion is coupled to a pair of frames that oppose one another and are arranged to rotate outwards to a position that is essentially perpendicular to the base portion. A large panel can be positioned perpendicular to the base portion and coupled to opposing edges of these two frames, and a top portion can be position parallel to the base portion coupled to these two frames in order to form a stable structure. A side panel can be coupled to each of the frames to provide further support and stability. In some embodiments one or more doors can be coupled to the remaining free edges of the frames (for example, opposing the large panel) in order to provide an enclosed storage space within the collapsible cart. In some embodiments a cooking unit can form part of or be coupled to the top portion of the collapsible cart.

### BRIEF DESCRIPTION OF THE DRAWING

FIG. 1A depicts an embodiment of a grill cart before it is deployed, with a grill resting on top of it.

FIG. 1B depicts the same embodiment as in FIG. 1A where the grill cart is not yet deployed.

FIG. 1C depicts the same embodiment as FIG. 1A with the side frames deployed.

FIG. 1D depicts the same embodiment as FIG. 1A with the support arms deployed.

FIG. 1E depicts the same embodiment as FIG. 1A fully deployed and with the grill fastened on top.

FIGS. 2A-N depict a telescoping slot and connector type grill cart and provide step-by-step views at different stages of cart deployment.

FIGS. 3A-B depict a grill nesting in a cart.

FIGS. 4A-B depict a grill mounted on a cart using drawer glides.

FIGS. 5A-J depict a flat-pack slot-fit type grill cart and provide step-by-step views at different stages of cart deployment.

FIGS. 6A-I depict an X-riser type grill cart and provide step-by-step views at different stages of cart deployment.

FIGS. 7A-H depict an X-riser type grill cart with telescoping legs and provide step-by-step views at different stages of cart deployment.

FIGS. 8A-C depict an X-riser type grill cart with a single handed button release and provide step-by-step views at different stages of cart deployment.

FIGS. 9A-J depict a grill cart with folding legs and provide step-by-step views at different stages of cart deployment.

FIGS. 10A-K depict another grill cart with folding legs and provide step-by-step views at different stages of cart deployment.

FIGS. 11A-J depict a grill cart that features single motion expansion, a fully collapsible grill firebox hood, and provide step-by-step views at different stages of cart deployment.

FIGS. 12A-M depict a grill cart that features single motion expansion and provide step-by-step views at different stages of cart deployment with and without the grill.

FIGS. 13A-I depict a grill cart that features single motion expansion with a drawer glide mounted grill and provide step-by-step views at different stages of cart deployment.

FIGS. 14A-G depict a grill cart that can be deployed with one hand and provide step-by-step views at different stages of cart deployment.

FIGS. 15A-I depict a jack-type grill cart and provide step-by-step views at different stages of cart deployment.

FIGS. 16A-K depict an embodiment of a folding grill cart at various stages of assembly, and provide step-by-step vies of the assembly process.

FIGS. 17 A-G depict another embodiment of a folding grill cart at various stages of assembly, and provide step-by-step vies of the assembly process.

### DETAILED DESCRIPTION

Each of the figures of this application show the same embodiment of a cart 100 while in different stages deployment. Grill carts described in this application enhance the portability of a grill by providing a detachable framework that can be quickly and easily packed into a compact configuration for either storage or transportation, and can also be quickly and easily deployed to set up a grill.

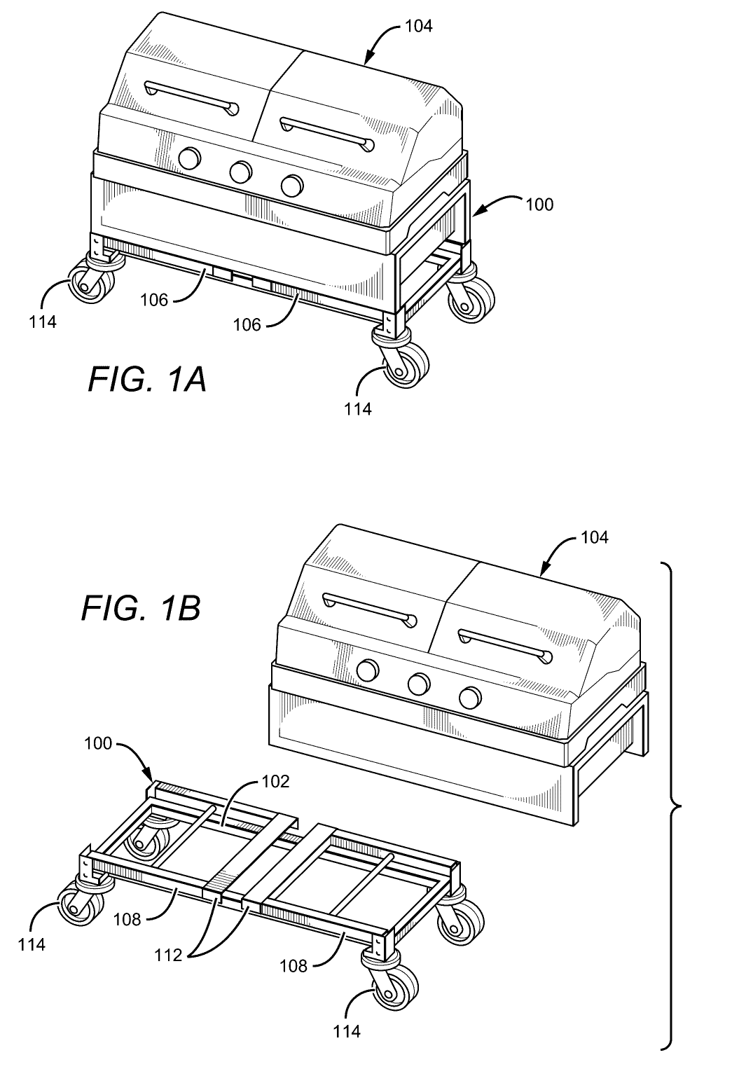

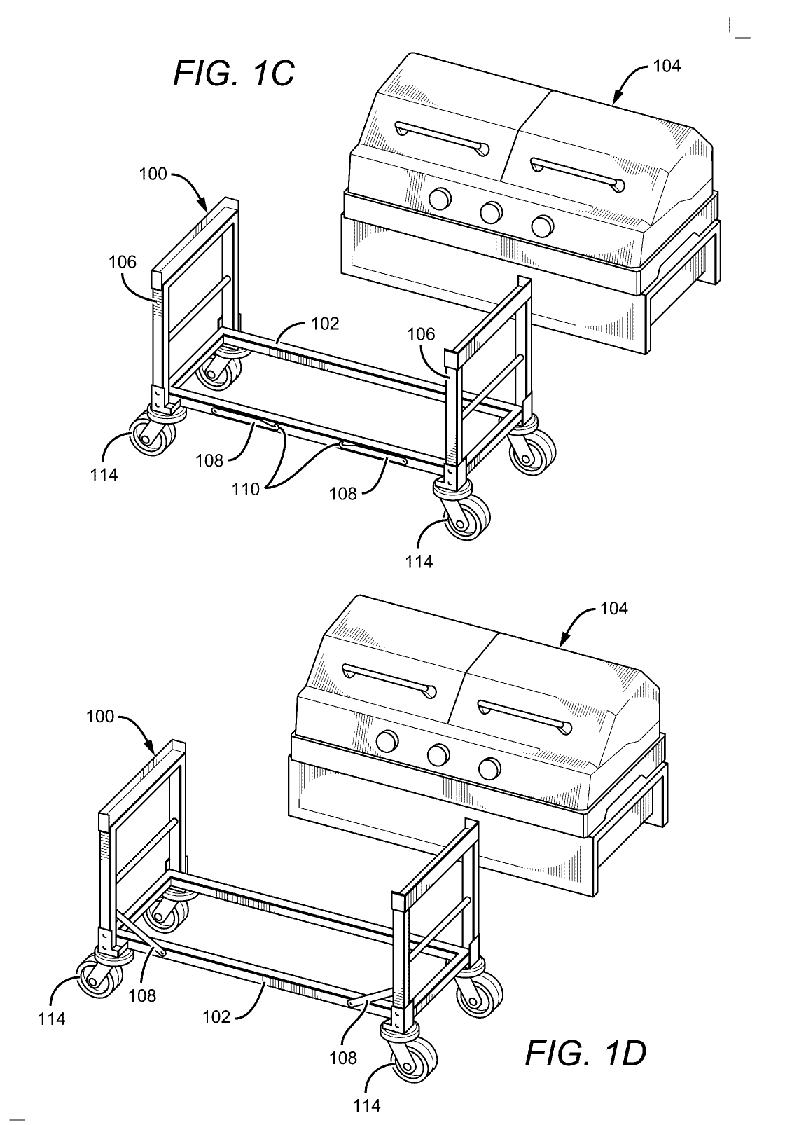

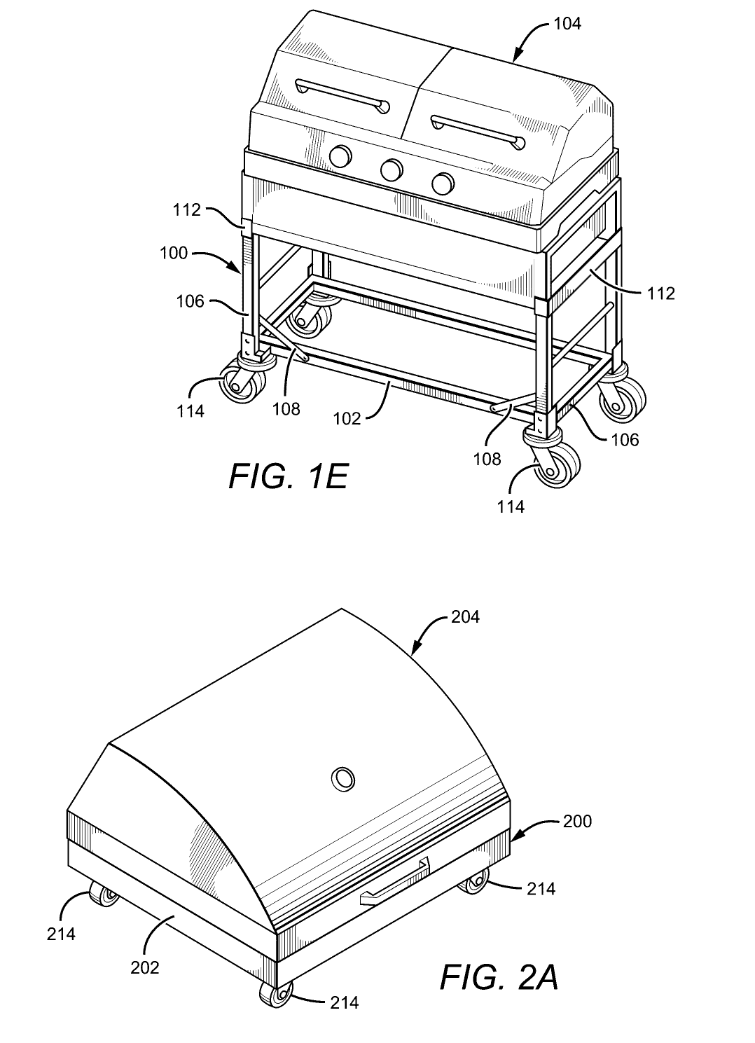

The base frame 102 of the cart 100 can be seen in FIGS. 1A-E. Each figure shows a different stage of deployment. In FIG. 1A, the cart 100 is folded up with a grill 104 resting on top. FIG. 1B shows the grill 104 lifted off the top of the undeployed cart 100. FIG. 1C shows the side frames 106 deployed. FIG. 1D shows the support arms 108 in position. And FIG. 1E shows the grill 104 placed on top of the fully deployed cart 100. In preferred embodiments, the base frame 102 is a rectangular metal frame. The base frame 102 can optionally include structural components to provide sheer strength (not pictured), but those components can generally be made unnecessary by using a strong material to build the base frame 102 (e.g., steel).

Preferably, the base frame 102 is approximately the same size as the grill 104 that the cart 100 is designed to support. However, the base frame 102 can vary in size without departing from the inventive concepts described in this application. It is more important that the base frame 102 provide stability for the cart 100 than it have a particular size and shape.

To create a cart 100 that has some mobility, the base frame 102 can additionally include wheels 114. In rectangular configurations, such as those shown in FIGS. 1A-E, the wheels 114 can be placed at each corner of the base frame 102. However, in some embodiments mobility is not as important and the wheels 114 can be replaced with static structural components (e.g., pegs, or extended portions of the base frame 102).

In preferred embodiments, the base frame 102 also includes components designed to facilitate connection with two side frames 106. The side frames 106 are designed to fold up and down. When the side frames 106 are up, they provide a platform for a grill 104 to rest on top of (as shown in FIG. 1E), and when the side frames 106 are down, a grill 104 can rest on top of the side frames 106 and the base frame 102 (as shown in FIG. 1A).

The side frames 106 can be coupled with the base frame 102 by, for example, hinges, by slots fitting over pegs, or by any other means now known in the art that can allow the side frames 106 to rotatably couple to the base frame 102. It is sufficient that the side frames 106 are coupled with the base frame 102 such that they can fold down to lie against the base frame 102 and also be rotated upward to form approximately a right angle to the plane of the base frame 102.

In other embodiments, the deployed position of the side frames 106 is not vertical (i.e., the side frames 106 do not create approximately a 90 degree angle with the base frame 102). The side frames 106 can alternatively be deployed to some angle away from vertical (e.g., 5-10, 10-15, 15-20, 20-25, 25-30 degrees from vertical in either direction).

The side frames 106 are preferably formed to be less than the half the length of the base frame 102, as seen best in FIG. 1B where the side frames 106 are folded down. By creating the side frames 106 to have a length (as measured from the point where the side frame couples with the base frame 102 to the end of the side frame that is the farthest from the base frame 102) that is less than half of the length of the base frame 102, both of the side frames 106 can be folded down toward each other without overlapping and causing unwanted interference. However, other embodiments of the cart 100 include side frames 106 that are longer than half of the length of the base frame 102 to provide a taller deployed cart 100. The side frames 106 can have a length that is, for example, 75-70%, 70-65%, 65-60%, 60-55%, 55-50%, 50-45%, 45-40%, 40-35%, 35-30% the length of the base frame 102, where the length of the base frame 102 is measured between the ends where the side frames 106 couple to the base frame 102.

In preferred embodiments, the side frames 106 additionally include components to allow a grill 104 to fasten to the cart 100. FIG. 1B, for example, shows side frames 106 having hooks 112 that enable fasteners on the grill 104 to couple to the cart 100. FIG. 1E shows the fasteners on the cart 100 coupling to the hooks 112.

In other embodiments, the side frames 106 can themselves have fasteners instead of hooks 112. By providing fasteners (e.g., latching fasteners, elastic fasteners, screwing fasteners) on the side frames 106, the grill 104 need only have receiving components (e.g., hooks, or protrusions). Another way to fasten the cart 100 to the grill 104 would be to have small rotating arms with hook portions that swivel up to the grill 104 to hook onto a protrusion (e.g., a protrusion formed into the structure of the grill 104, or a screw that sticks out). This fastening method can also be reversed so that the swiveling arms with hooks are on the grill 104 with the receiving protrusions on the tops of the side frames 106.

In some embodiments, the side frames 106 are not two pieces as shown in FIGS. 1A-E. Instead each side frame can include two separate legs that extend independently of the other.

To provide shear strength for the cart 100 when the side frames 106 are deployed, in preferred embodiments, support arms 108 couple the side frames 106 to the base frame 102. At least two support arms 108 are necessary (one for each of the side frames 106), but including additional support arms 108 would not be a departure from the inventive concepts described in this application. The support arms 108 can be rotatably coupled to the base frame 102 by a hinge or any other connector known in the art. When the side frames 106 are deployed, the support arms 108 can then couple with the side frames 106 to provide structural rigidity to the cart 100.

In other embodiments the support arms 108 are rotatably coupled with the side frames 106, and when the side frames 106 are deployed the support arms 108 can then couple with the base frame 102. One way to couple the support arms 108 with either the side frames 106 or the base frame 102 is by providing a hook portion on each support arm 108 and a peg on the component the support arm 108 is to be coupled to, so that the hook can go over the peg. This configuration can be seen in FIG. 1C, where each support arm 108 has a hooked end 110 to couple with a peg on each of the side frames 106 (not shown).

In another aspect of the inventive subject matter, the cart 100 can forego support arms 108 entirely. In these embodiments, the side frames 106 can be locked into the deployed position by a pin or a clip (e.g., when the side frame is moved into the upright position, it clicks or locks into place by a suitable component known in the art).

In any embodiment described above, an additional top piece can be used to couple the tops of the side frames 106. This top piece (not shown) can be a flat piece that creates a top platform or surface, or it can be a frame (e.g., with cross members to provide structural rigidity to the top piece). By including the top piece, the cart 100 gains additional shear rigidity, which is especially preferable in embodiments where the side frames 106 include independently deployable legs. The top piece can couple to the tops of the side frames 106 by fitting around the tops of the side frames 106 and optionally covering the tops of the side frames 106 (e.g., the top piece has slots that receive the tops of the side frames 106, where the slots are either configured as through holes or as upside down cup pieces).

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

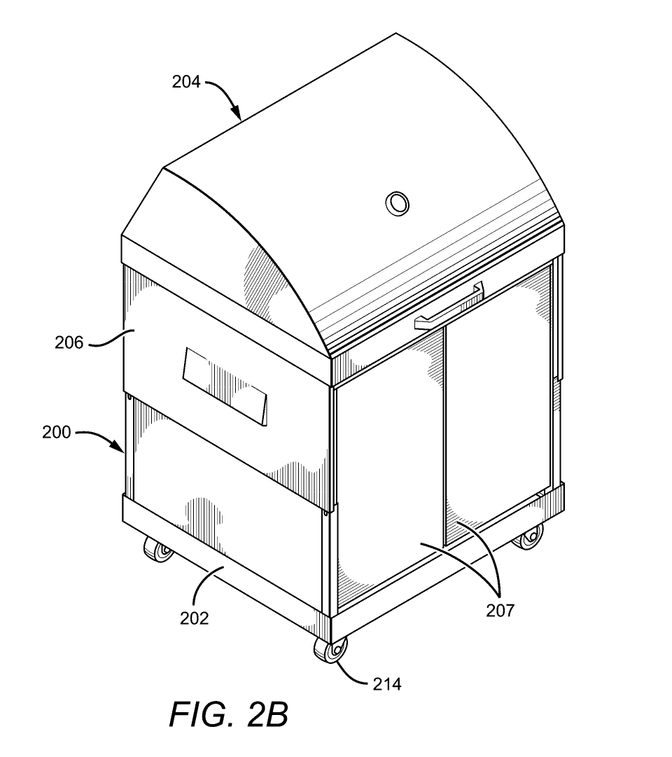

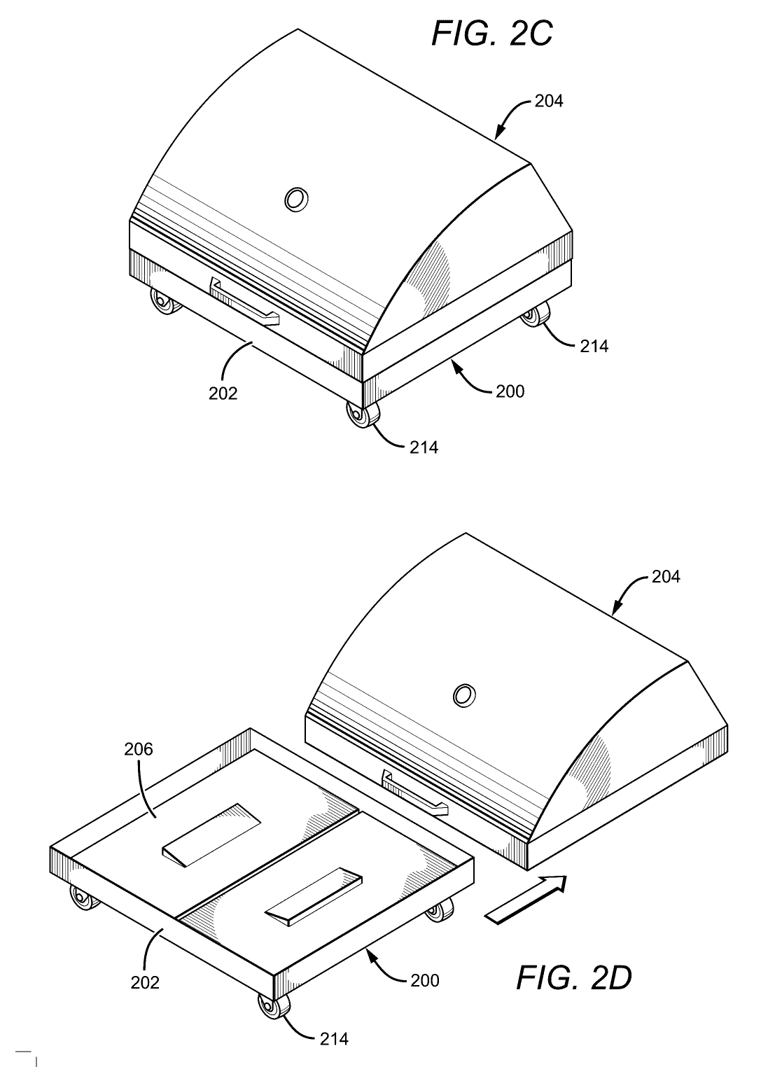

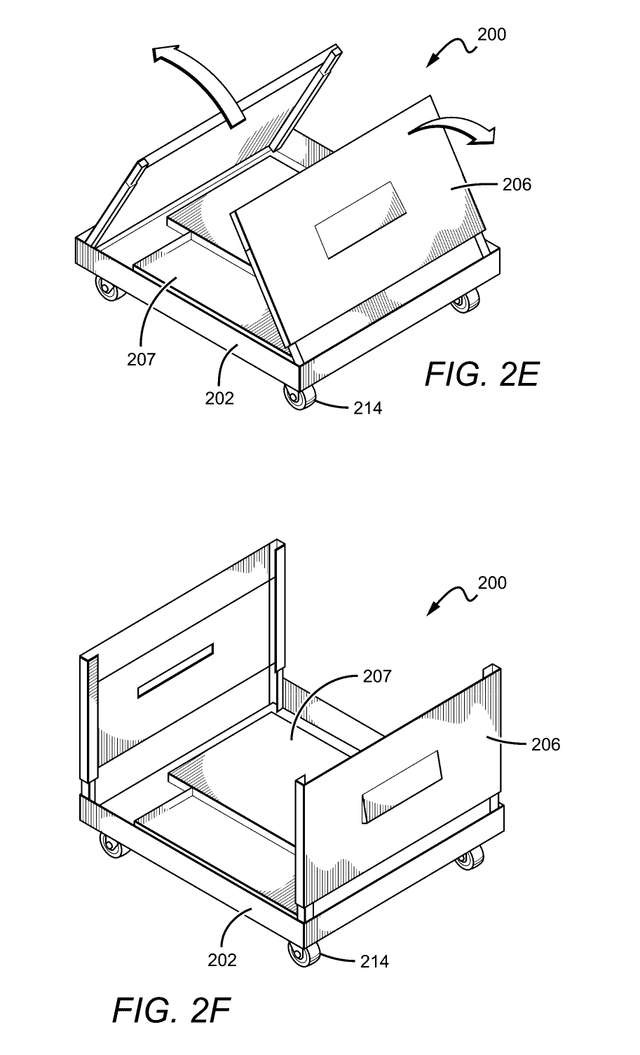

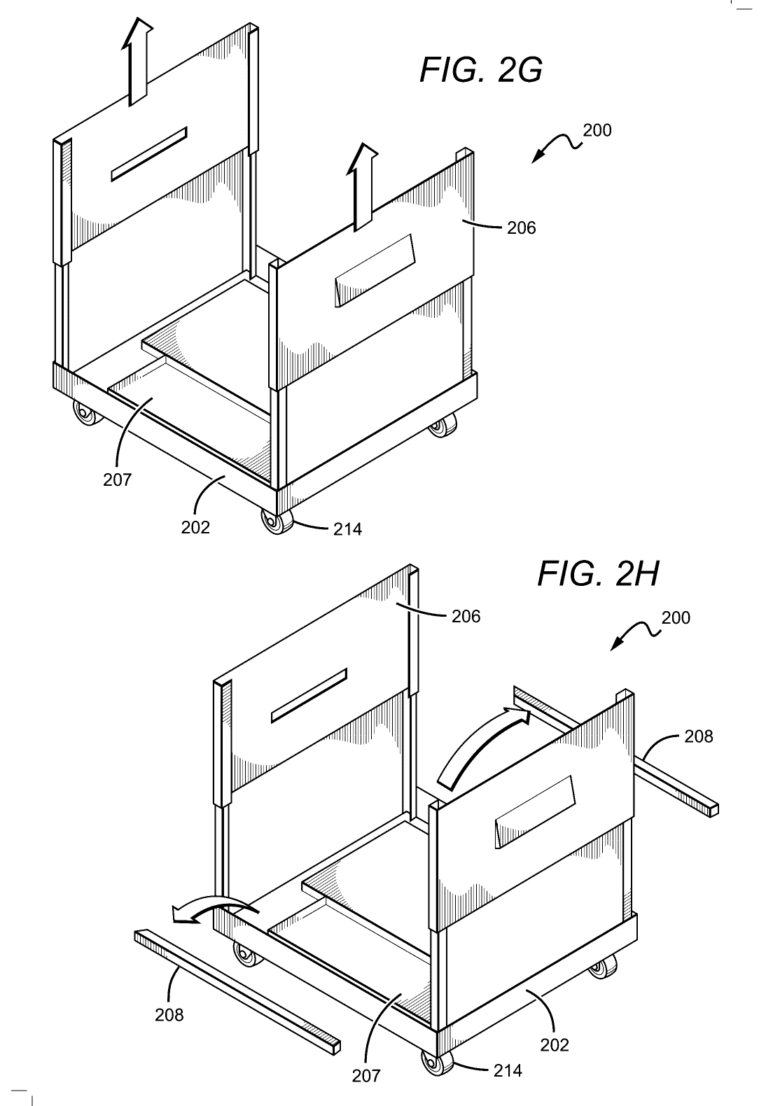

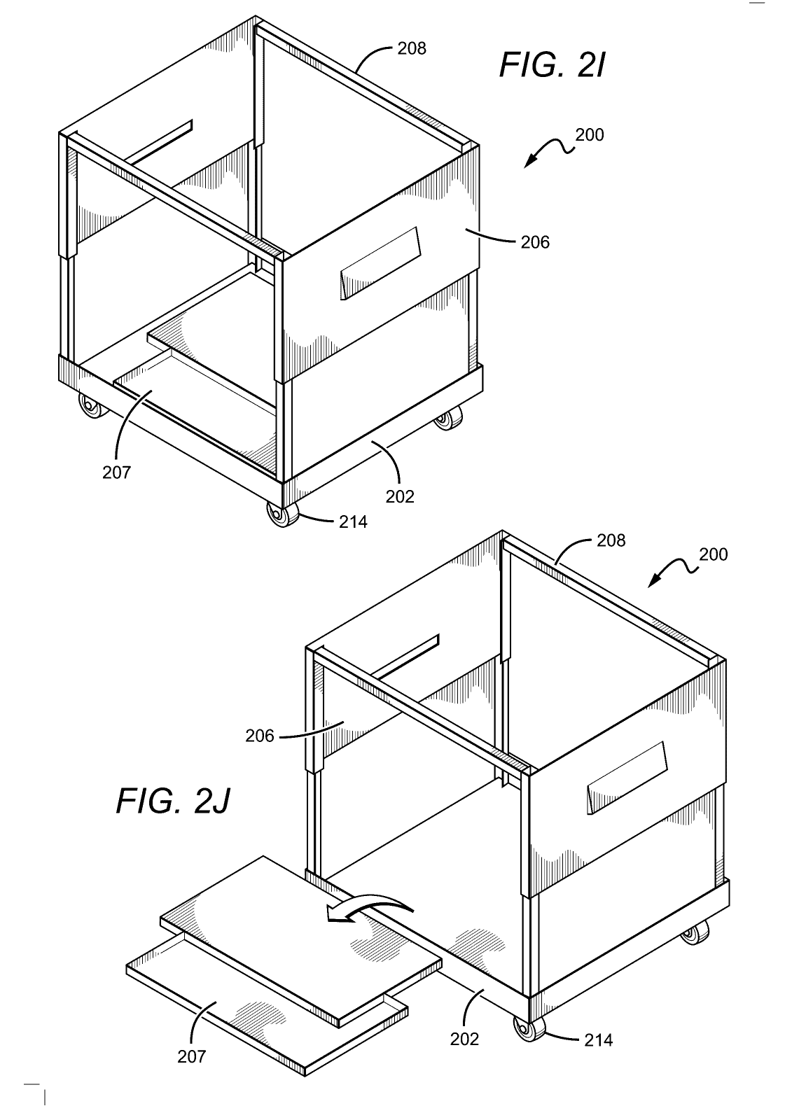

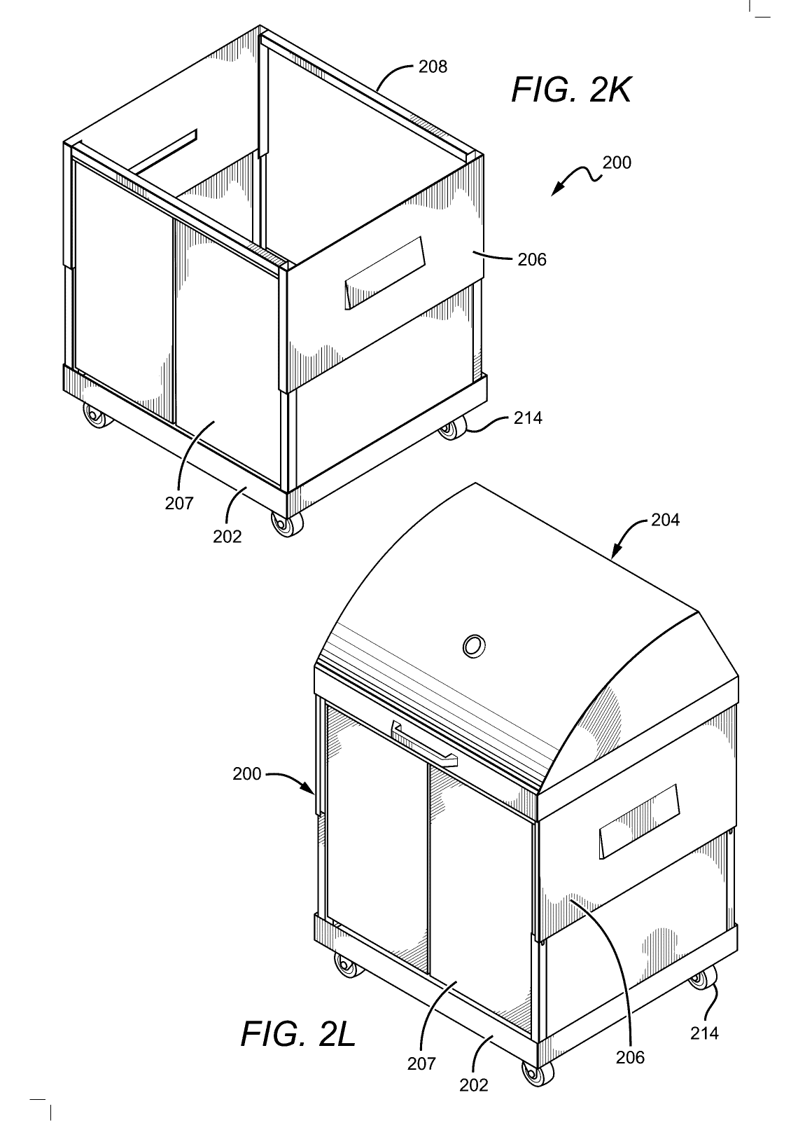

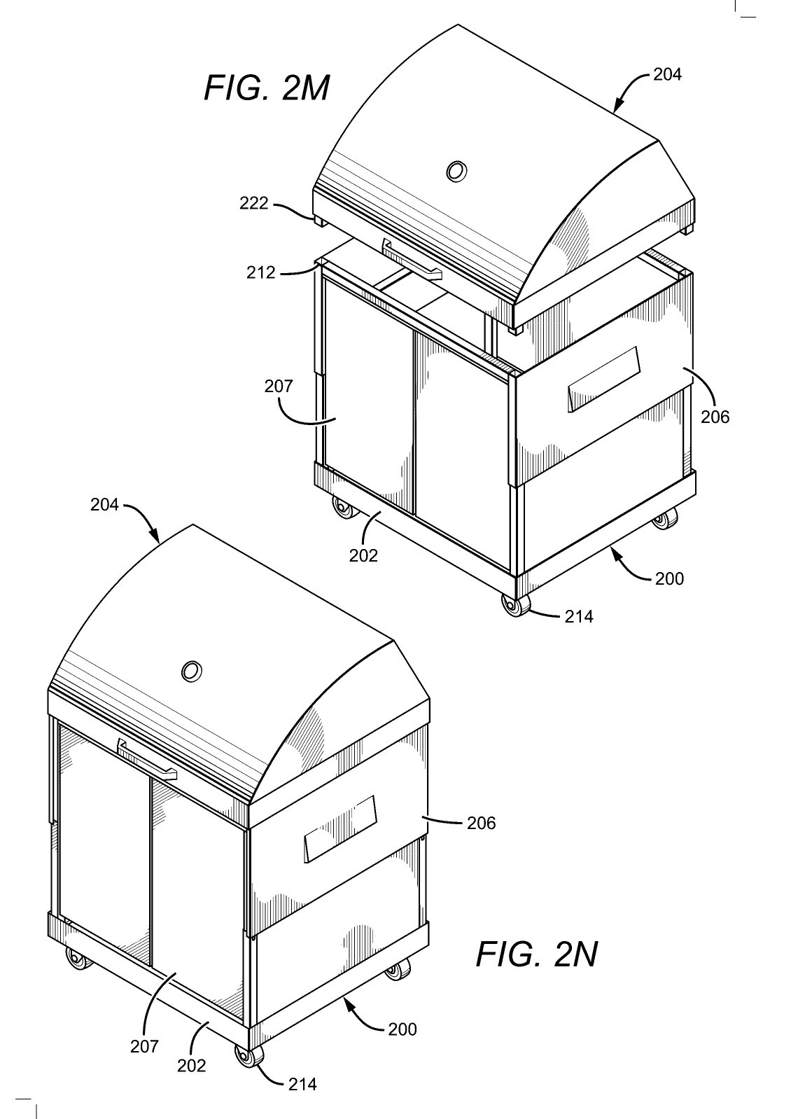

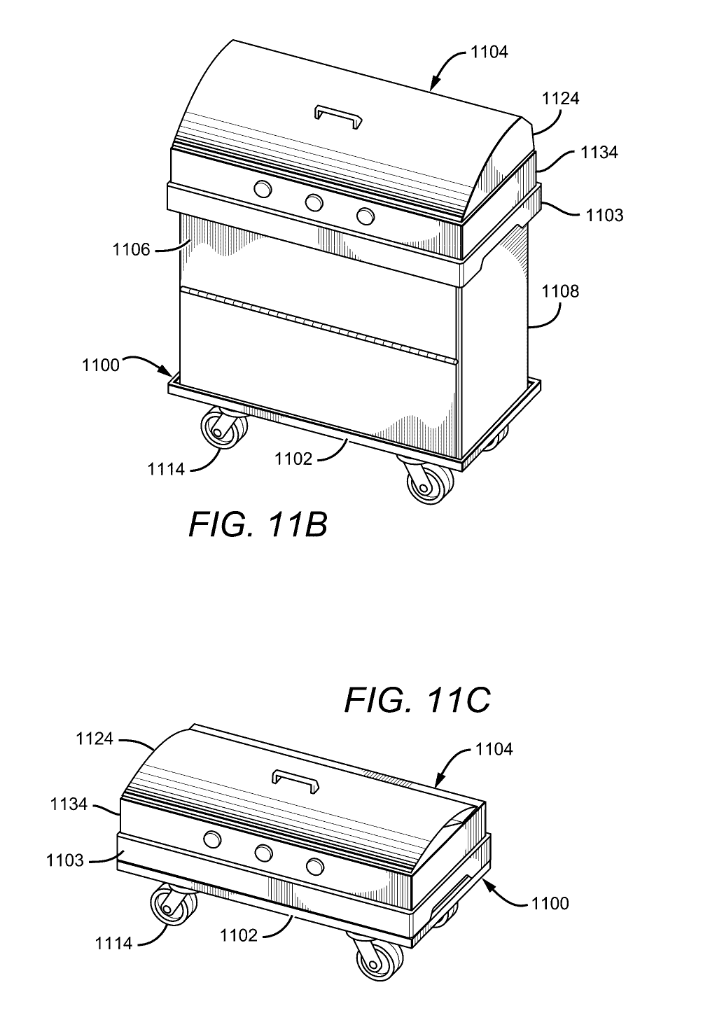

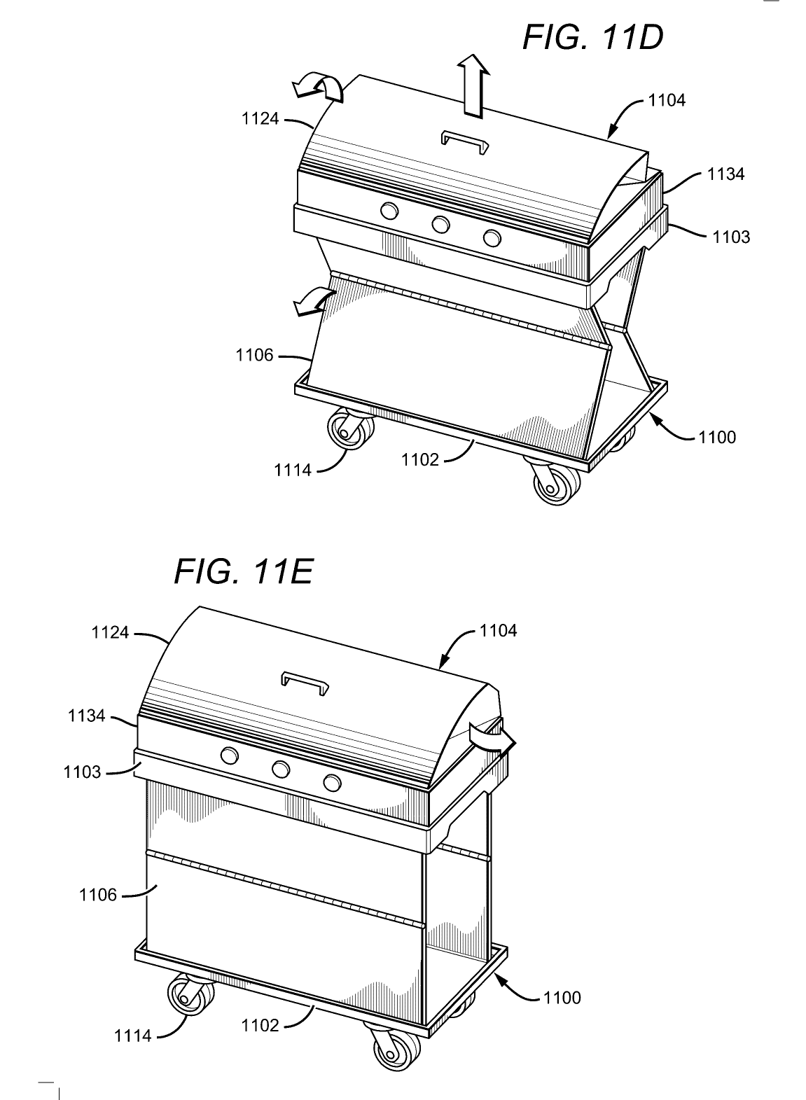

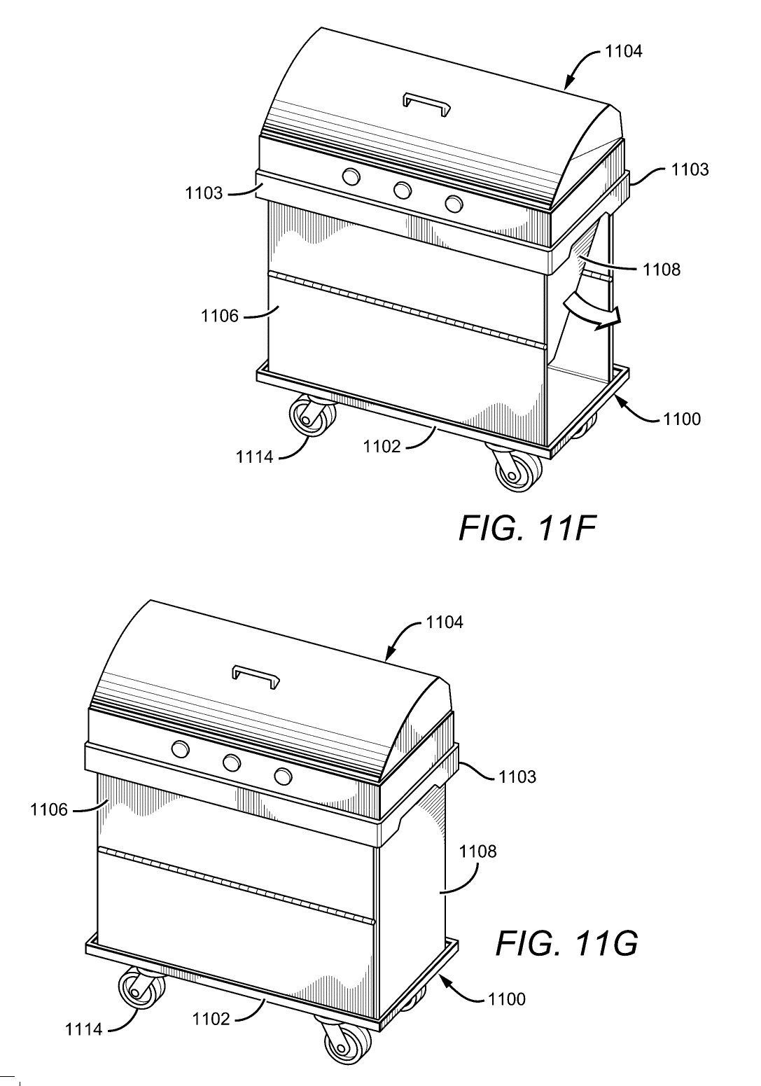

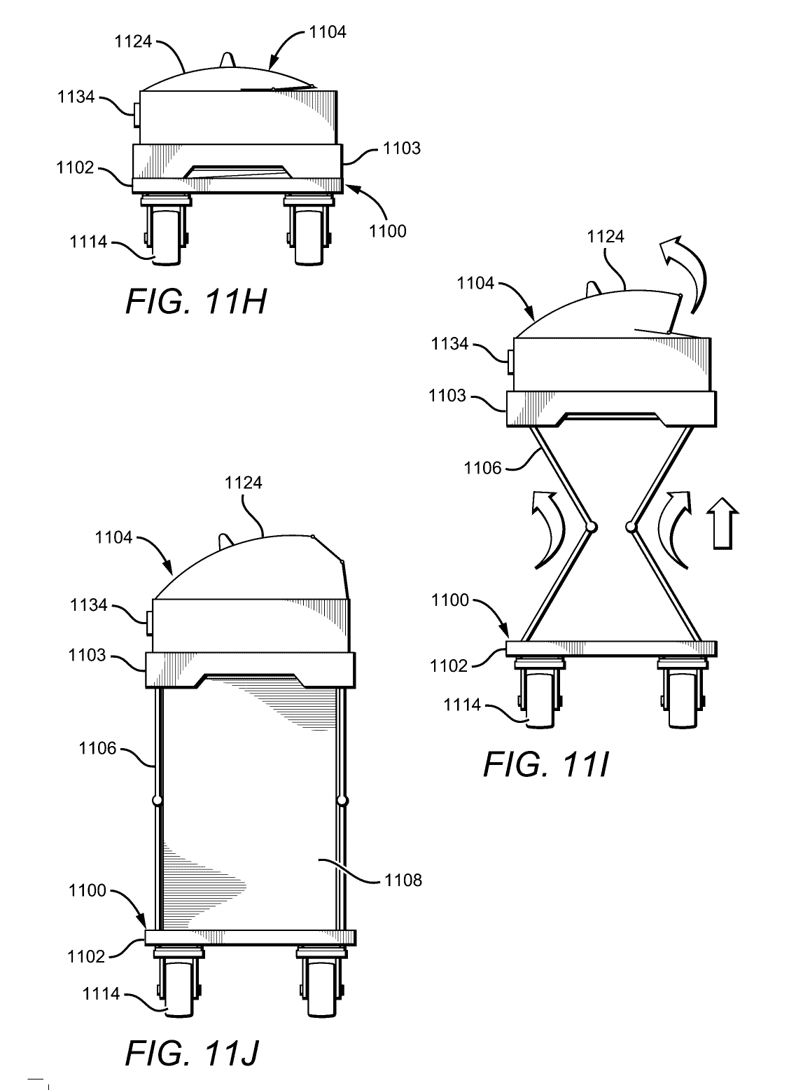

In another embodiment, telescoping slot and connector side frames are employed as shown in FIGS. 2A-N. In FIG. 2A, cart 200 is in the collapsed configuration for shipping/storage. Cart 200 includes base frame 202 and optionally includes wheels 214. Grill 204 (comprising a firebox base and firebox hood) is shown stacked on collapsed cart 200. One having skill in the art would appreciate that the firebox hood can be further collapsed (see e.g., FIG. 11) to save space during shipping and/or storage.

Cart 200 is shown in the fully deployed configuration in FIG. 2B. Telescoping side frames 206 support grill 204, and doors 207 are installed at the front of cart 200. Different stages of deployment are shown in FIGS. 2B-N. The right perspective view of cart 200 in the collapsed configuration is shown in FIG. 2C. To deploy the cart, the grill 204 is removed from collapsed cart 200 and set aside (FIG. 2D). Left and right side frames 206 are folded up (FIG. 2E). Next, each side frame is expanded in a telescoping fashion (FIGS. 2F-G). Preferably, each side frame locks automatically as it reaches the fully extended state, although other locking mechanisms (e.g., pin/dowel in hole, spring snap clip, screw) are not excluded. In regard to the left and right side frames, the left and right side frames can also comprise three or more telescoping panels. Additionally, the inventors contemplate that non-telescoping panels can be employed in collapsible grill carts consistent with the inventive subject matter.

Support arms 208 are inserted in grooves at the top of the left and right side frames across the top of the front and back of the grill cart (FIGS. 2H-I). Support arms 208 may also be coupled to side frames 206 by other suitable means (e.g., screws). As shown in FIGS. 2J-K, doors 207 are installed at the front of the grill cart by appropriate means (e.g., hinge pins). Alternatively, doors 207 can be mounted on base frame 202 and/or support arms 208. Grill 204 is then positioned on top of the cart (FIG. 2L). FIG. 2M shows one mode of securing grill 204 to fully deployed cart 200. Pegs 222 disposed on the bottom of grill 204 insert into holes 212 in side frames 206. Advantageously pegs 222 can also secure grill 204 to collapsed cart 200 via holes 212 to facilitate shipping and storage. A right side perspective view of assembled grill cart 200 and grill 204 is shown in FIG. 2N. In subsequent figures, like numerals refer to like structures.

Typically, contemplated grills comprise firebox hoods and firebox bases. Each firebox base further comprises one or more griddles and one or more burners, wherein the burners are configured to couple with gas regulators, which in turn are configured to couple with standard propane tanks. It should be appreciated that any suitable means of coupling grills to carts according to the inventive subject matter may be employed.

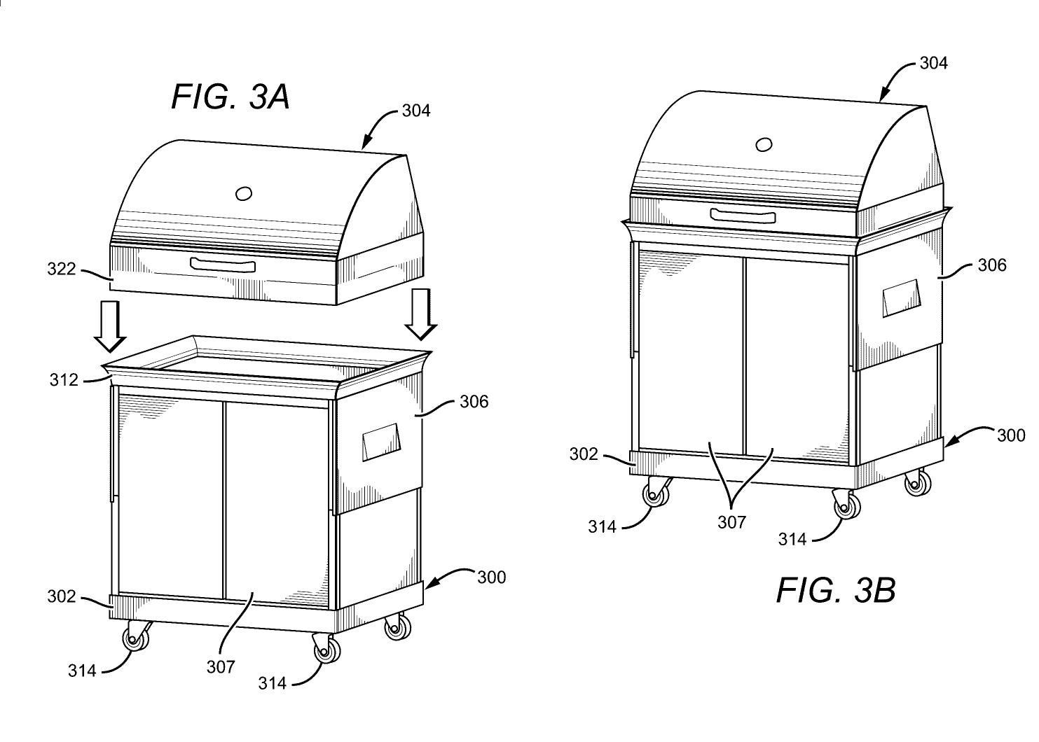

For example, the firebox base can nest in a lip extending at least partially around the circumference of the cart top. FIGS. 3A-3B show a nesting top configuration for securing grill 304 to cart 300. Cart 300 has flaring lip 312, which extends around the perimeter of the cart top. The inventors also contemplate the flared pieces could also extend from the corners or the edges of the top of the cart without extending along the entire length of each edge of the cart top. Firebox base 322 of grill 304 is sized and dimensioned to nest within lip 312. It should be appreciated that a flared lip (or flared pieces) may also be disposed on grill 304 such that the top of cart 300 nests within the flared lip disposed on the grill. Like numerals refer to like structures.

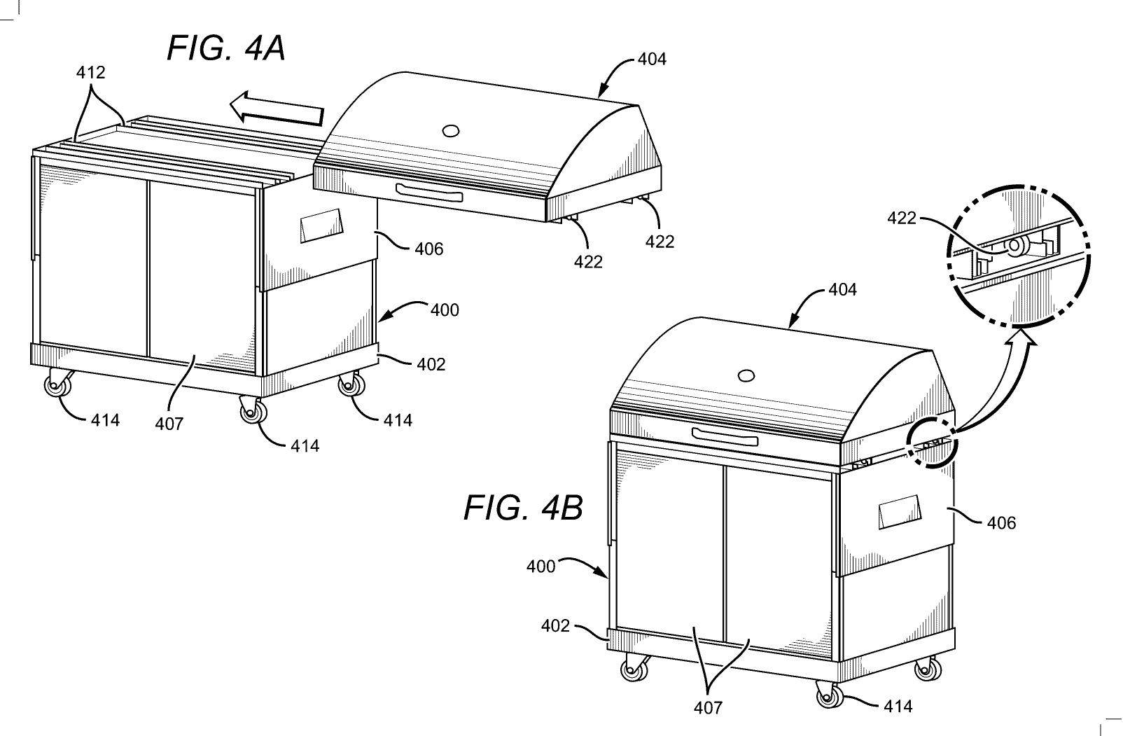

In a preferred embodiment of the inventive grill cart, drawer glides facilitate installation of the grill on the cart. FIG. 4A shows drawer glides 412 mounted on the top of cart 400. Wheels 422 installed on the bottom of grill 404 can be positioned in catches at the ends of drawer glides 412. Once positioned, wheels 422 roll along drawer glides 412 as shown in FIG. 4B. Preferably, once grill 404 is aligned on cart 400, it automatically locks into position. To prevent the grill from sliding off or uncoupling from the cart, the firebox base may be secured to the cart using latches or other suitable means. Like numerals refer to like structures.

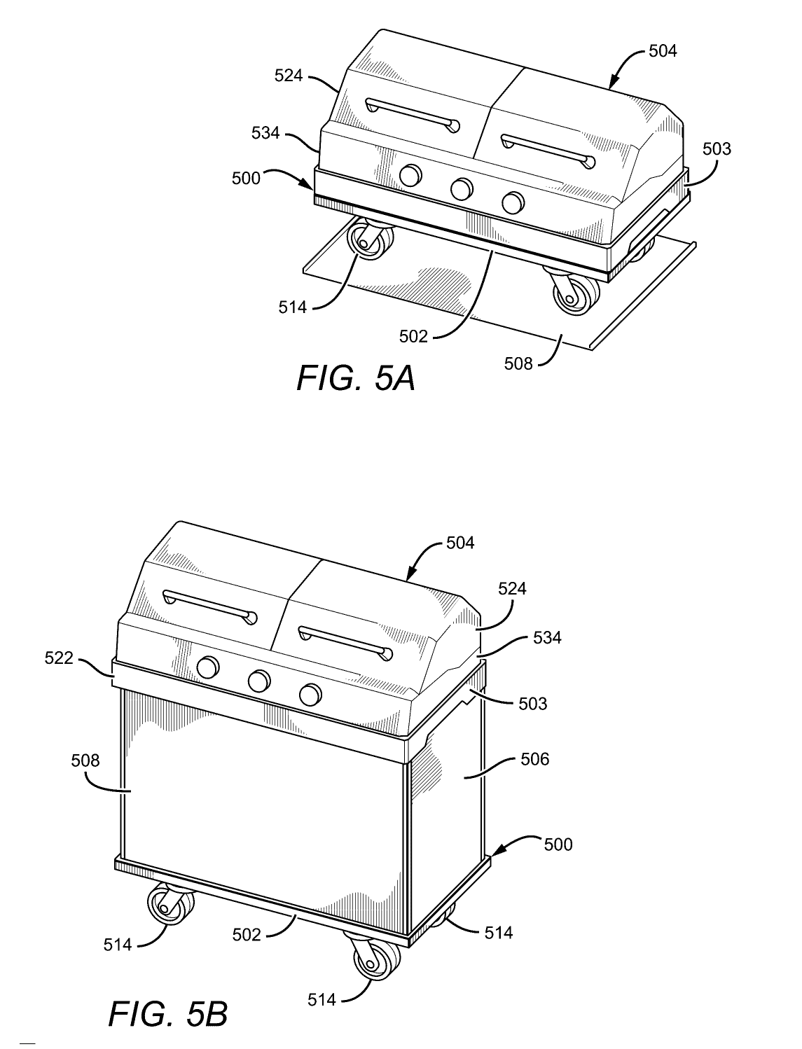

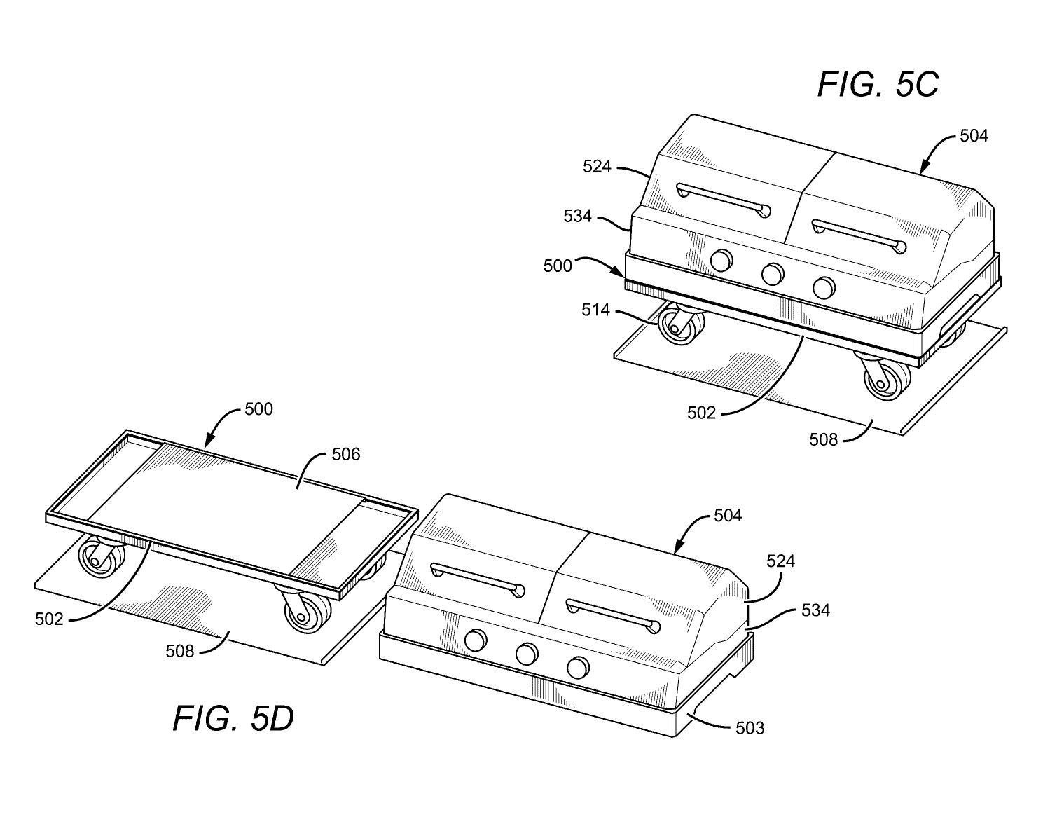

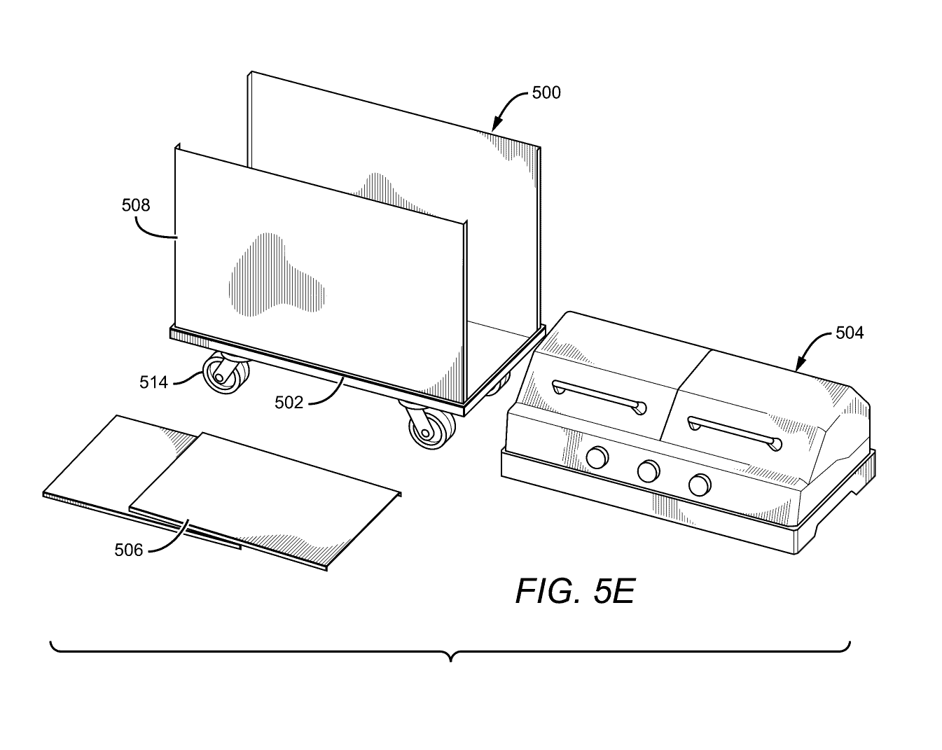

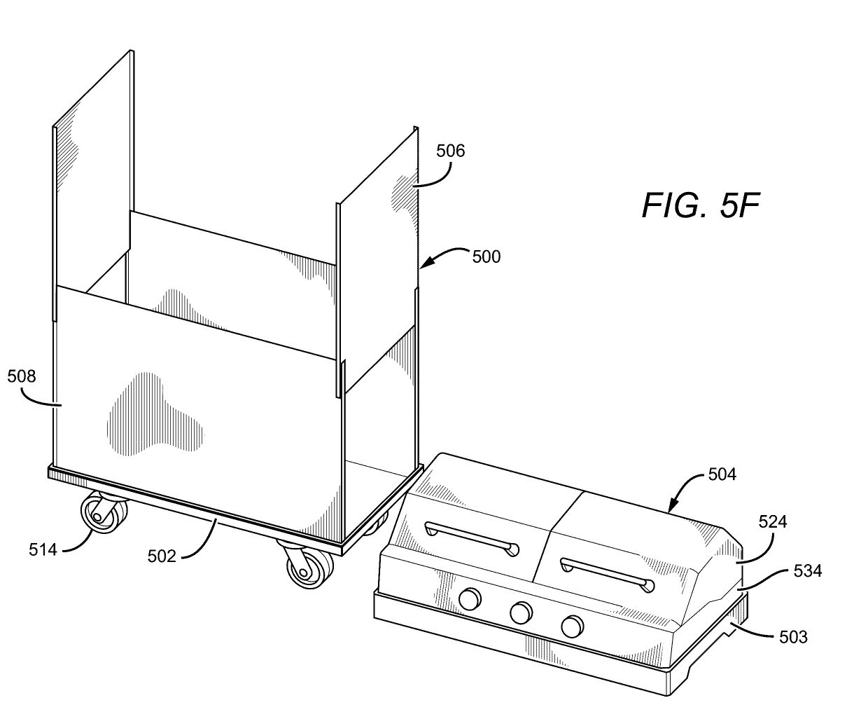

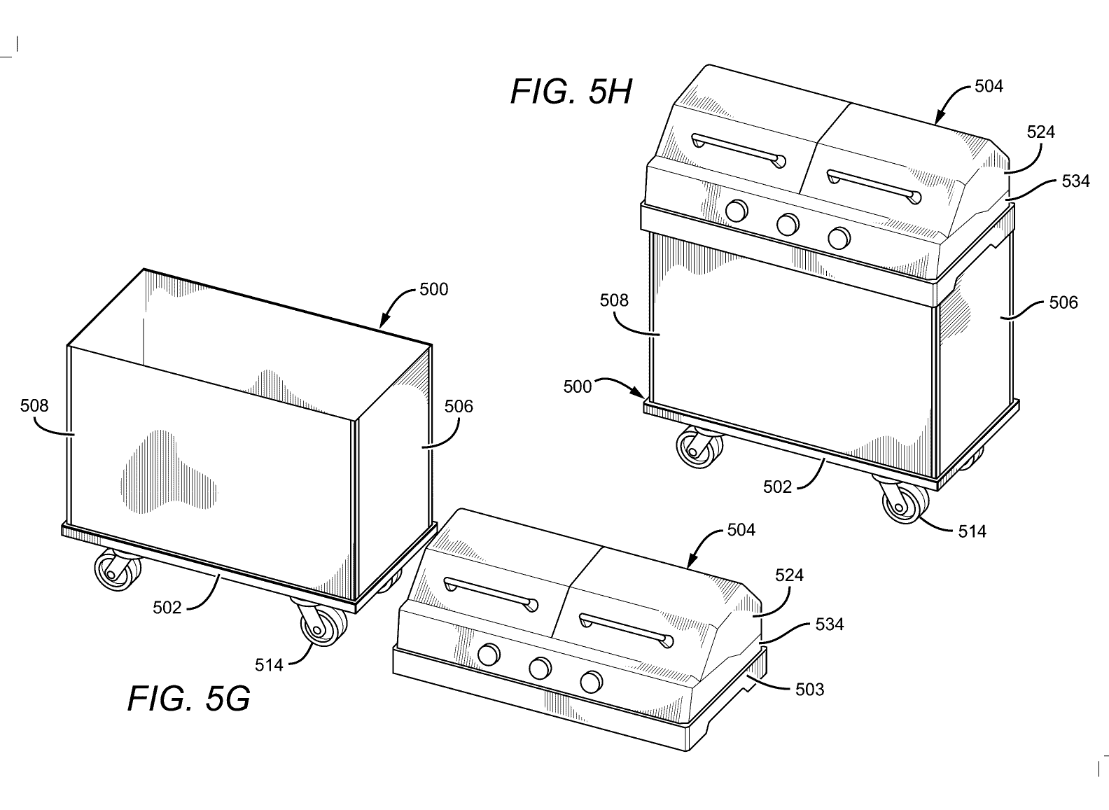

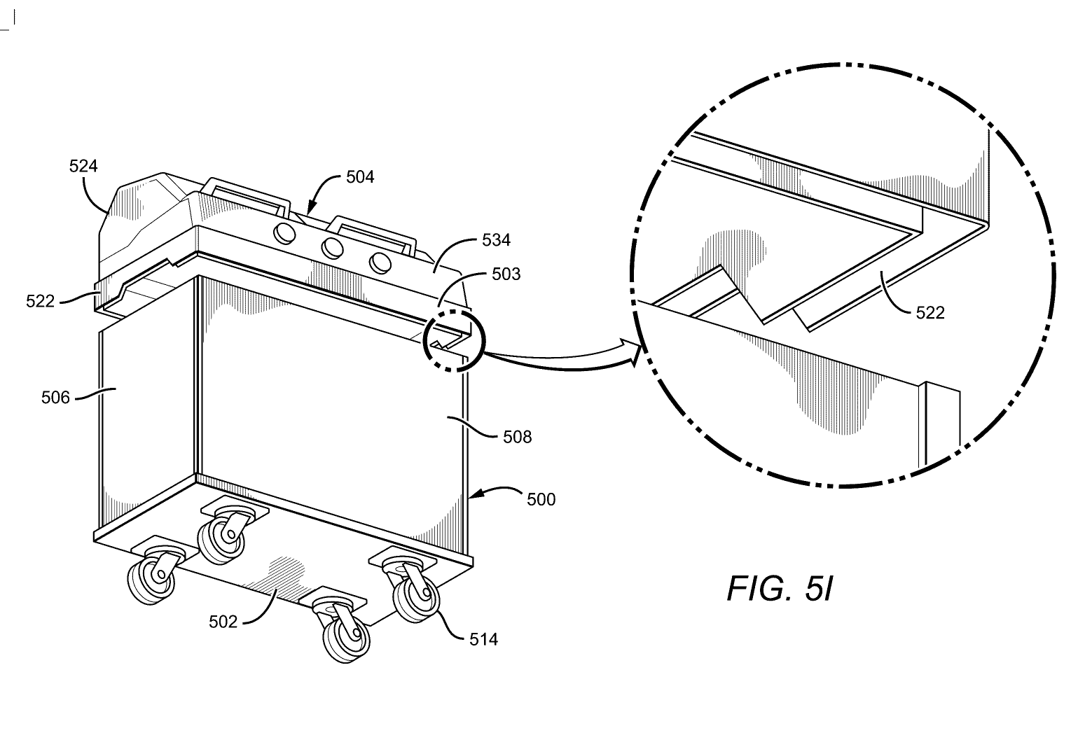

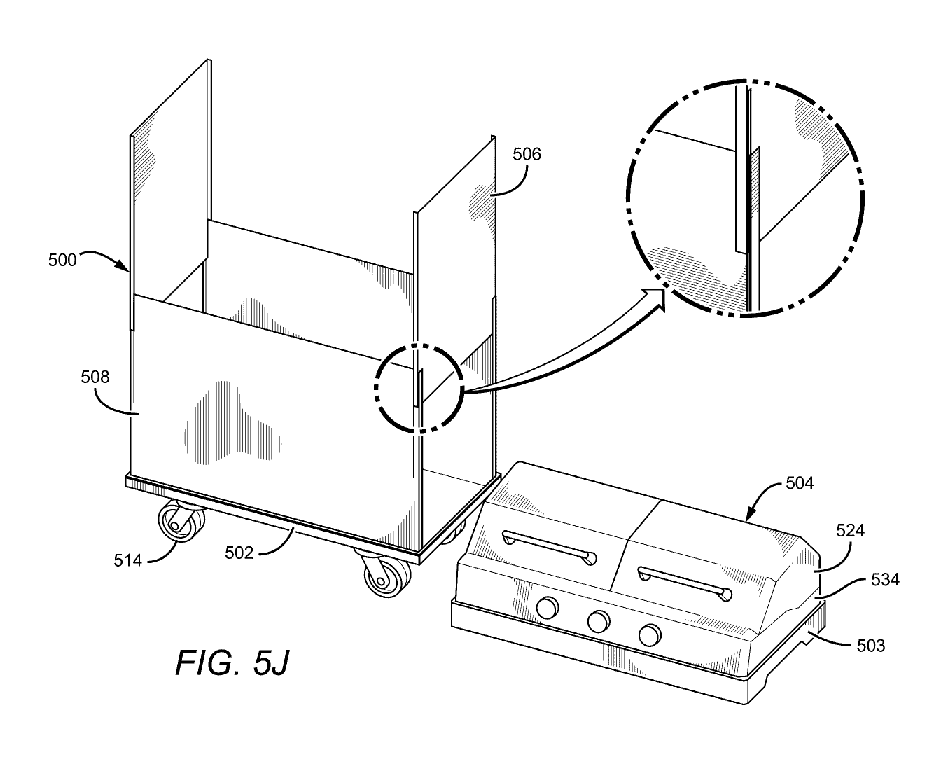

FIGS. 5A-5J show another embodiment of the inventive subject matter that has flat-pack slot-fit walls. As shown in FIG. 5A, in the collapsed configuration, grill 504 is stacked on base frame 502, side walls 506, and front and back walls 508. FIG. 5B shows a right perspective view of the assembled grill cart 500 and grill 504. The assembly process for this embodiment is illustrated in FIGS. 5C-J. FIG. 5C shows a right perspective view of cart 500 in the collapsed configuration. In FIG. 5D grill 504 is removed from base frame 502 and set aside. FIG. 5E shows front and back walls 508 positioned on base frame 502. Next, side walls 506 are joined to front and back walls 508 by sliding each piece in complementary channels as shown in FIGS. 5F & J. The fully assembled cart 500 is shown next to grill 504 in FIG. 5G. Grill 504 can then be fitted on the cart by inserting the top perimeter of cart 500 in channels 522 on the bottom of grill 504. In FIG. 5H grill 504 is shown fitted on assembled cart 500. Like numerals refer to like structures

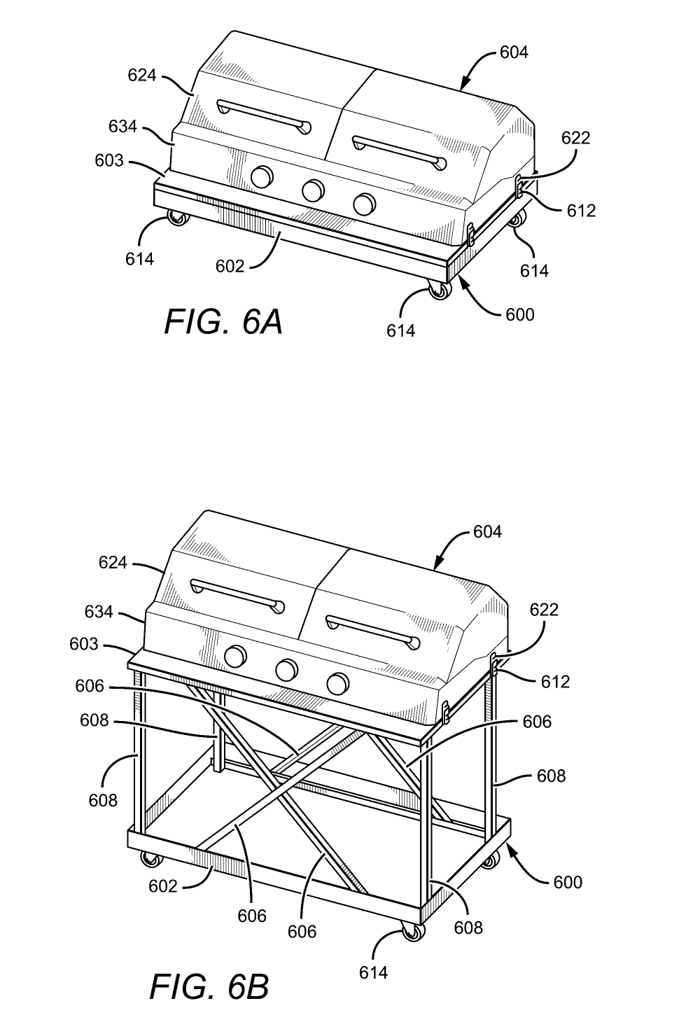

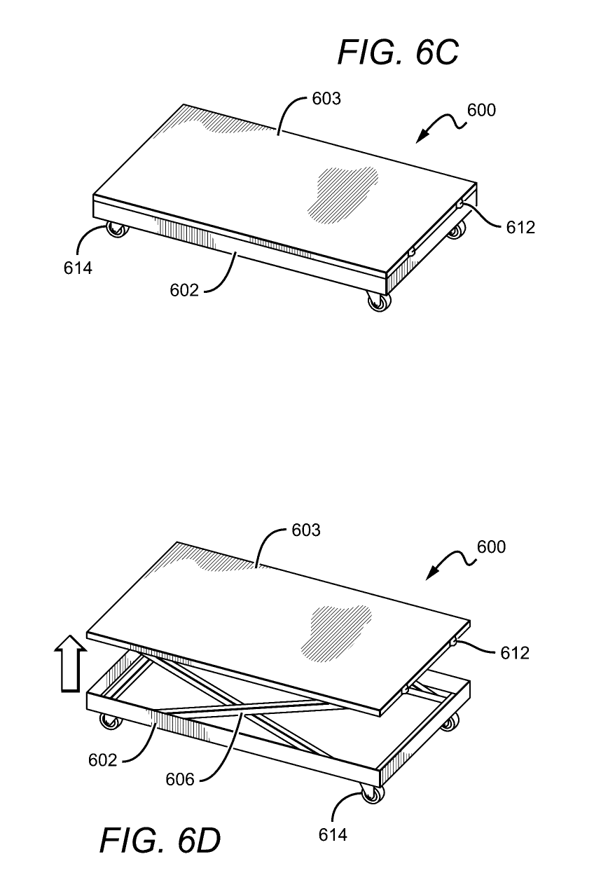

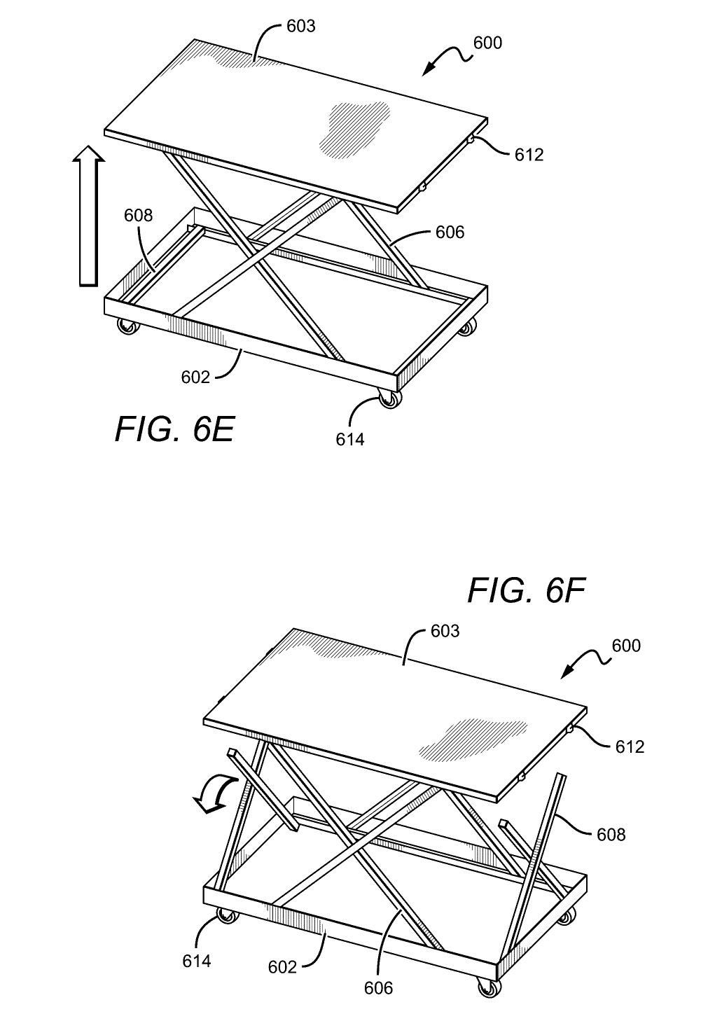

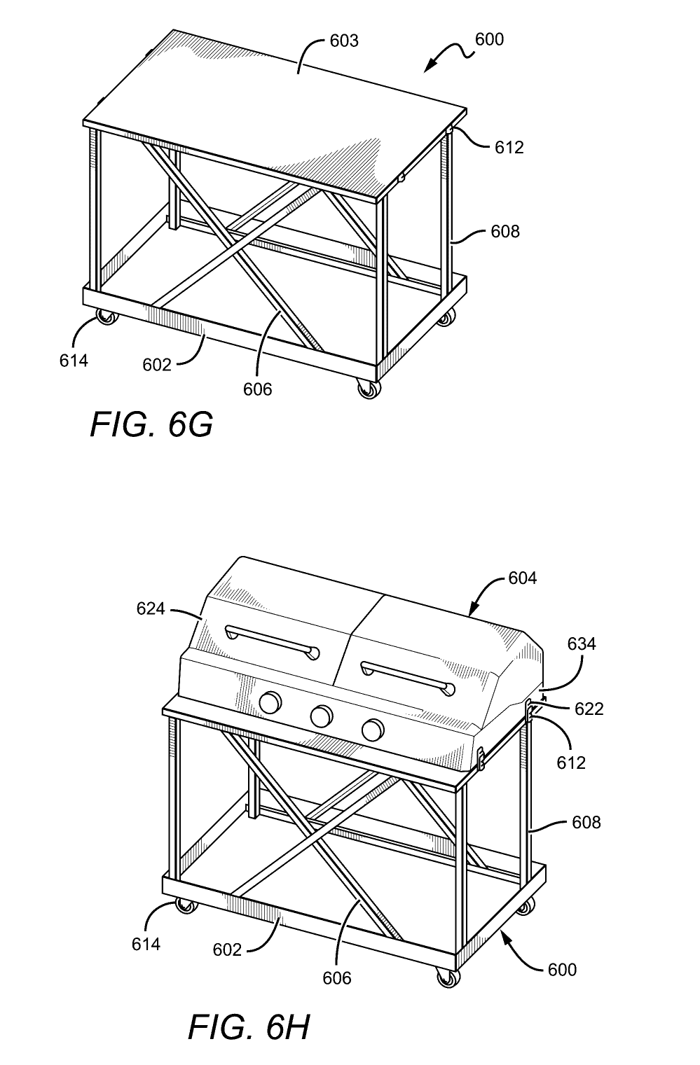

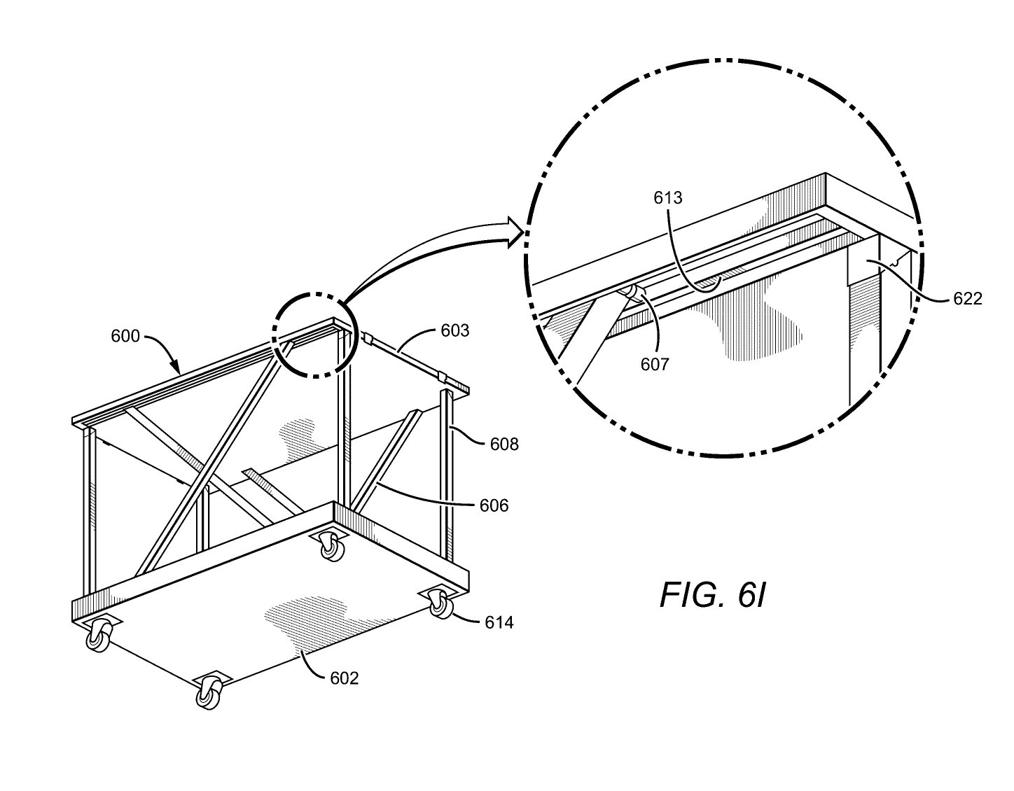

In yet further aspects of the inventive subject matter, grill cart 600 comprises a base frame 602 with wheels 614, X-risers 606, support legs 608, and top 603 as shown in FIGS. 6A and 6B. In the collapsed state (FIGS. 6A & C), the grill cart 600 is compact, which is advantageous for shipping and storage. In FIGS. 6C-H, the facile assembly of cart 600 is shown in a step-by-step manner. Grill 604 is preferably removed from collapsed cart 600 before assembly (FIG. 6C). Top 603 is lifted, and X-risers 606 angle upward from a substantially horizontal configuration to between 20 and 80 degrees from horizontal (FIGS. 6D & E). To facilitate the elevation of top 603, wheels 607 disposed at each end of X-risers 606 roll in tracks 613 installed in base frame 602 and top 603 (FIG. 6I and inset). Preferably when cart 600 is fully deployed X-risers automatically lock, for example using a catch or other locking mechanism. Supports legs 608 are installed at each corner of the cart by suitable means. For example, in FIGS. 6F-G, support legs 608 are rotated upward and locked into place using pin and slot mechanism 622 as shown in the inset of FIG. 6I. It should be appreciated that other securing mechanisms may be employed, such as catches or other housings disposed on the bottom of the top 306. Grill 604 is then placed on top 603 and latched into place, wherein the latch bottom 612 is disposed on top 604, and the latch top 622 is disposed on grill 604 (FIG. 6H). Like numerals refer to like structures.

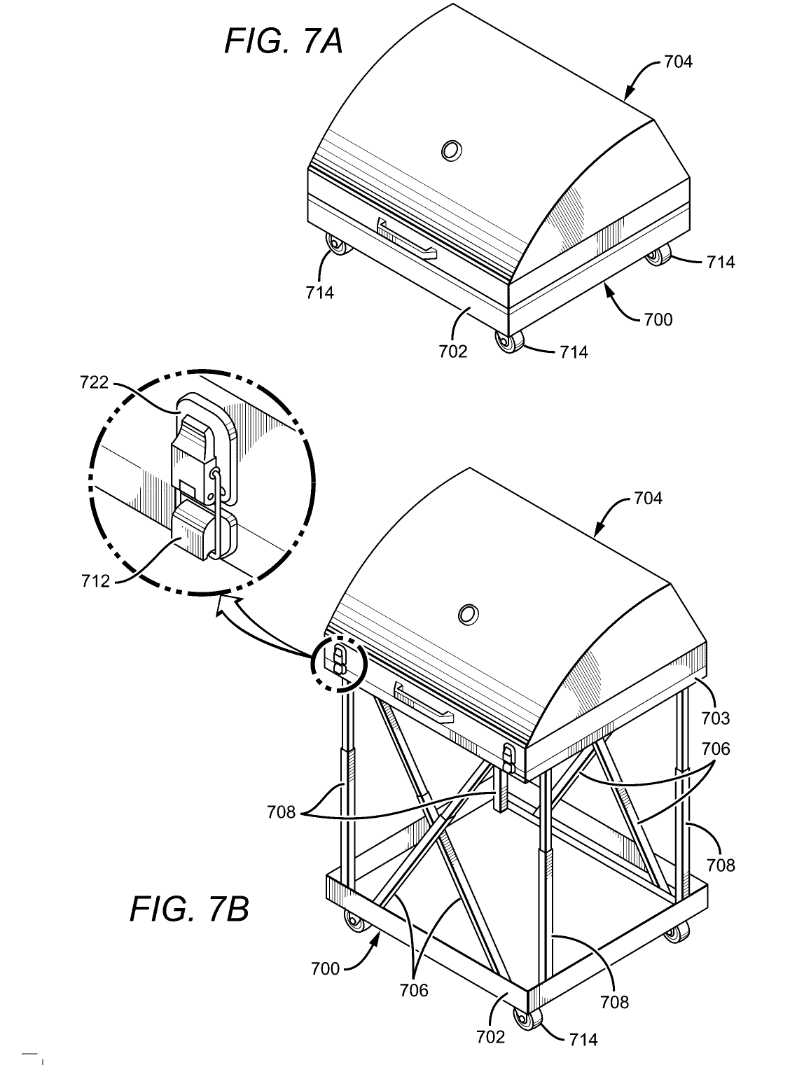

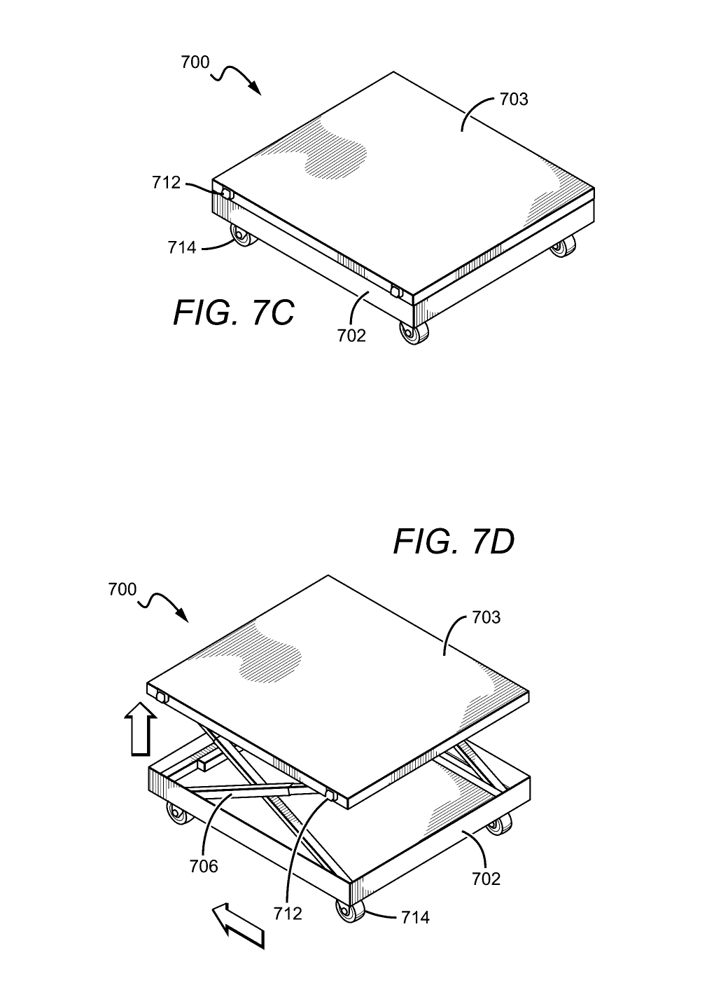

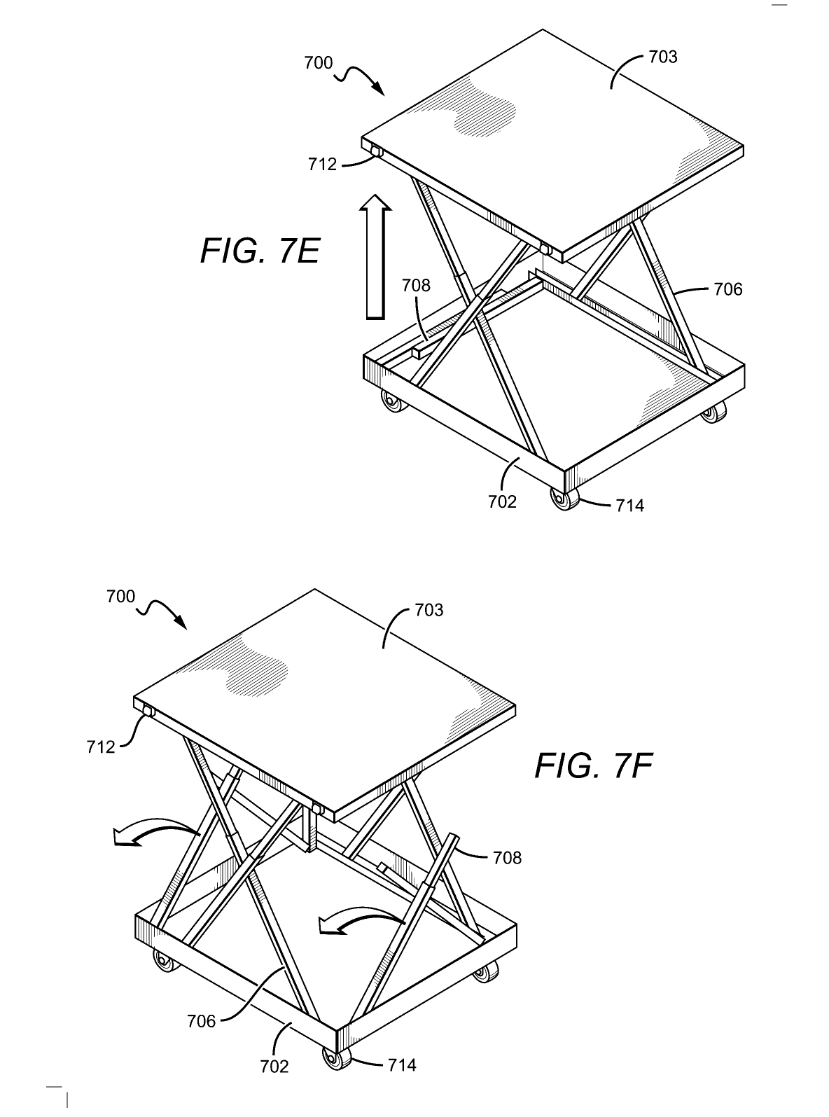

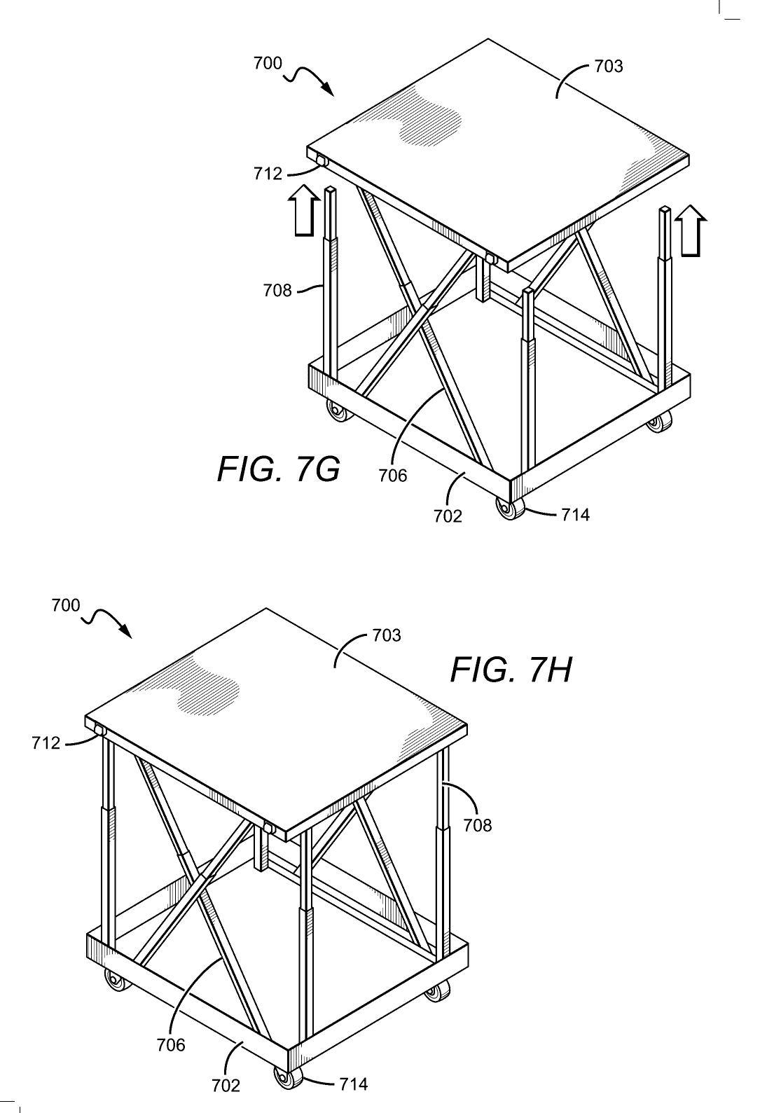

In an exemplary embodiment of the inventive grill carts, X-risers and/or the corner supports can be telescoping. As shown in FIGS. 7A-7H, the grill cart advantageously collapses to a compact configuration for shipping and storage. In the collapsed, compact configuration, base frame 702 and grill 704 are visible (FIG. 7A). Although wheels 714 are shown in FIG. 7A, for shipping, the inventors appreciate that space can be saved by shipping the cart/grill with the wheels un-installed (e.g., stowed in the grill 704). FIG. 7B shows fully deployed cart 700 with grill 704 mounted on top 703, and telescoping X-risers 706 and support legs 708 are exposed. X-risers 706 and support legs 708 can be locked at the desired height by suitable means, including pin and slot mechanisms, clutches, collars, cams, shock cords, spring-buttons, snap collars, and set knobs, for example. Step-by-step deployment of cart 700 is illustrated in FIGS. 7C-H. Optionally, grill 704 can be removed from collapsed cart 700 and set aside (FIG. 7C). Next, top 703 is lifted (FIG. 7D). Initially, X-risers 706 are in the compact configuration, and as top 703 is elevated further, X-risers 706 extend in a telescoping manner (FIG. 7E). FIG. 7F shows compact support legs 708 rotating upward. In FIG. 7G, support legs 708 telescope upward and extend into holes disposed in the bottom of top 703. A perspective view of fully deployed cart 700 is shown in FIG. 7H. Finally grill 704 can be placed on top of the cart and latched in place onto cart 700 as shown in FIG. 7B, or secured by other means. Like numerals refer to like structures.

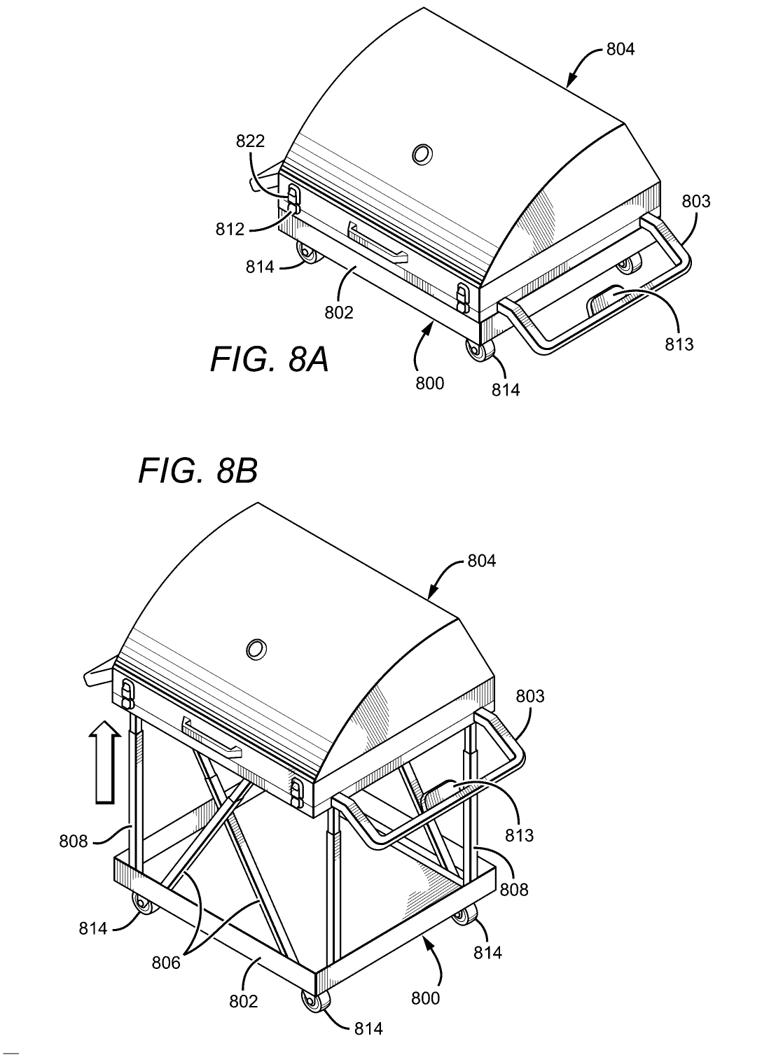

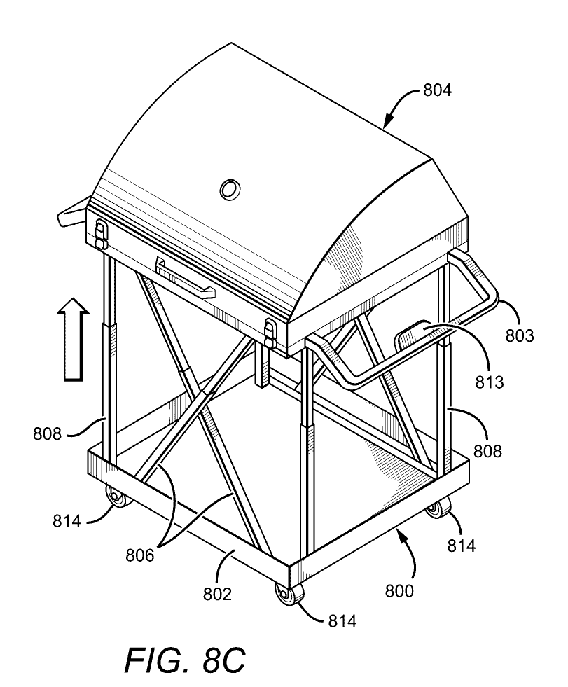

FIGS. 8A-8C show a preferred grill cart and grill. In this embodiment, grill 804 comprises handles 803 that allow a user to lift the grill and assemble the cart without first removing the grill from the cart 800. Even more preferably, the grill can comprise actuator 813 (e.g., a button or lever) that the user actuates to lock and unlock cart 800 from the collapsed and/or the deployed configurations, so that the cart can be easily collapsed and expanded (FIG. 8B-C). Optionally, actuator 813 concurrently activates air springs that assist the user in elevating grill 804 and allows grill 804 to collapse slowly without the user having to carry the weight of grill 804 to prevent grill 804 from crashing to the ground as cart 800 is collapsed. Although grill 804 is shown latched onto top 803, the grill and cart can be an integrated structure. Like numerals refer to like structures.

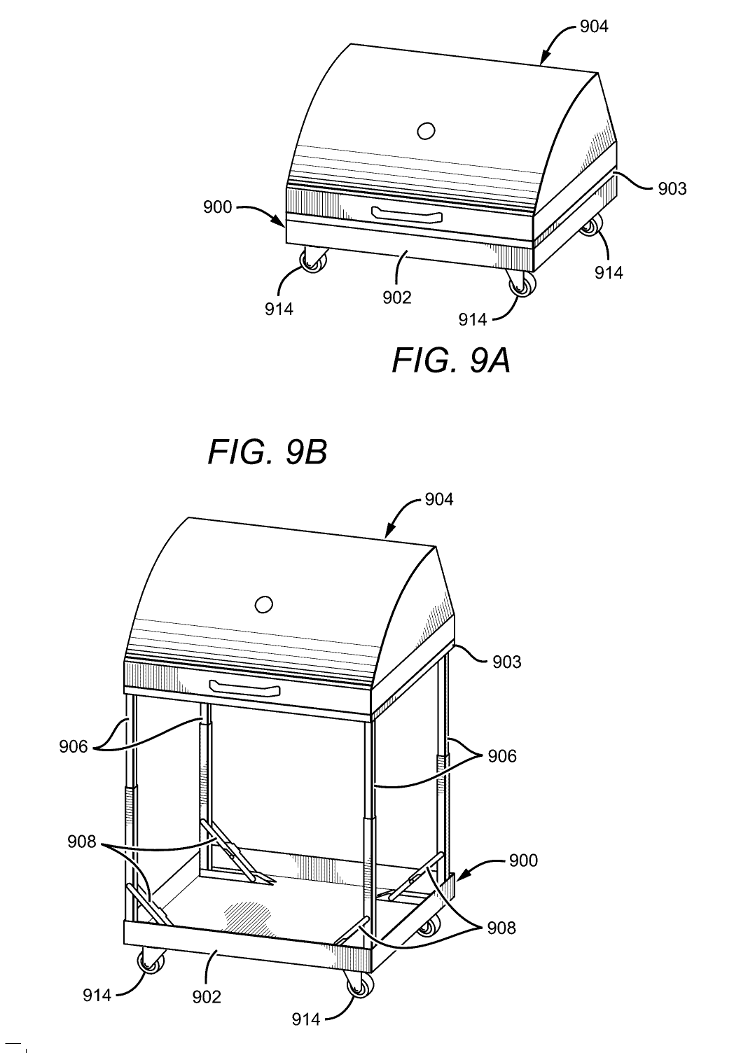

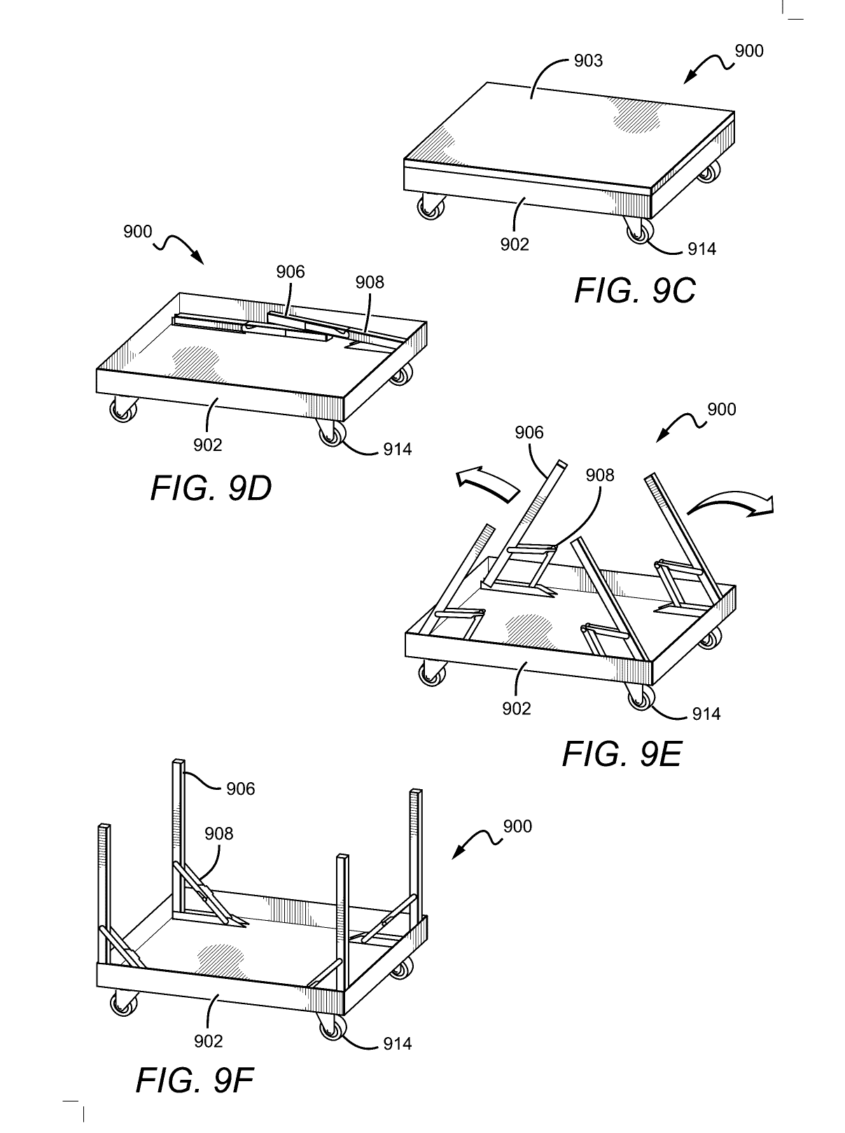

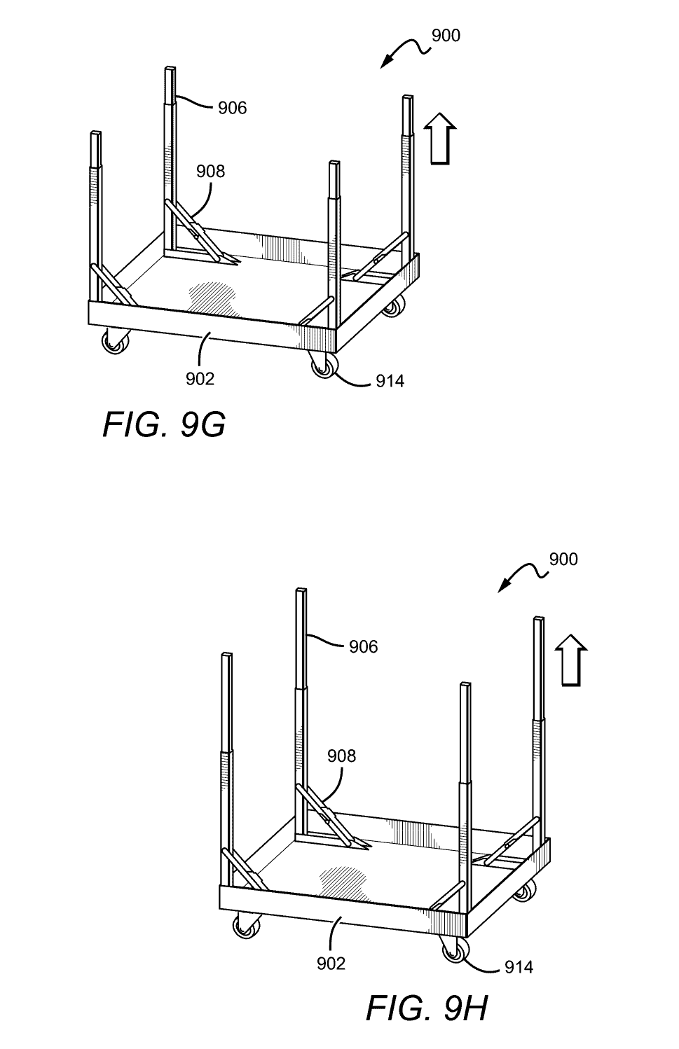

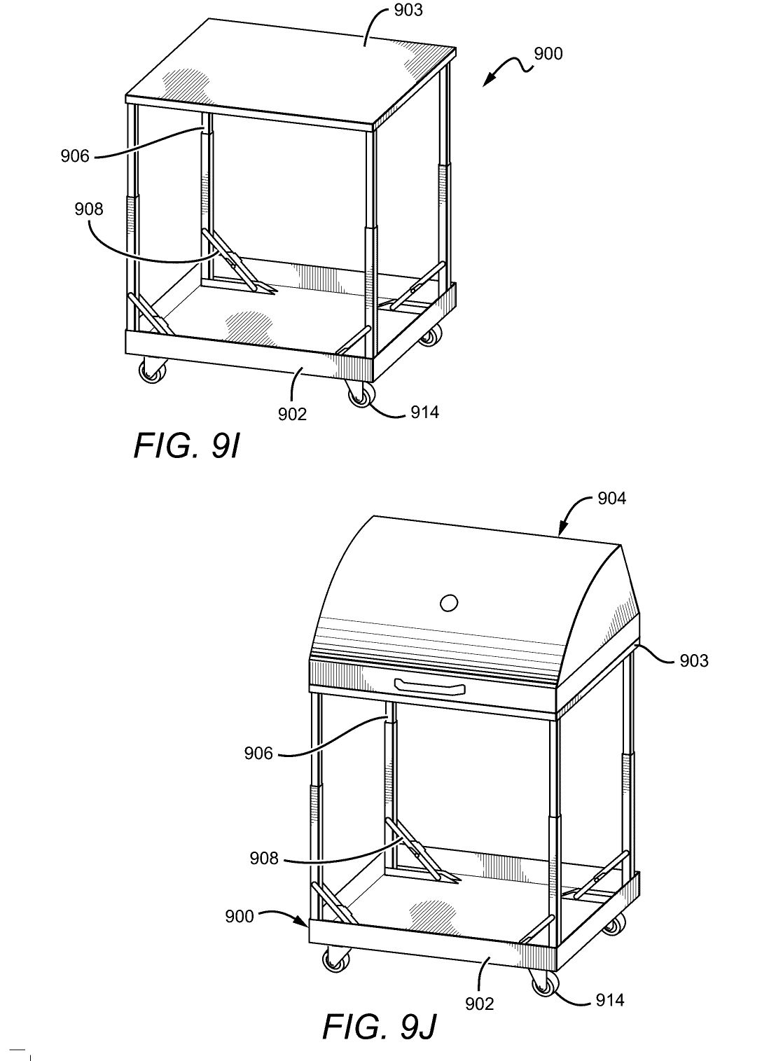

In the exemplary embodiment of the inventive subject matter shown in FIGS. 9A-J, legs 906 of cart 900 are folded against either the base frame 902 in the collapsed configuration, although rotatably attaching legs 906 to top 903 of cart 900 is not excluded. To assemble cart 900, grill 904 and top 903 are removed, then legs 906 are folded out from base frame 902 (FIGS. 9C-F). In a preferred embodiment, support arms 208 (e.g., auto-locking hinges) employed automatically lock when the legs are fully deployed. It should be appreciated that legs 906 in such embodiments can be telescoping or non-telescoping. When telescoping legs 906 are used, legs 806 are extended and secured using suitable means including pin and slot mechanisms, clutches, collars, cams, shock cords, spring-buttons, snap collars, and set knobs, for example (FIGS. 9G-H). Optionally, top 903 is secured to the cart by inserting legs 906 into holes in the bottom of top 903, or by inserting dowels in top 903 into the cavities in legs 906, or other suitable means (FIG. 9I). Once cart 900 is assembled, grill 904 can be placed on top of cart 900 and secured to the top of the cart by appropriate means, including latches, nesting structures, drawer glides, etc. (FIG. 9J). Like numerals refer to like structures.

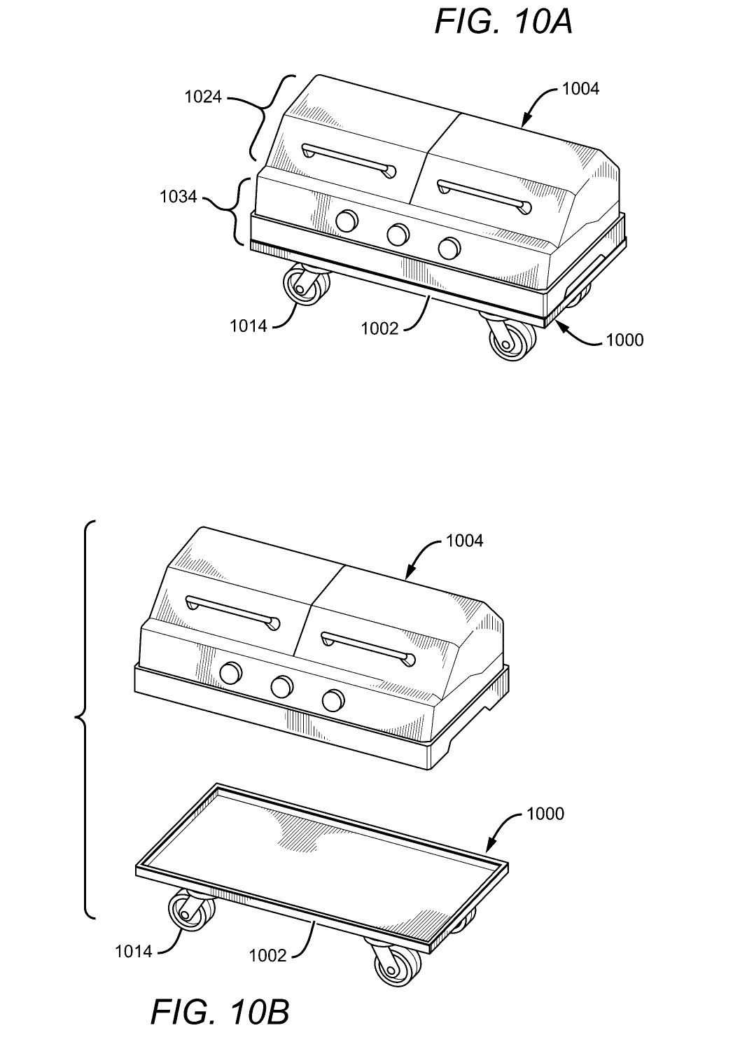

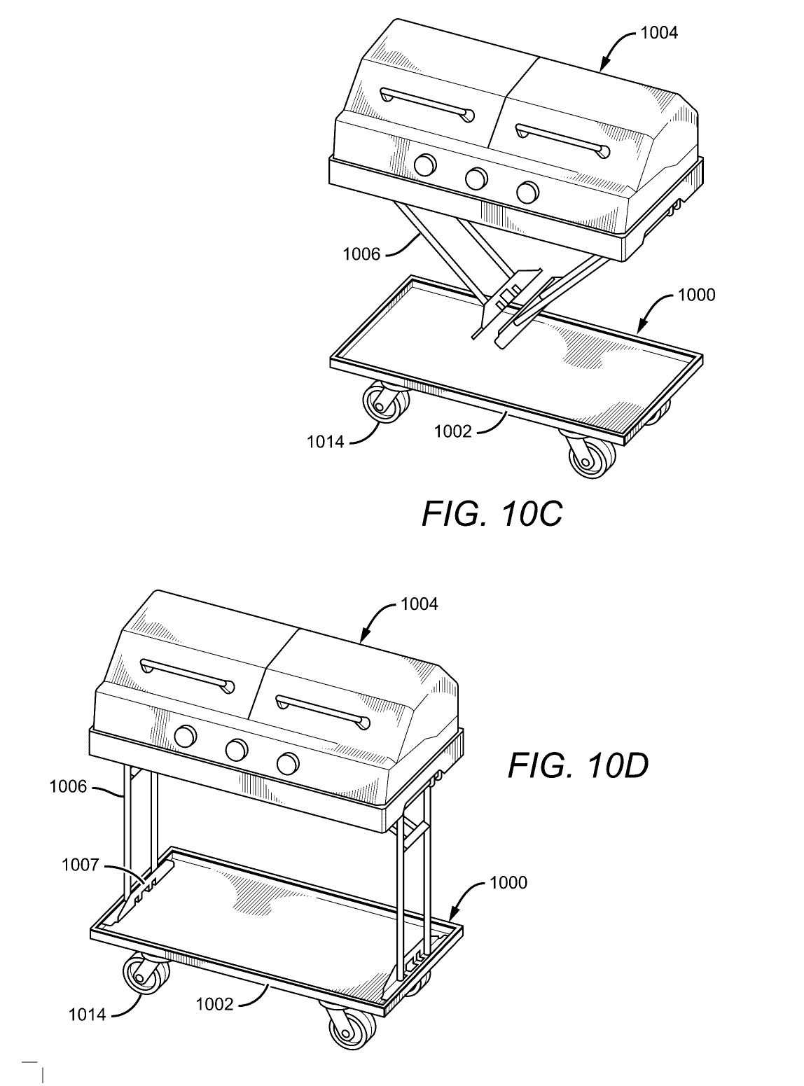

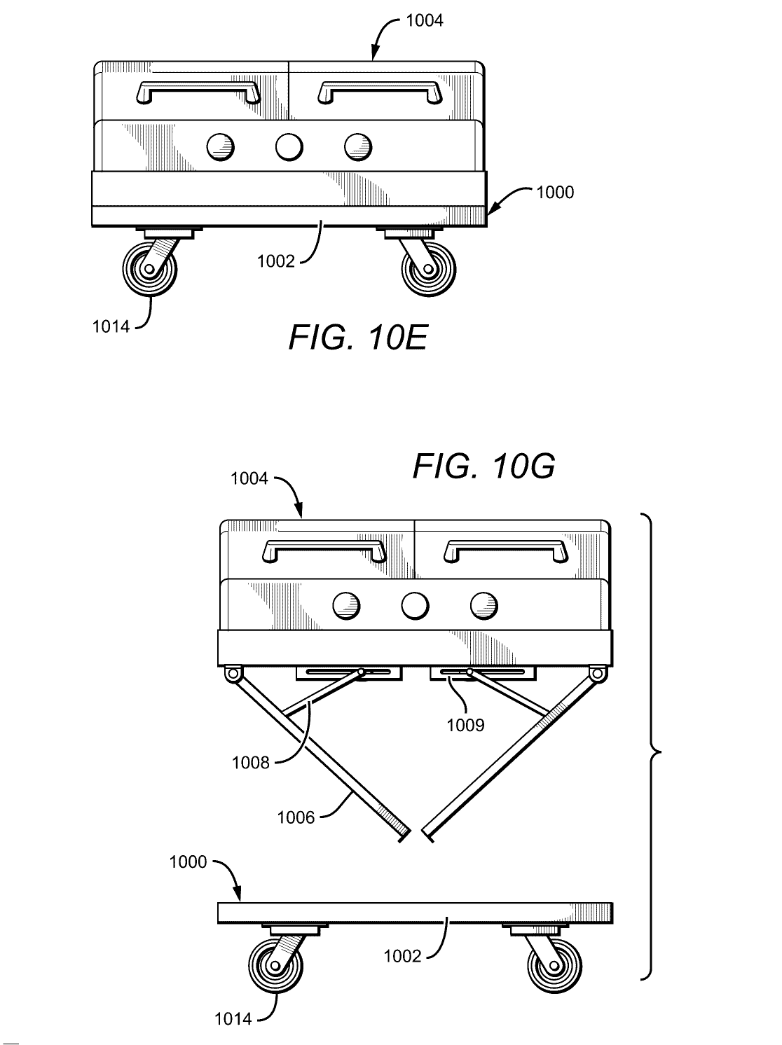

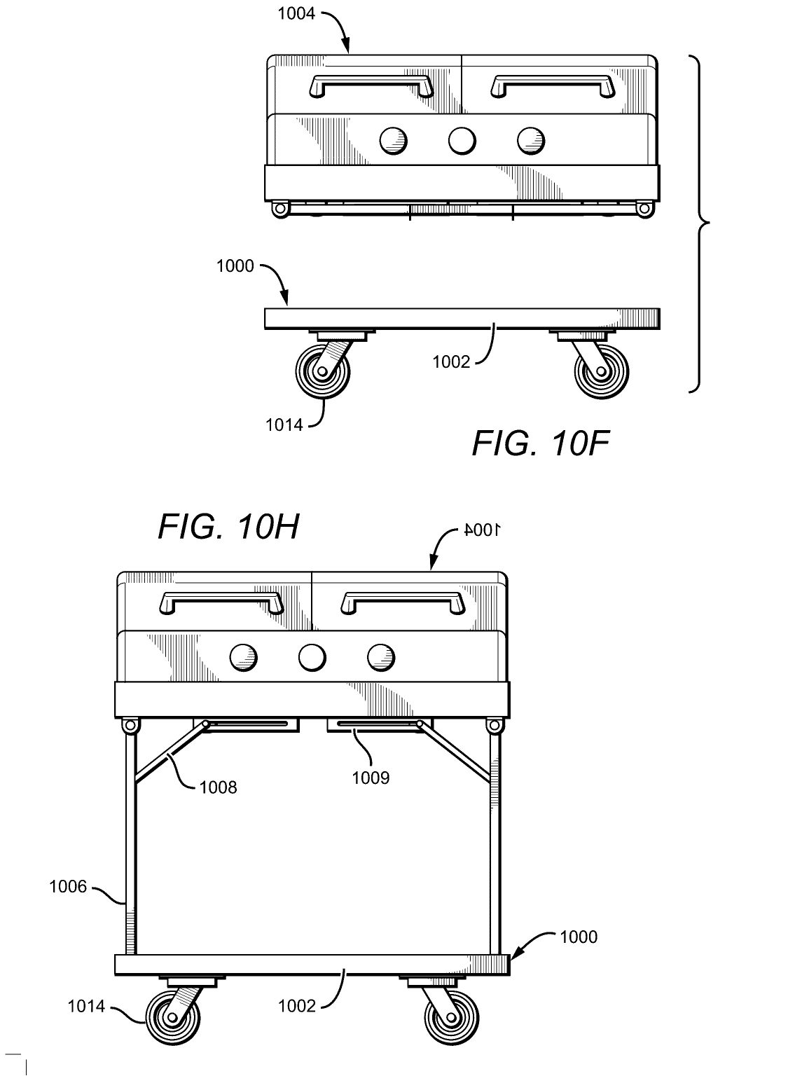

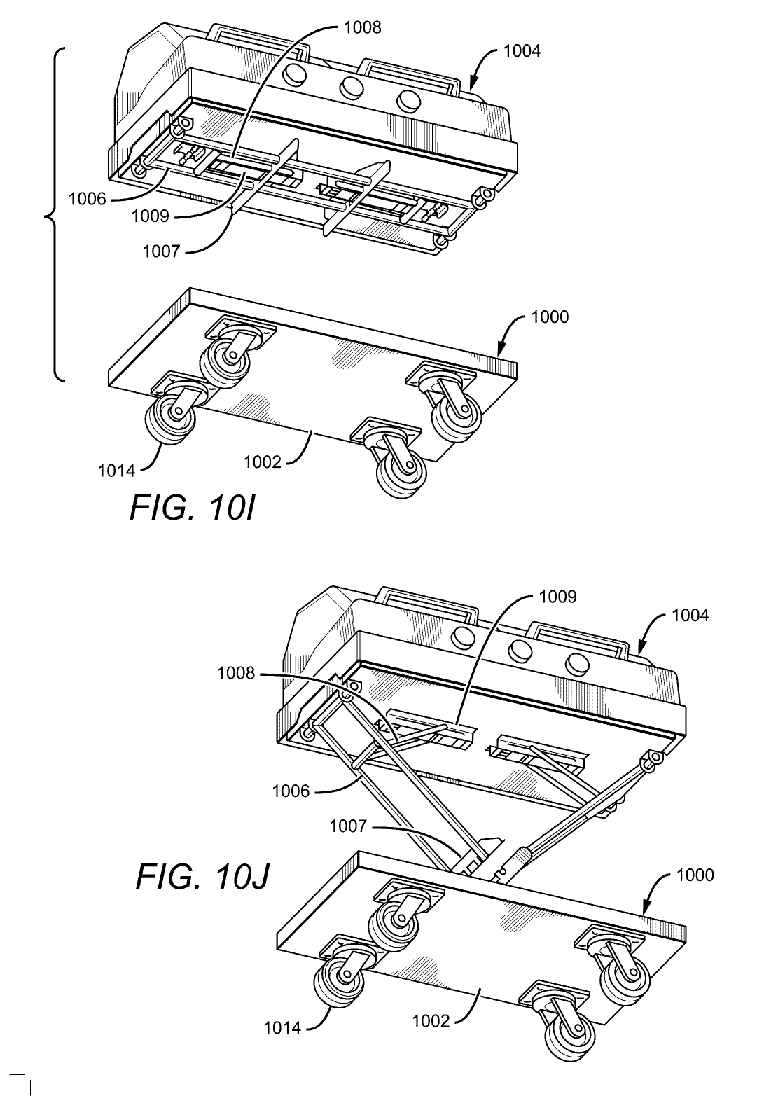

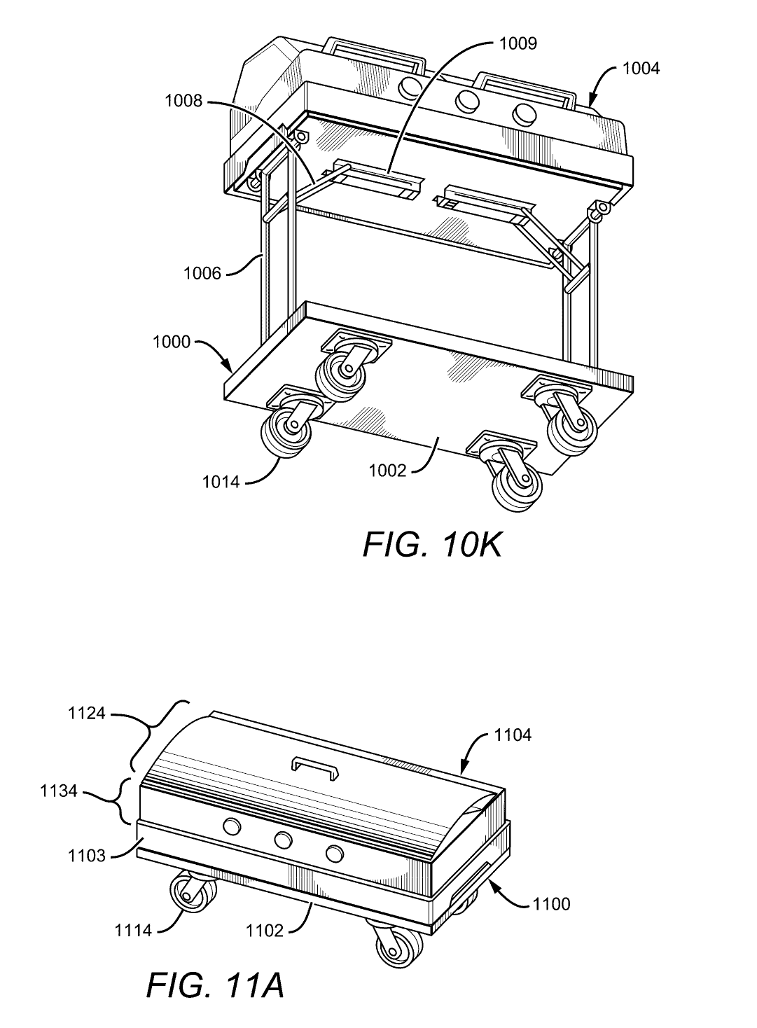

FIGS. 10A-10K show another grill cart configuration in which side frames 1006 fold out from the bottom of grill 1004 (FIGS. 10A-D). FIGS. 10E-H and 10I-K show front and bottom, left perspective views of the deployment process. As the legs rotate downward, one end of each support arms 1008 concurrently extends downward and the other end slides in a channel in locking mechanism 1009. Locking mechanism 1009 at the bottom of the grill is configured to automatically lock once the legs reach the fully deployed configuration (FIGS. 10H & K). To refold the legs, a button or lever is depressed to release side frames 1006. As shown in FIG. 10I, feet 1007 have notches to accommodate side frames 1006 and support arms 1008. Once support frames 1006 are deployed, feet 1007 may be secured to base frame 1002 using couplings such as screws or other fasteners. The inventors further contemplate that to facilitate moving the assembled grill and grill cart, wheels 1014 can be installed on base frame 1002. Like numerals refer to like structures.

Therefore, in yet further embodiments of the inventive subject matter, as front and back panels unfold from the base frame, side panels rotate down from the top of the grill cart as shown in FIGS. 11A-13I. For example, FIGS. 11A and 11H show fully collapsed grill cart 1100 and firebox hood 1124, and FIG. 11B shows fully deployed cart 1100 and firebox hood 1124. A perspective view of the step-by-step deployment of cart 1100 is shown in FIGS. 11C-G, and side views are provided in FIGS. 11H-I. As grill 1104 is elevated, front and back walls 1106 fold up (FIGS. 11D-E, I). Side walls 1108 fold down from top 1103 (FIGS. 11F-G, J). Like numerals refer to like structures.

Firebox hood 1124 is fully collapsible to further compact the grill for shipping and/or storage. In a preferred embodiment, the front surface of the grill hood is curved, such that the height of the hood does not exceed the depth of firebox base 1134 (FIG. 11C). The back of firebox hood 1124 is foldably coupled (e.g., using hinges) to the firebox hood 1124 and firebox base 1134 (FIGS. 11D-E). The sides of the firebox hood are likewise foldably coupled to the edges of the back panel of the firebox hood, such that they can be folded in for storage/shipping and rotated out to form the sides of firebox hood 1124. It should be appreciated that appropriate couplings maintain the firebox hood in the expanded configuration when it is in the deployed configuration. Suitable couplings include latches, snap-fit couplings etc. (FIGS. 11B, G & J). In contrast with collapsible firebox hood 1124 of the embodiment depicted in FIG. 11, grill 1004 shown in FIG. 10A comprises firebox base 1034 and firebox hood 1024, which is not collapsible. The inventor appreciates that either a fully collapsible firebox hood or an un-collapsible firebox hoods may be employed in all the embodiments disclosed herein. Like numerals refer to like structures.

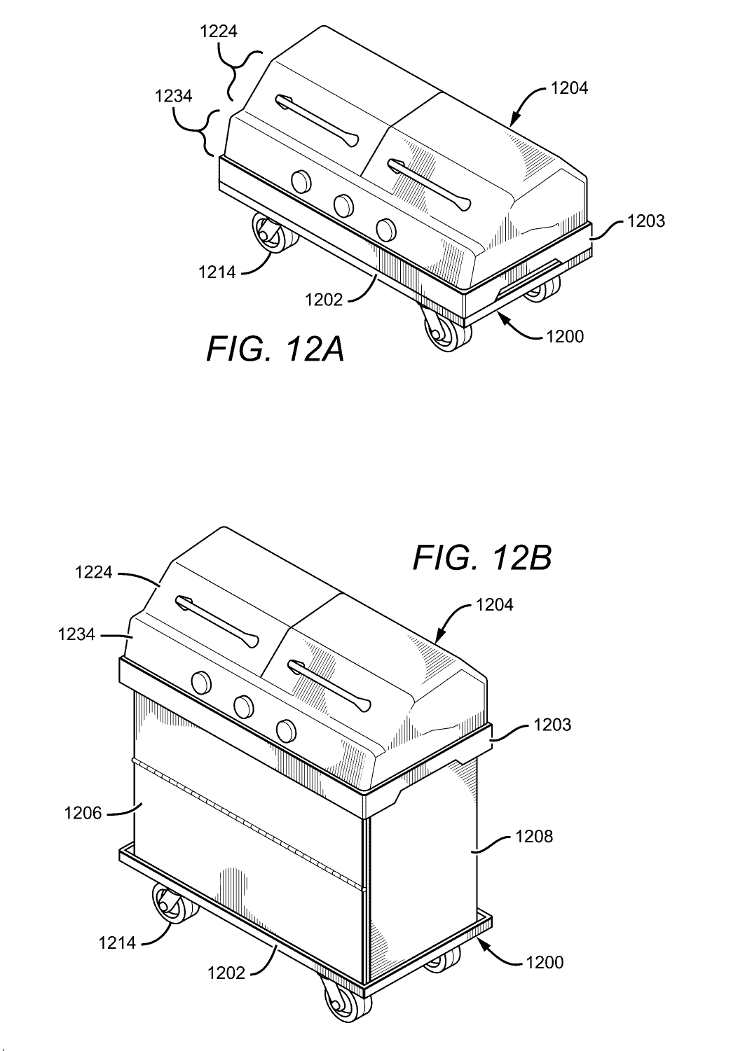

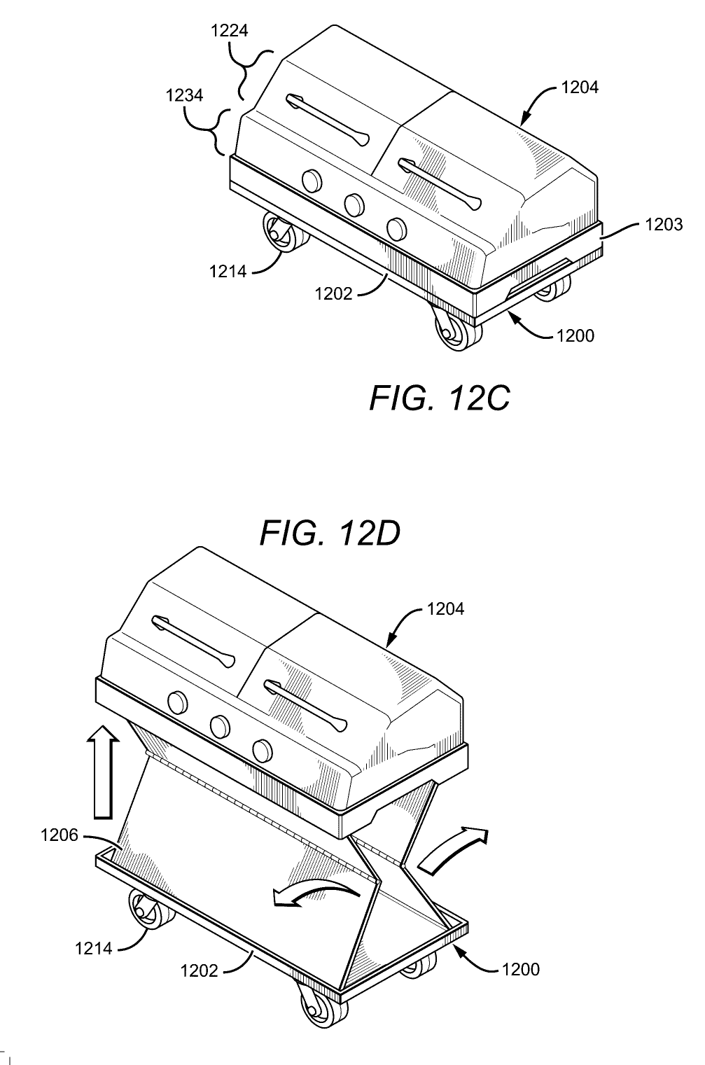

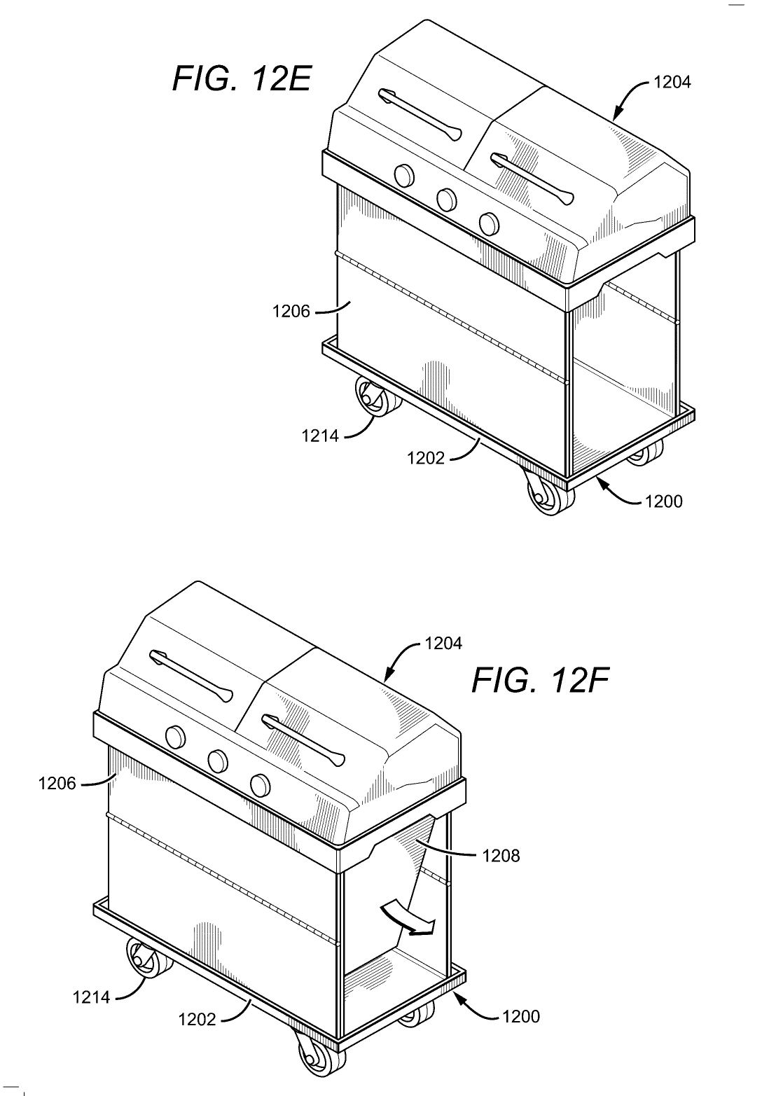

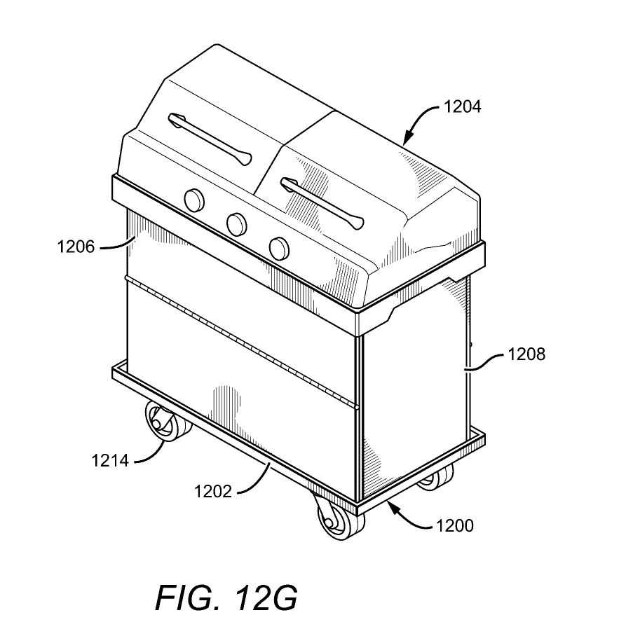

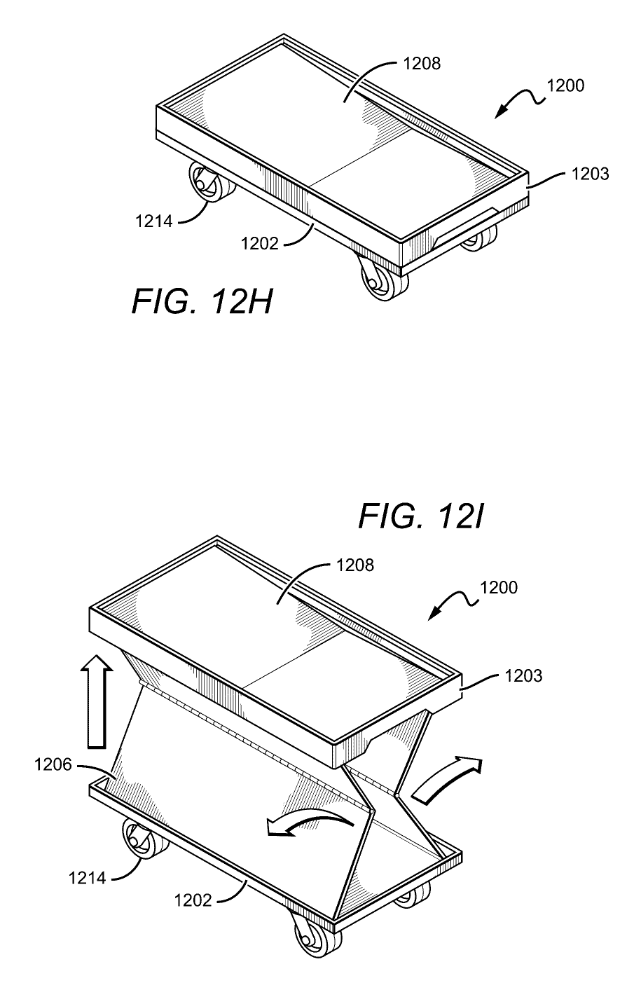

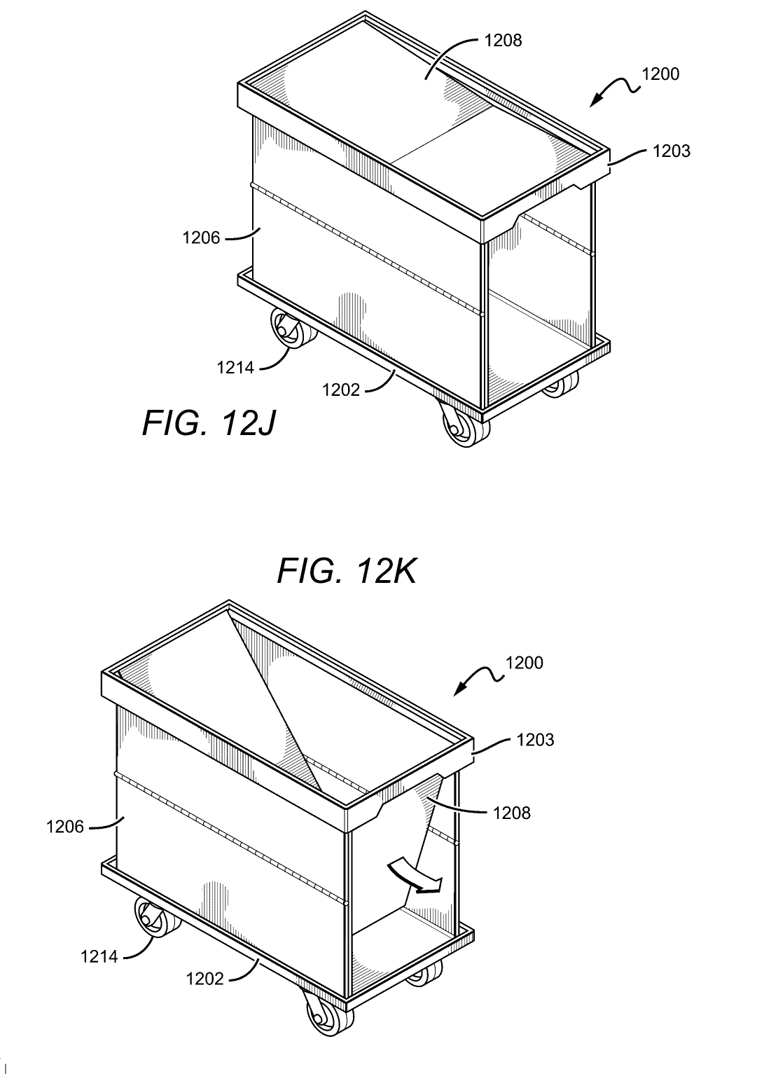

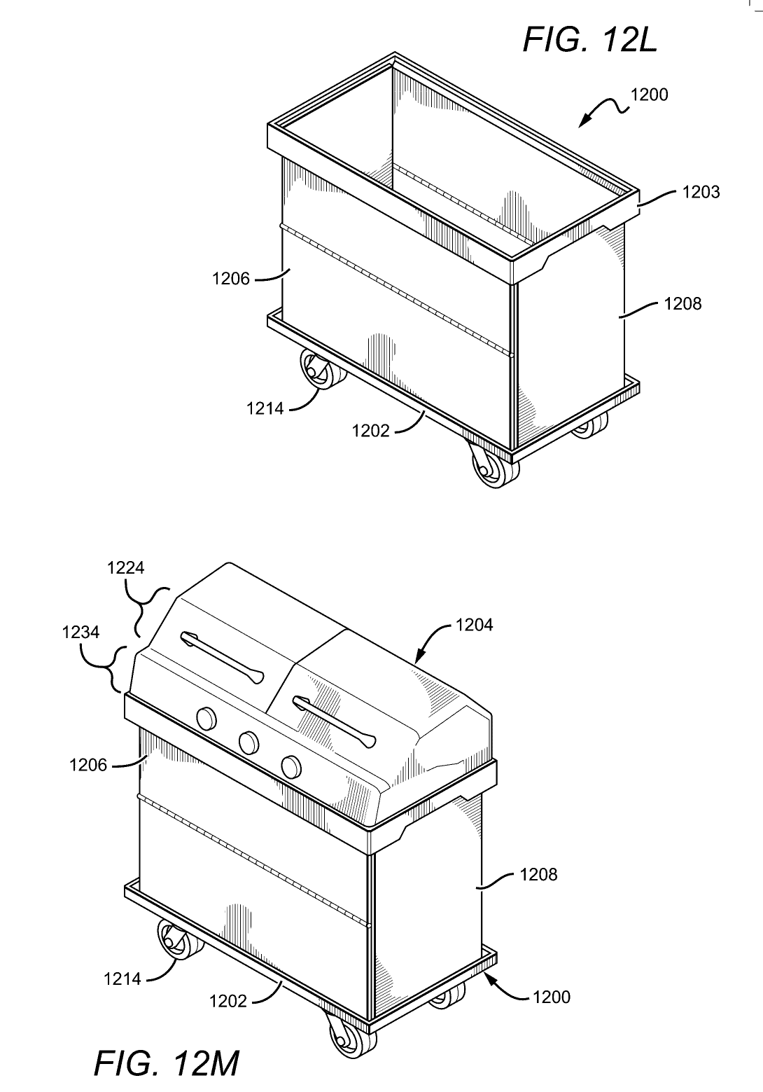

For example, an embodiment of the inventive subject matter comprising a grill cart as in FIG. 11 with the grill as in FIG. 10 is illustrated in FIG. 12. Grill 1204 comprises firebox base 1234 and firebox hood 1224, which is not collapsible. Grill 1204 may be coupled to cart 1200 as shown in assembly FIGS. 12C-G or separable from cart 1200 as shown in FIGS. 12H-M.

FIGS. 12A and 12C show fully collapsed grill cart 1200 and grill 1204, and FIGS. 12B and 12G show fully deployed cart 1200 with grill 1204. The step-by-step deployment of cart 1200 is shown in FIGS. 12C-G. As grill 1204 is elevated, front and back walls 1206 fold up (FIGS. 12D-E). Side walls 1208 fold down from top 1203 (FIGS. 12F-G). Along these lines, where grill 1204 is removable from top 1203, cart 1200 can be assembled before grill 1204 is placed on cart 1200. FIG. 12H shows fully collapsed grill cart 1200 without grill 1204, FIG. 12L shows fully deployed cart 1200, and FIG. 12M shows fully deployed cart 1200 with grill 1204 on top 1203. The step-by-step deployment of cart 1200 is shown in FIGS. 12H-M. As cart top 1203 is elevated, front and back walls 1206 fold up (FIGS. 12I-J). Side walls 1208 fold down from top 1203 (FIGS. 12K-L). Lastly, grill 1204 is secured to cart 1200 (FIG. 12M). Like numerals refer to like structures.

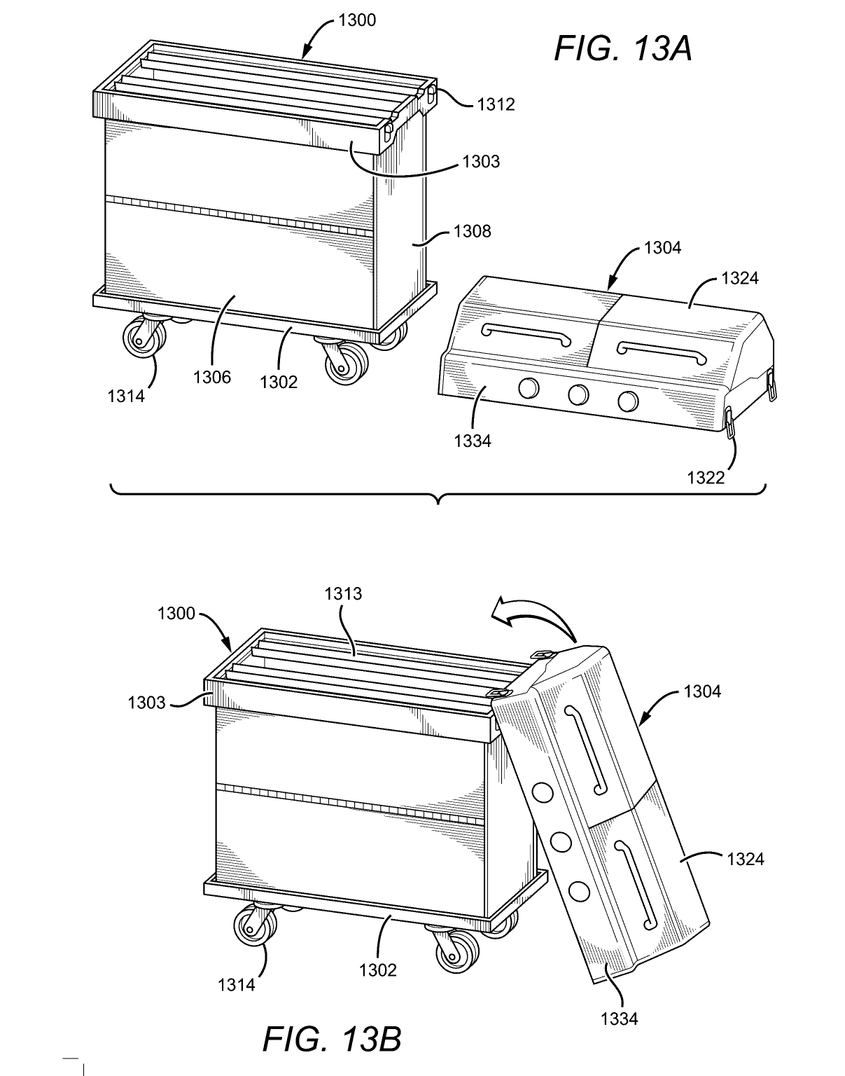

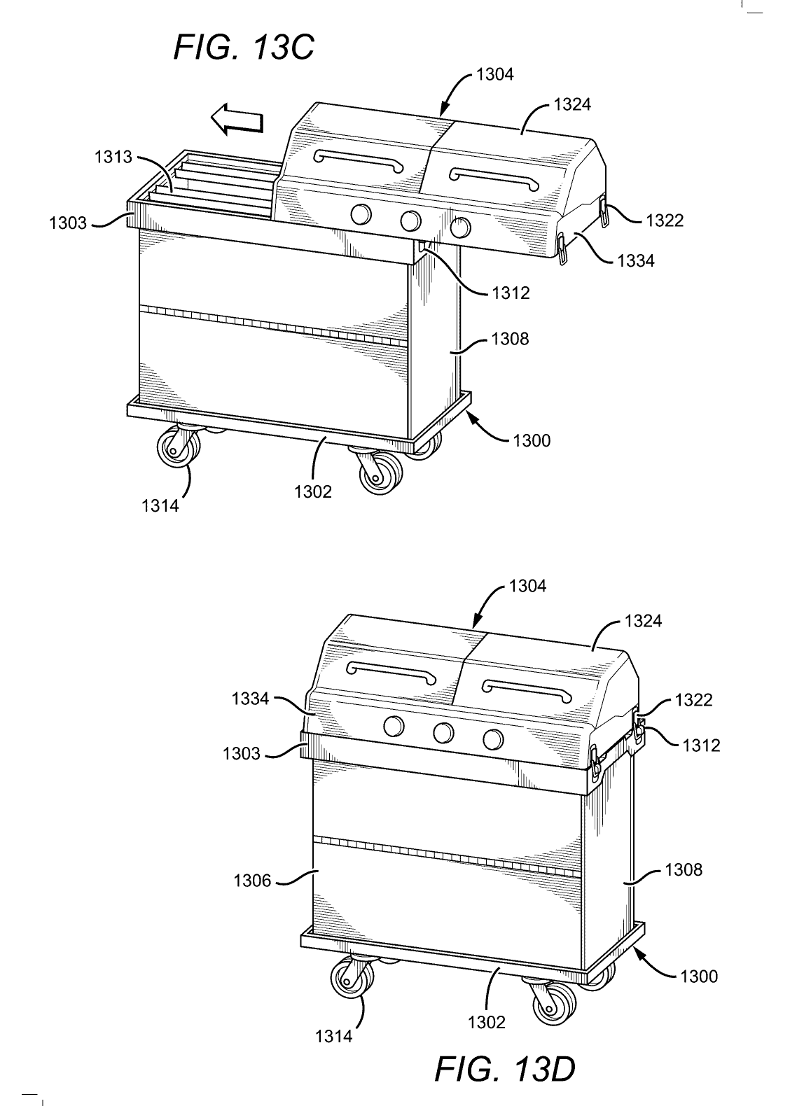

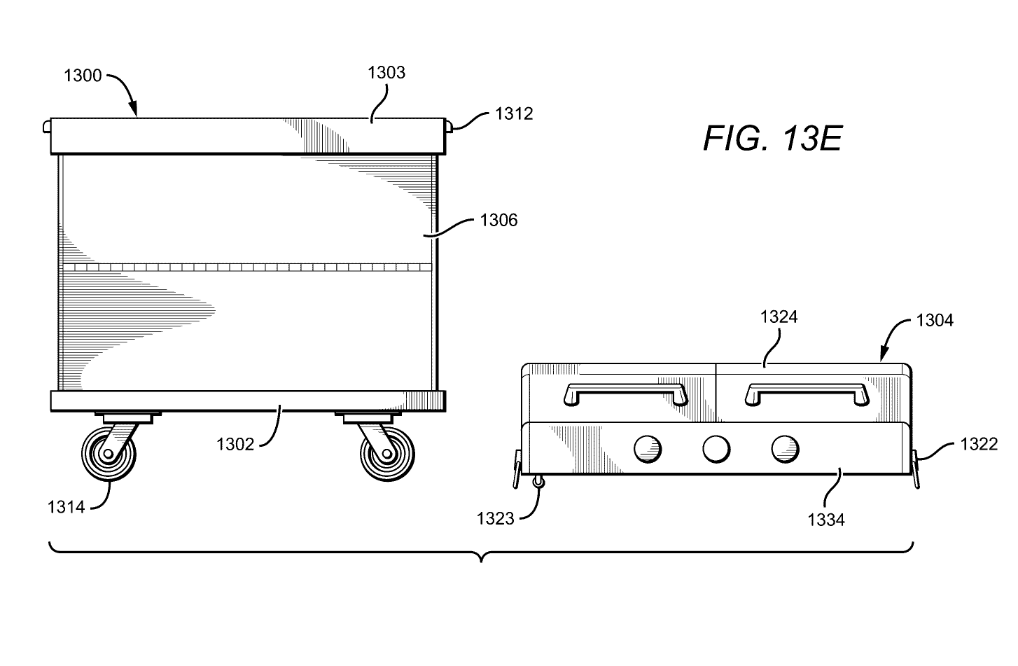

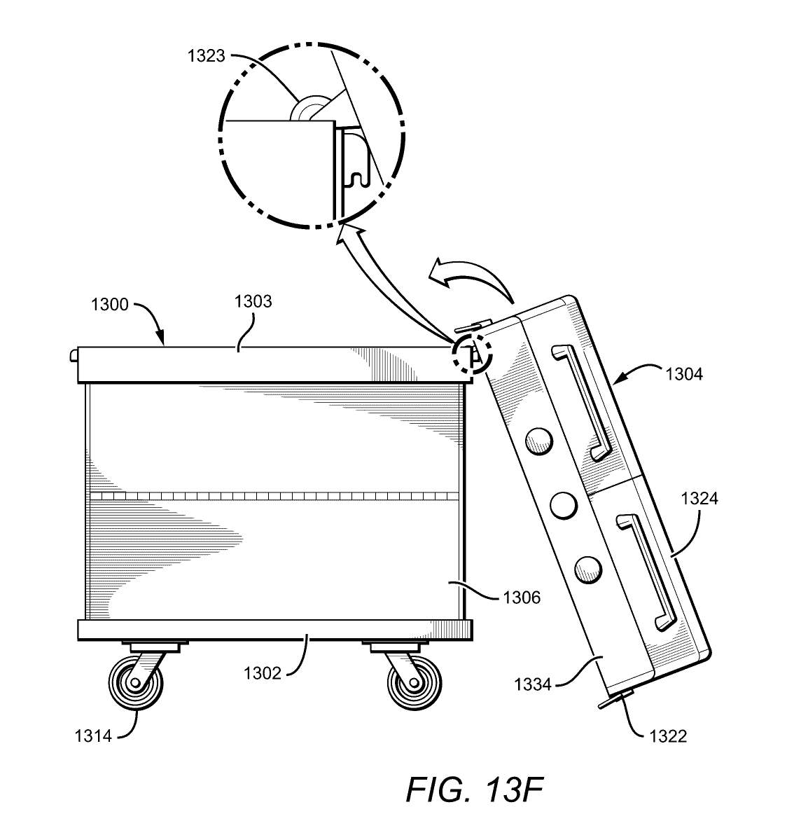

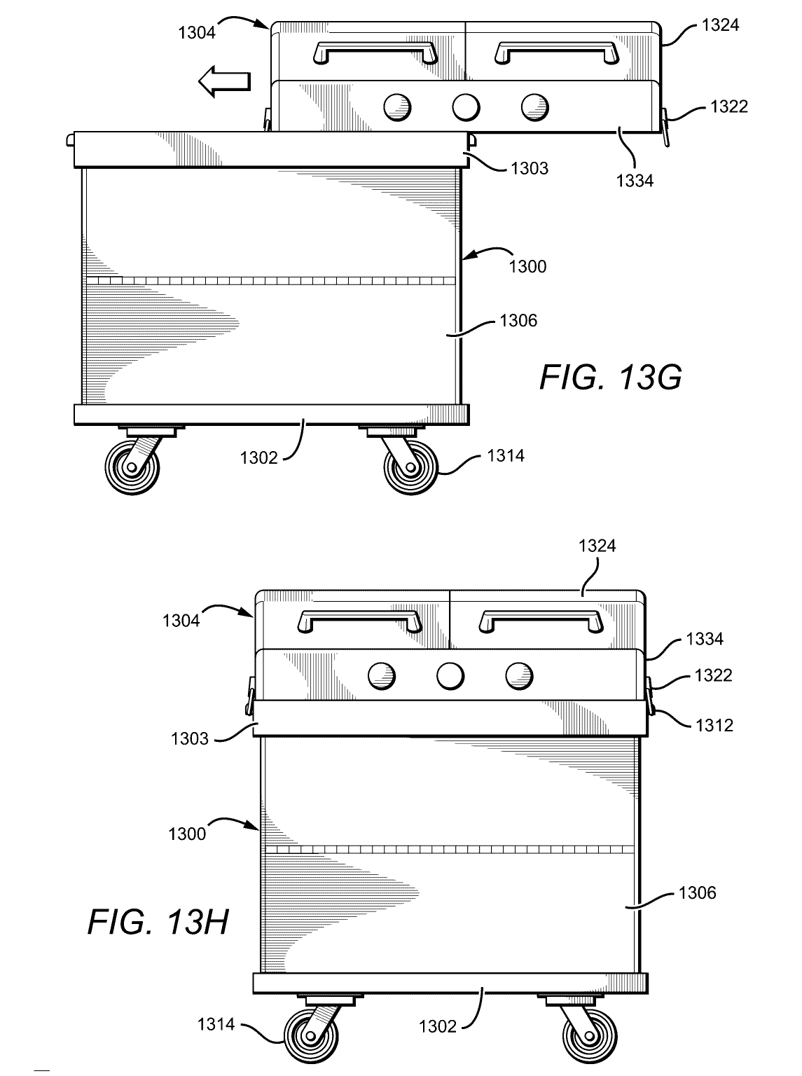

FIG. 13A-13I show an embodiment, wherein grill 1304 is secured to cart 1300 after cart 1300 is assembled. Cart 1300 is assembled in the same manner as cart 1200. Grill 1304 can then be secured to the top of the cart as shown in FIGS. 13A-D (front view of assembly shown in FIGS. 13E-H). Grill 1304 is shown next to the assembled cart in FIG. 13A. The user lifts the side of grill 1304 having wheels 1323 and positions them in the catches of drawer glides 1313 (FIG. 13B, 13I and inset of FIG. 13I). The other end of grill 1304 is then lifted and slid into place (FIG. 13C). Optionally, latches (1312/1322) or other means can be used to prevent the grill from unintentionally rolling or sliding off the cart (FIG. 13D). It should be appreciated that this embodiment may be easily assembled by one person. Like numerals refer to like structures.

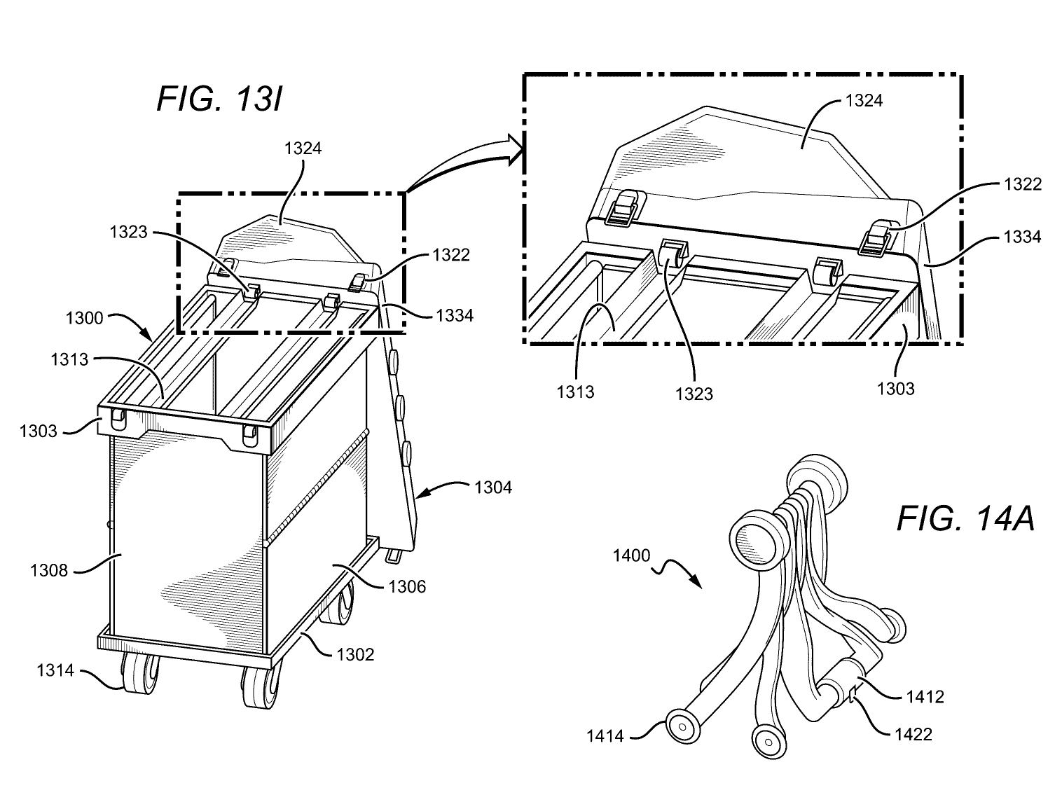

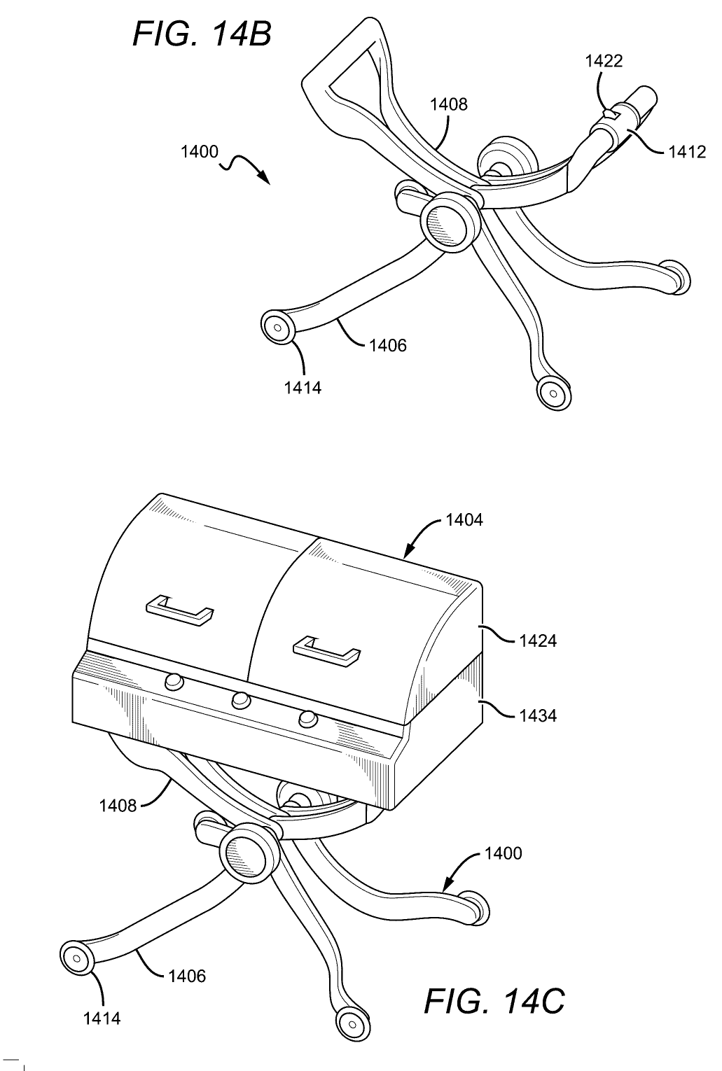

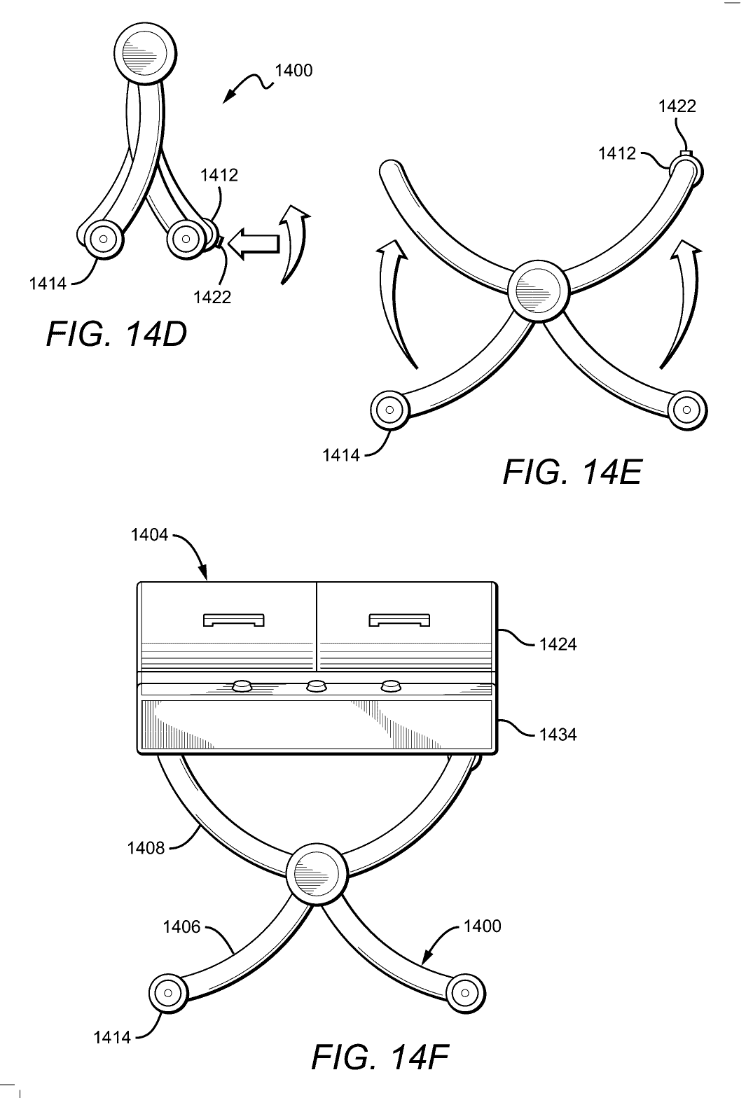

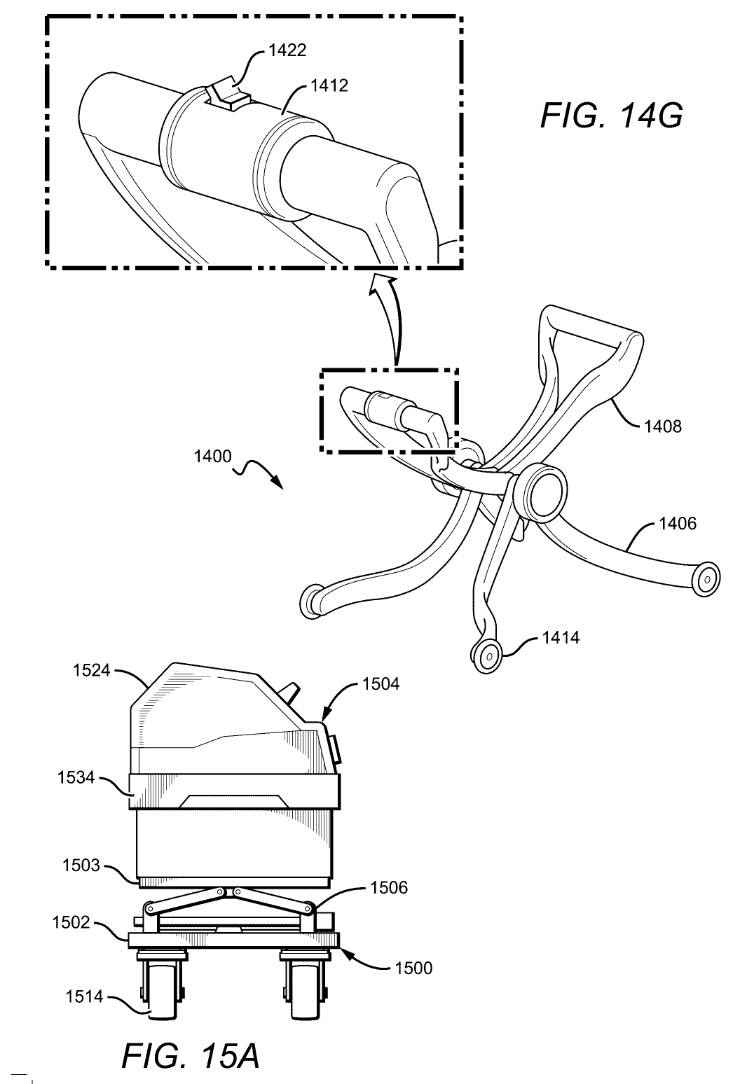

The inventor further contemplates a grill cart that can be deployed with one hand. A preferred embodiment is shown in FIG. 14. Cart 1400 comprises four legs 1406 having wheels 1414 and supports 1408. Legs 1406 and supports 1408 fold together (FIGS. 14A & D). To deploy the cart, the user grasps handle 1412, depresses button 1422 and twists handle 1412 (FIGS. 14B, E & G). The twisting of handle 1412 actuates the lifting of legs 1406 and extending of legs 1406 (e.g., via release of a cable lock). Once cart 1400 is deployed, grill 1404 can be placed on top and secured (FIGS. 14C & F). Like numerals refer to like structures.

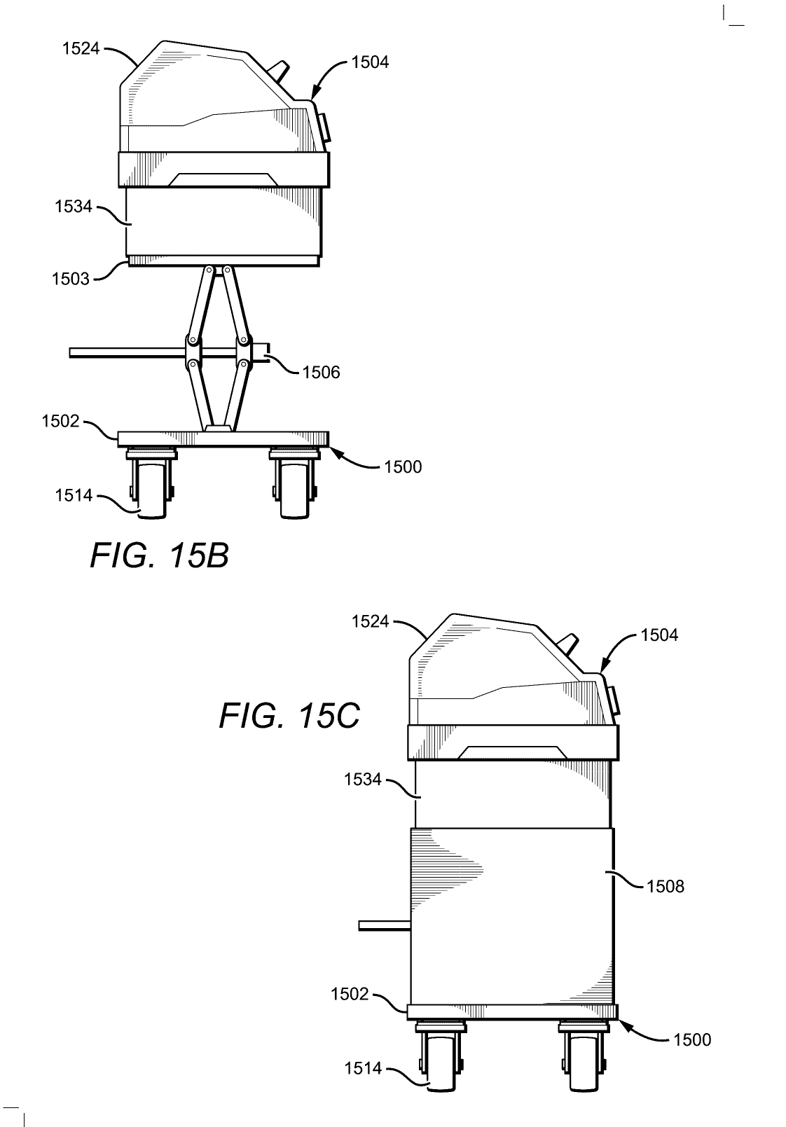

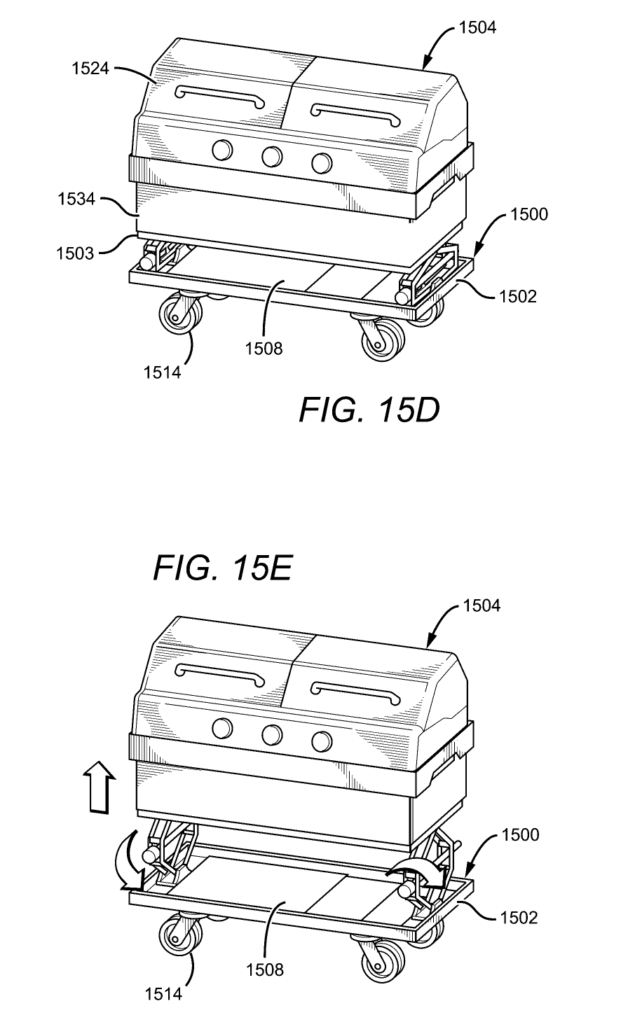

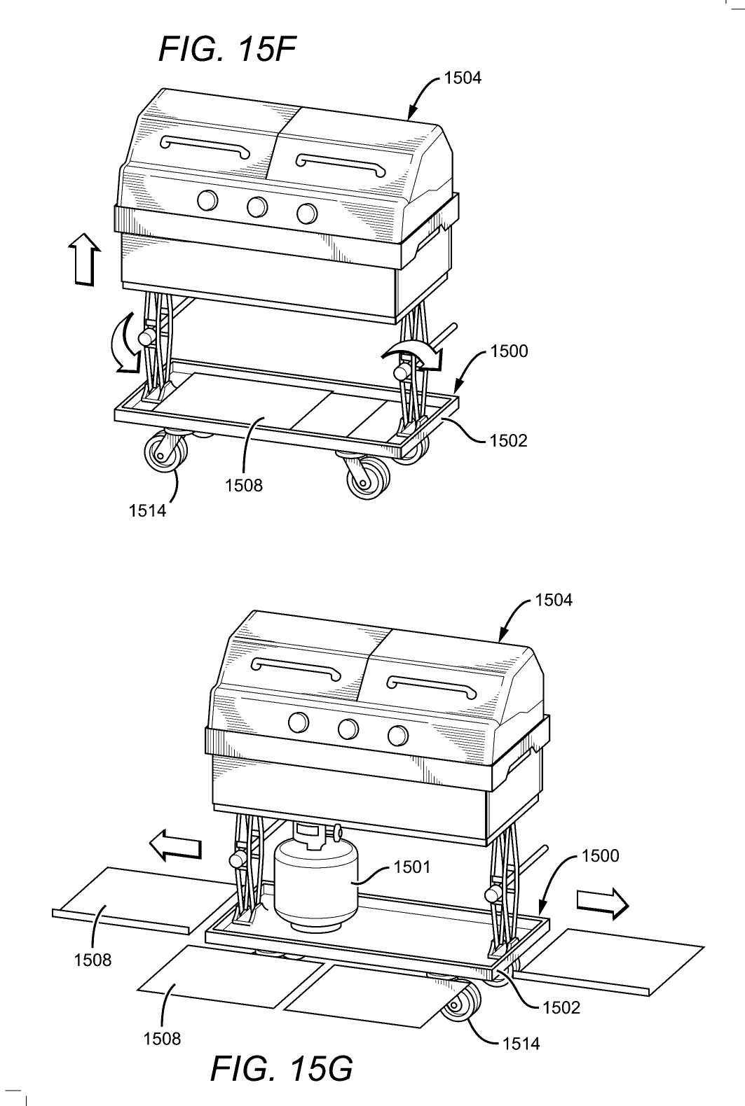

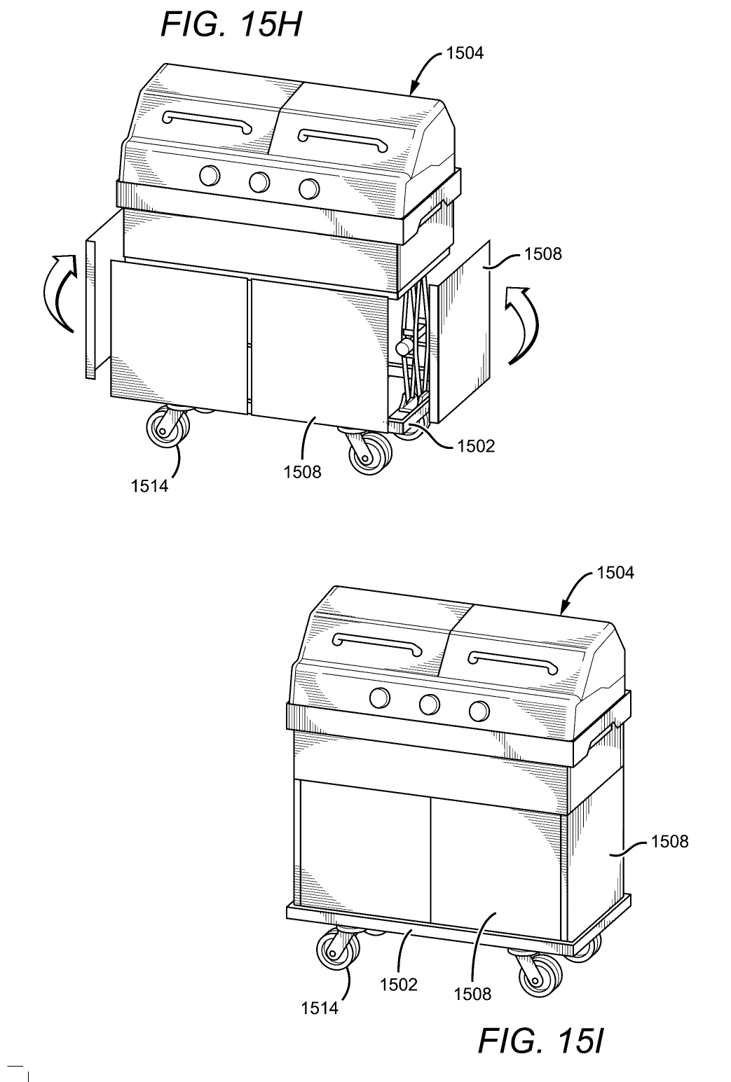

Yet another embodiment of the inventive subject matter is depicted in FIGS. 15A-151. Both grill 1504 (firebox base 1534 and hood 1524) can be raised from base frame 1502 using a car-jack-type mechanism 1506 (FIGS. 15A-B & D-G). As shown in FIG. 15E, a user twists knobs on jack 1506 to elevate grill 1504. Once grill 1504 is elevated, walls and doors 1508 can be installed (FIGS. 15C & G-I). FIG. 15G shows propane tank 1501 stowed in grill cart 1500. Side views of different stages of grill cart assembly are shown in FIGS. 15A-C. Like numerals refer to like structures.

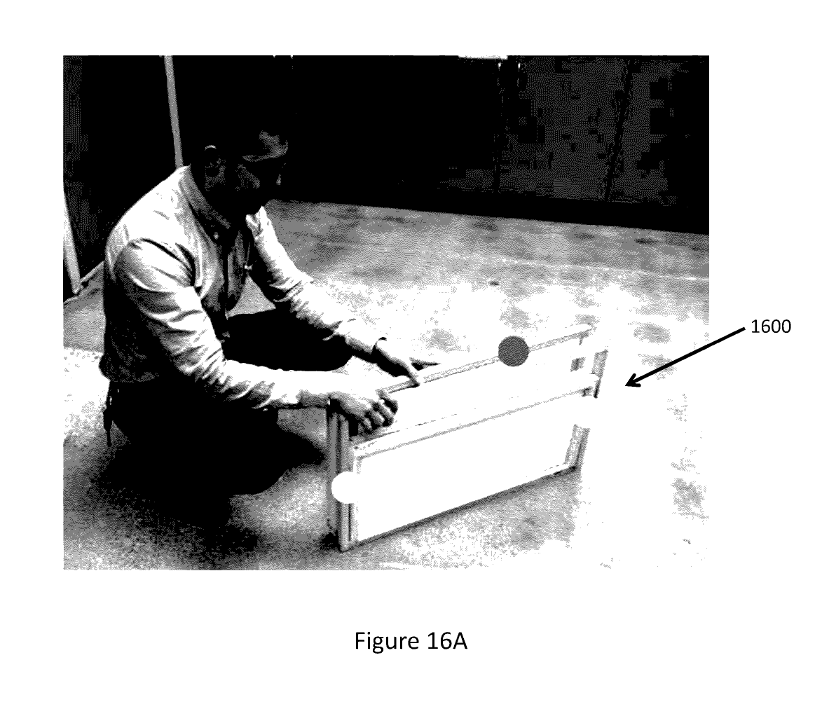

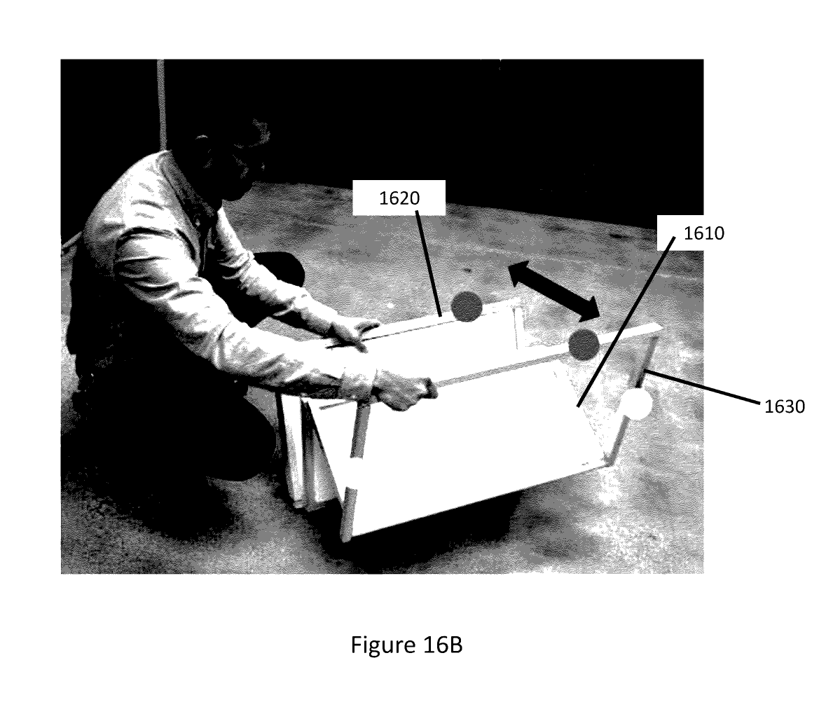

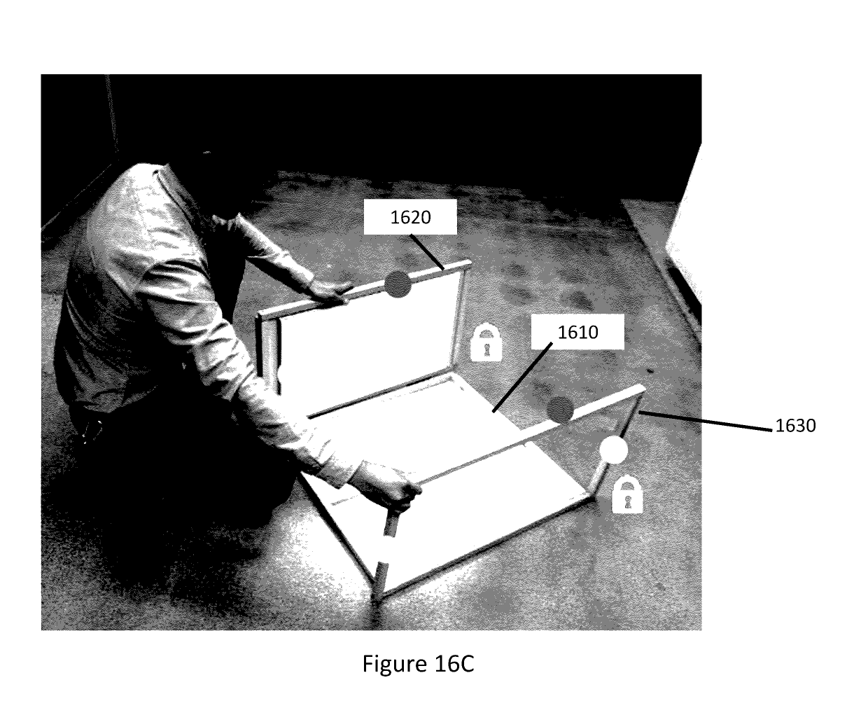

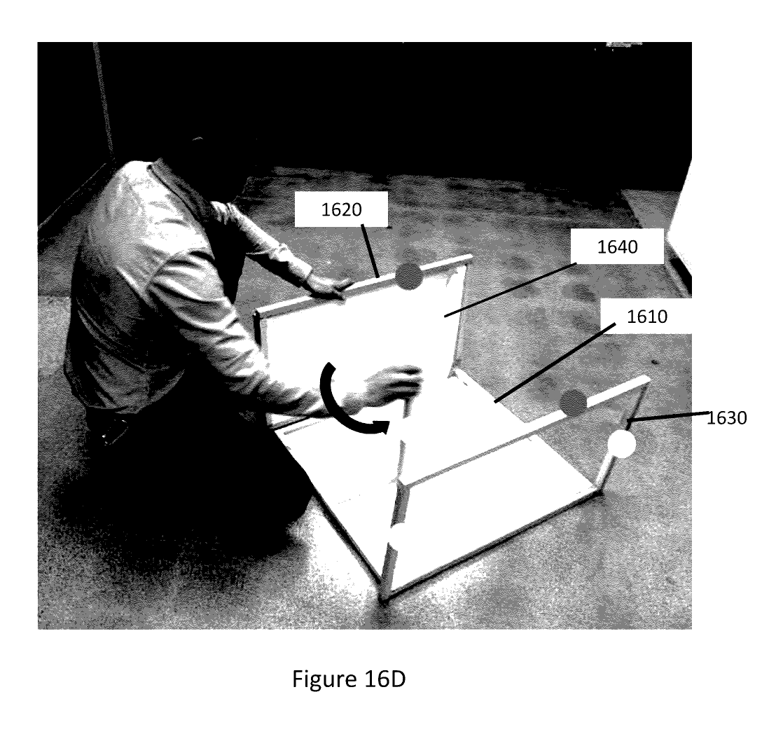

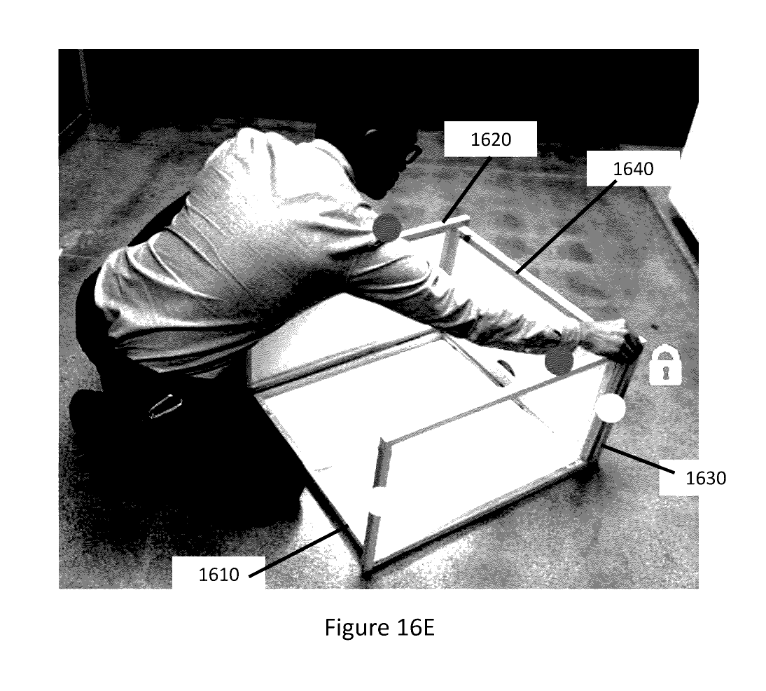

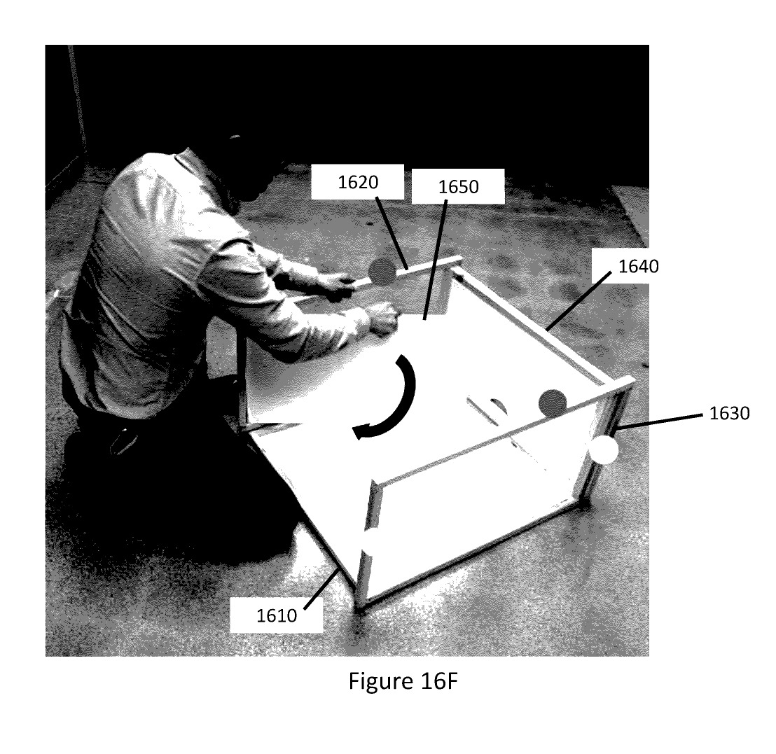

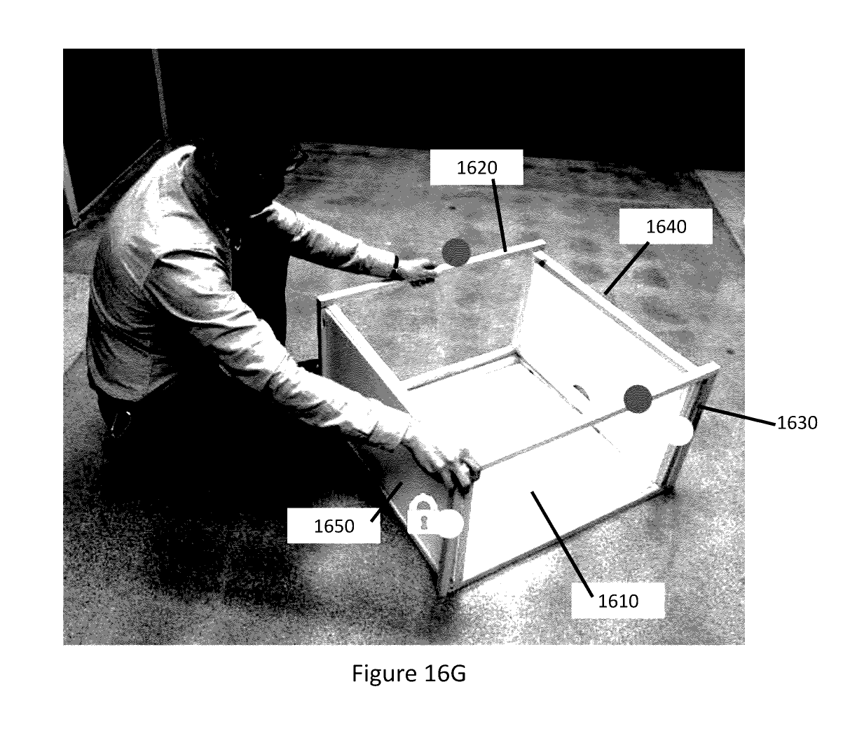

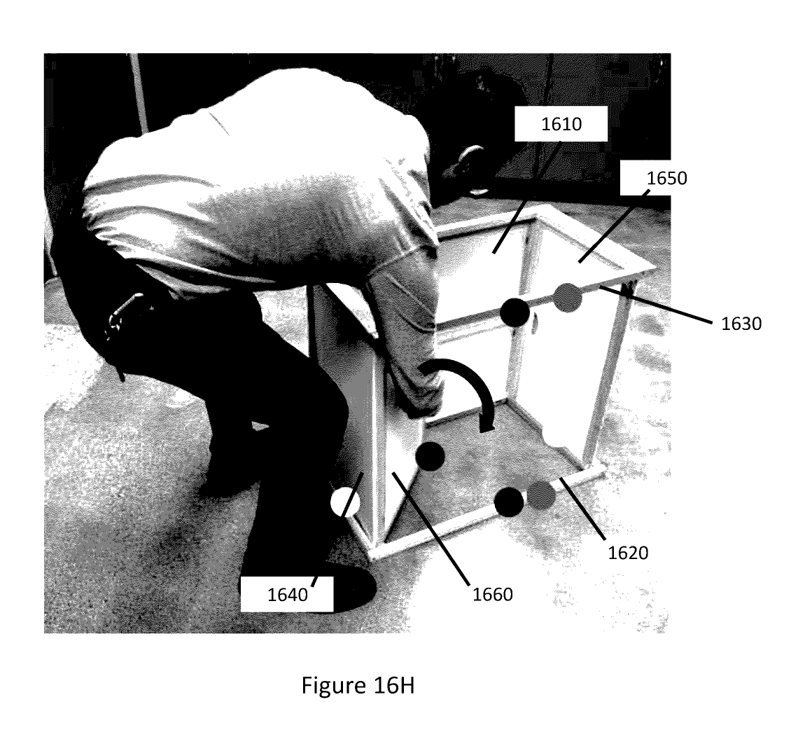

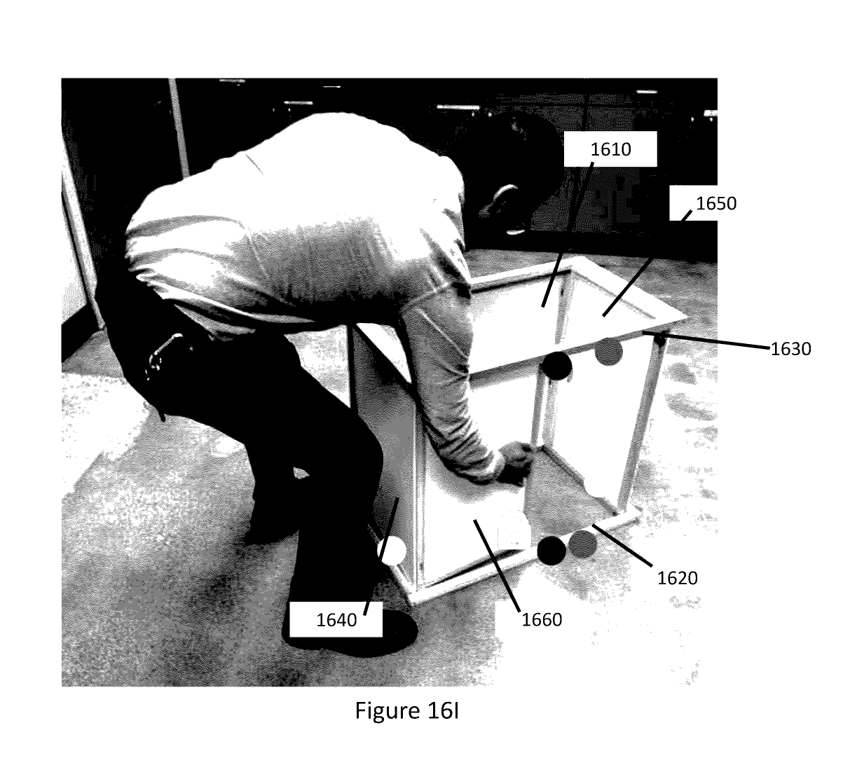

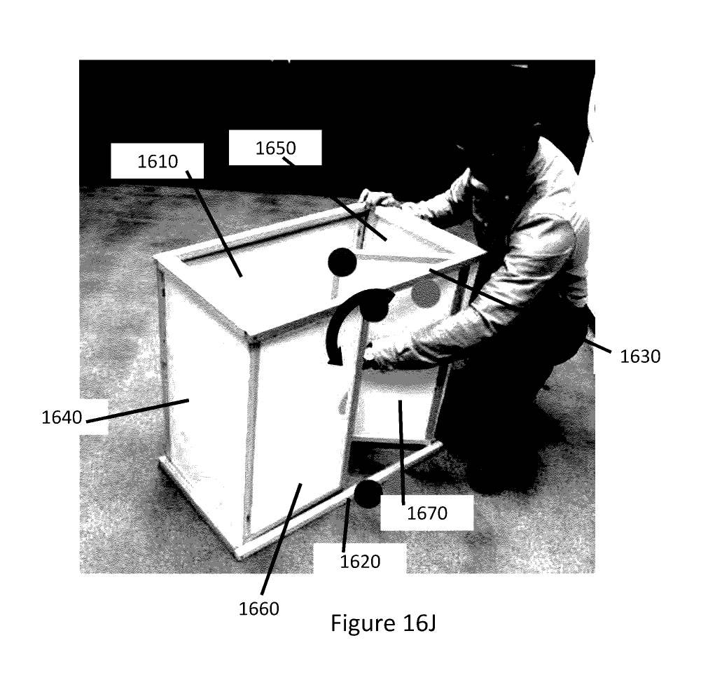

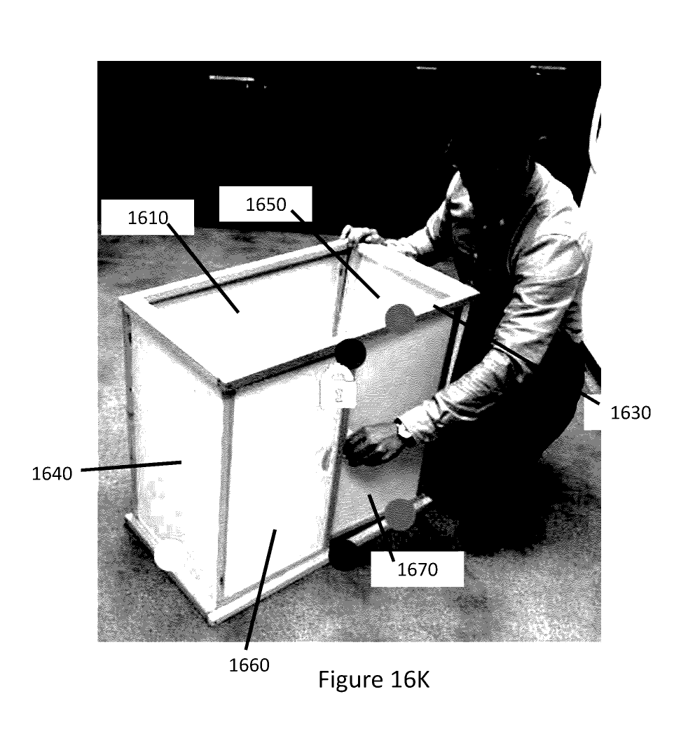

Another embodiment of the inventive subject matter, shown in FIGS. 16A to 16K, depicts a grill cart that is provided as a compact assembly that is readily transportable. As shown in FIG. 16A, the folded grill cart 1600 is highly compact, and can be stored and transported easily by a single user of average stature and fitness without the use of tools.

In an initial step of assembly (shown in FIG. 16B) the back 1610 of the cart is expanded, for example by unfolding at one or more hinges, and the base 1620 and top 1630 are rotated until they extend outwards. As shown in FIG. 16C, the back 1610 can be extended until it is essentially planar, at which point it can be secured or locked in this configuration. As shown in FIGS. 16A to 16K, the base 1620 and top 1630 are each pivotally coupled to opposing sides of the back 1610. The grill cart could include color coded labels (shown as shaded circles) disposed on different components or regions that help quickly guide a user through the assembly steps.

In FIG. 16D a first side 1640 is pivoted from its storage position adjacent to the base 1620. This first side 1640 can be positioned essentially perpendicular to the base 1620 and be secured in position, for example by securing it to the top 1630, as shown in FIG. 16E. The first side 1640 is shown as pivotally coupled to base 1620, but could alternatively be coupled to top 1630 and then secured to base 1620. It is contemplated that the first side 1640 could be automatically secured to base or top once in position via one or more latches and/or could be manually secured in place.

A second side 1650 can be similarly pivoted and secured as shown in FIGS. 16F and 16 G, respectively. As discussed above with respect to the first side 1640, the second side 1650 is shown as pivotally coupled to base 1620, but could alternatively be coupled to top 1630 and then secured to base 1620. The second side 1650 could be secured in place automatically once in position via one or more latches, manually secured in place, or a combination thereof.

Once secured in their expanded configuration, the partially assembled cart can be reoriented to position the top 1630 above the base 1620 and the back 1610 and sides 1640,1650 essentially perpendicular to the ground. At this point a first door 1660 that is coupled to first side 1640 can be pivoted and locked into position between a side (1640 or 1650) and the top 1630 and bottom 1620 of the partially assembled cart (see FIGS. 16H and 16I). As shown in FIGS. 16J and 16K, this action can be repeated with a second door 1670 that is coupled to second side 1650 positioned adjacent to the remaining side to provide an assembled grill cart. Thus, as shown in the figures, all of the first and second doors 1660, 1670, the first and second sides 1640, 1650, the top 1630 and the base 1620 are coupled directly or indirectly to the base 1620 at manufacturer, and only need to be rotated in place and secured to assembly the cart.

In some embodiments a grill or grill insert can be secured to the top of the assembled grill cart. In other embodiment a firebox, grill, and/or grill insert can form part of the cart assembly. For example, a lower surface of a firebox, grill, and/or grill insert can act as or be coupled to a top portion of such a folding grill cart assembly while it is in its folded state.

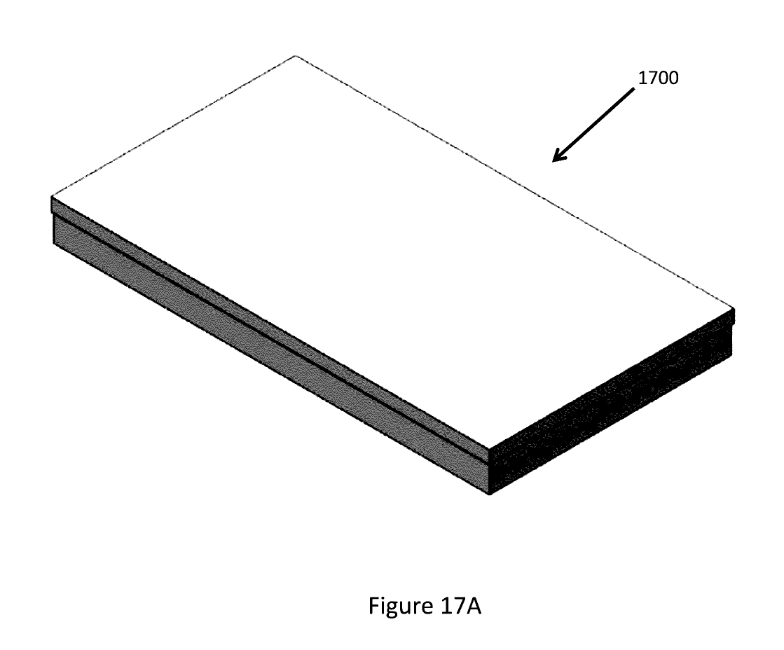

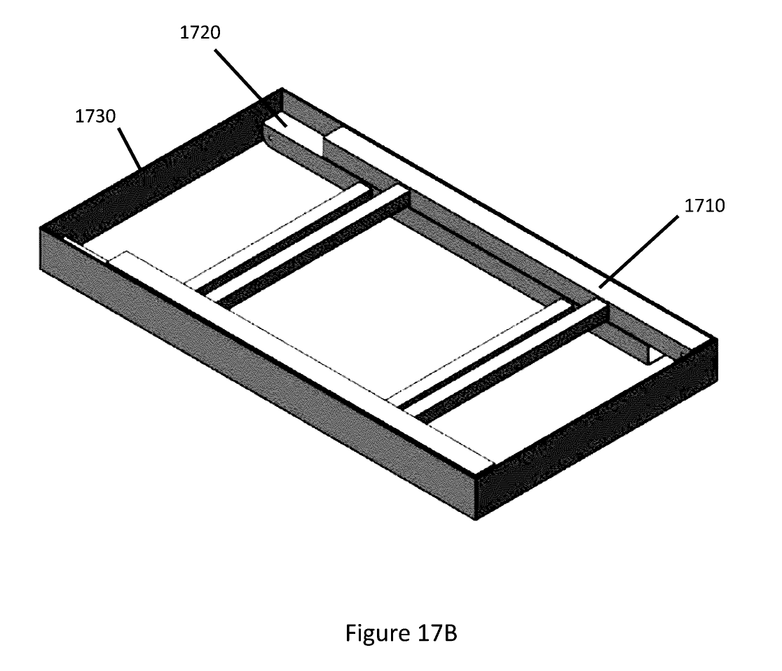

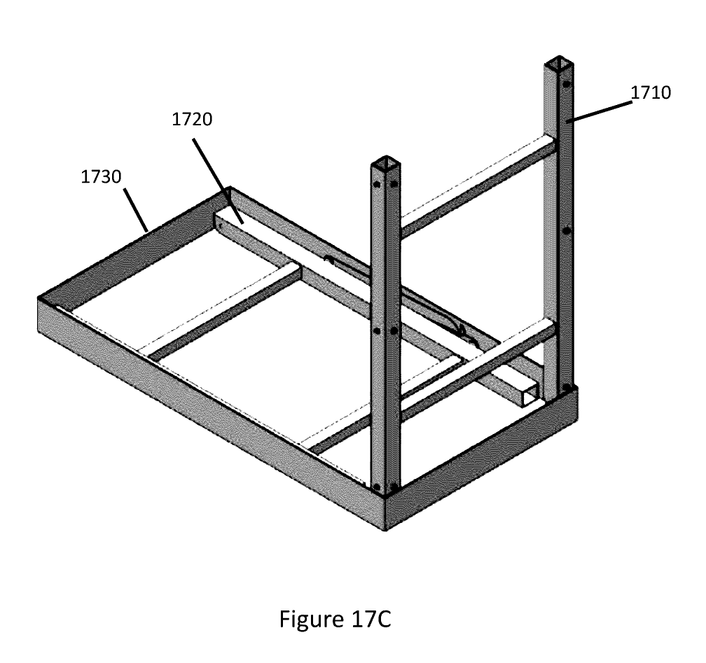

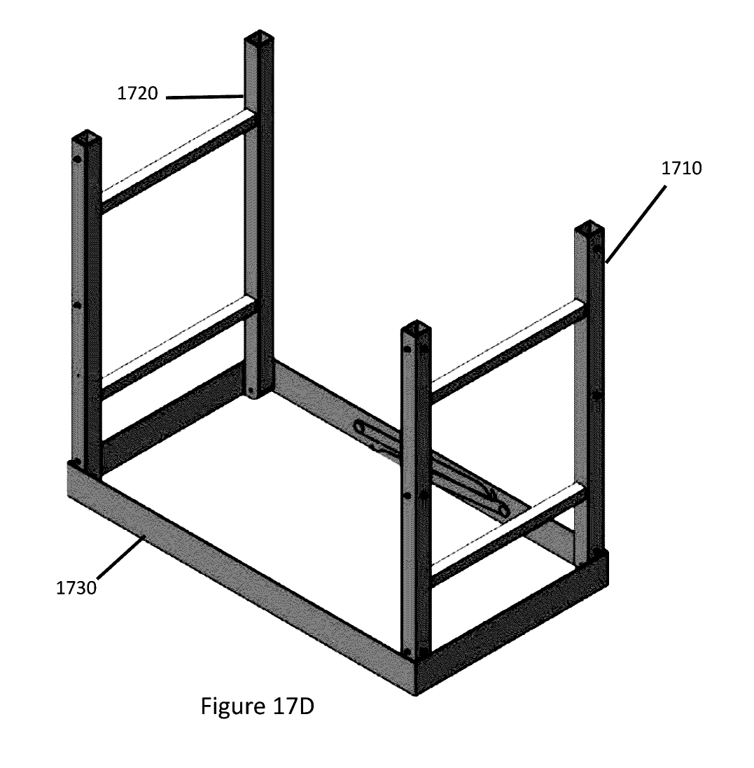

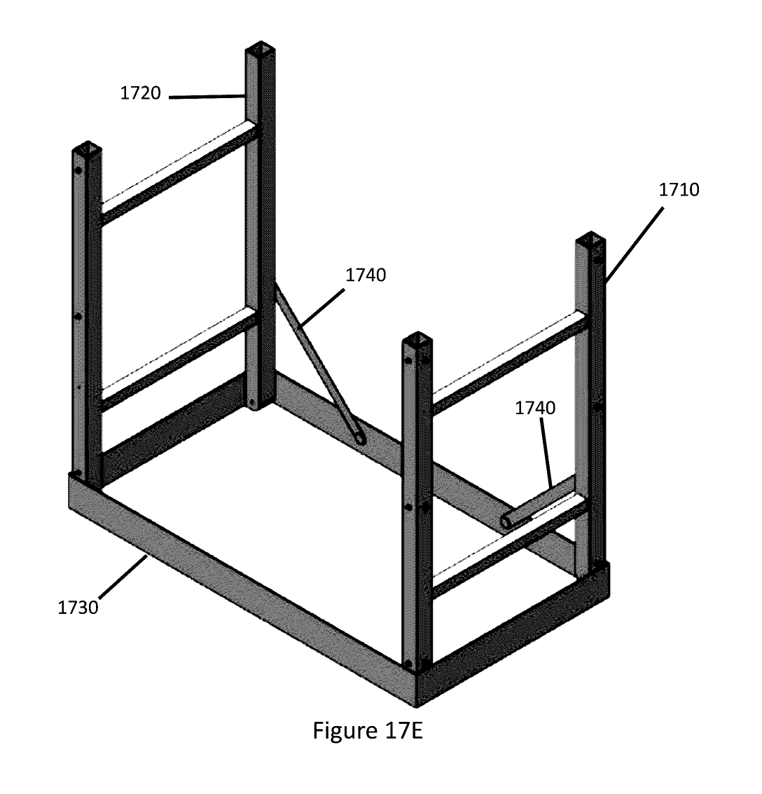

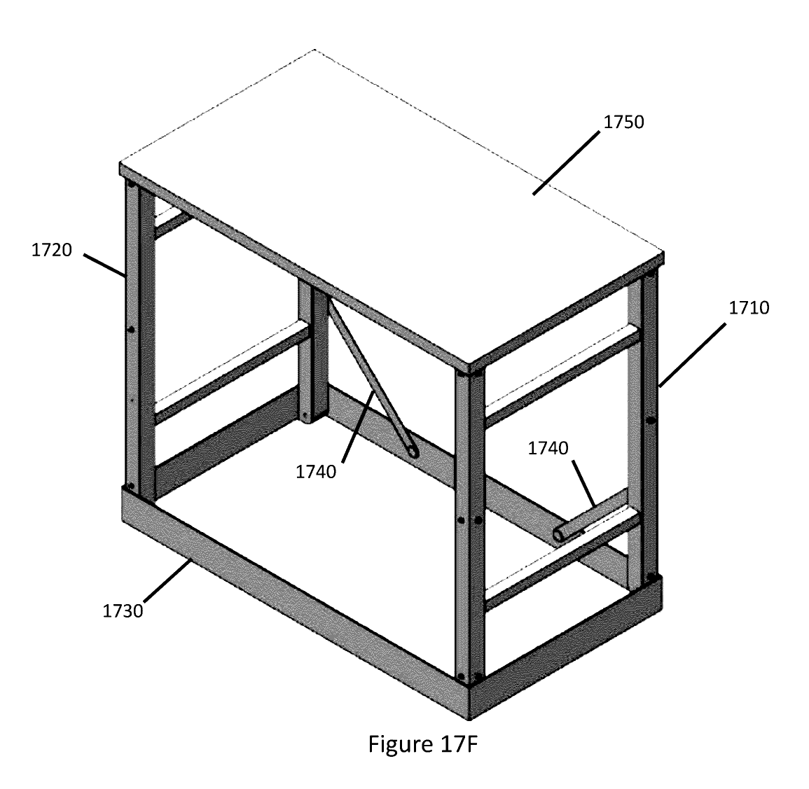

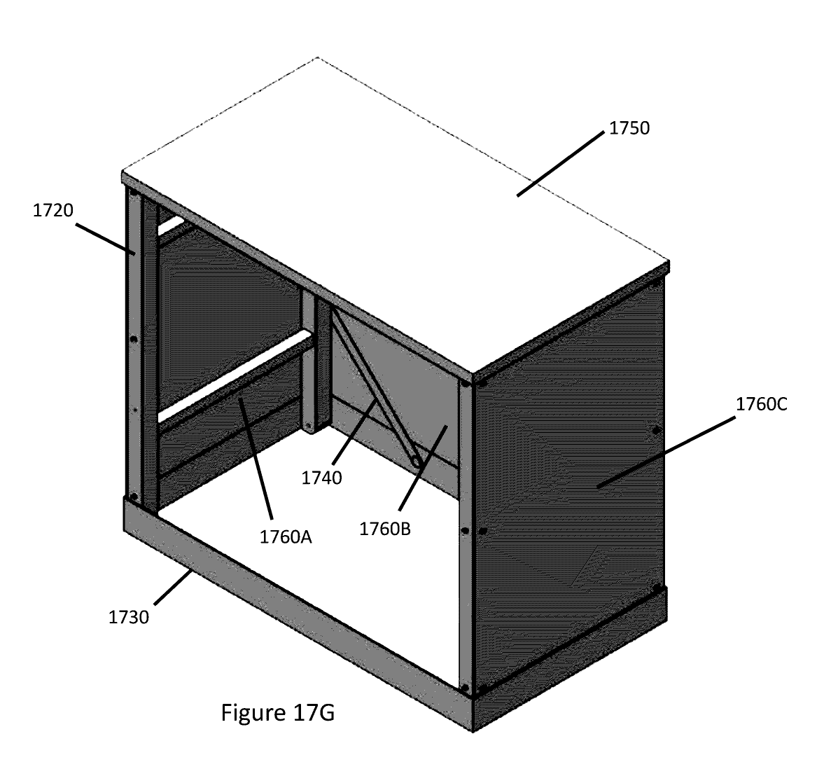

Another embodiment of the inventive subject matter is shown in FIGS. 17A to 17G. As shown in FIG. 17A, a folded grill cart assembly can be provided as a closed, compact unit 1700. Removal of a lid (not shown) exposes a first leg assembly 1710 and a second leg assembly 1720 that are coupled to a base 1730, as shown in FIG. 17B.

As shown in FIG. 17C in an initial step in assembling such a grill cart such a first leg assembly 1710 can be pivoted until it is essentially perpendicular to the base 1730. In a subsequent step (shown in FIG. 17D), the second leg assembly is similarly pivoted into position. The leg assemblies 1710 and 1720 can be stabilized by any suitable means, including friction, a ratchet assembly, or a brace. In a preferred embodiment, shown in FIG. 17E, the leg assemblies 1710, 1720 are stabilized by braces 1740. Such braces can, for example, have a pivoting end and a latching end that allow them to be rotated into position and coupled to either the base 1730 or a leg assembly 1710, 1720 (for example, by engaging a terminal hook on the brace with a protrusion on either the base 1730 or a leg assembly 1710, 1720). After the leg assemblies are stabilized a lid 1750 can be coupled to the free ends of the leg assemblies 1710, 1720 as shown in FIG. 17F. For example, a lid 1750 can include protrusions at the corners that partially enter or otherwise engage the leg assemblies 1710, 1720. In some embodiments, side panels 1760A, 1760B, 1760C can be coupled to the leg assemblies 1710, 1720, base 1730, and/or lid 1750 as shown in FIG. 17G. Such side panels can be coupled by any suitable means, including snaps (for example tinnerman snaps), clips, and hook and loop closures. In some embodiments the top 1750 can be incorporated into or coupled to a firebox, grill, and/or grill insert, for example by coupling to a bottom portion of the firebox, grill, and/or grill insert. In other embodiments the top 1750 can include features that provide attachments sites or otherwise stabilize a firebox, grill, and/or grill insert placed on top of the assembled grill cart.

In some embodiments of the inventive subject matter the grill cart can include one or more side table(s). Such a side table can slide outwards from the top portion of the cart. Alternatively, such a side table can pivot into position and be stabilized by a brace or similar mechanism. In embodiments where a firebox, grill, and/or grill insert forms part of the cart assembly such a side table can extend or pivot from a lower portion of the firebox, grill, and/or grill insert.

The exemplary embodiments of the inventive grill carts that have base frames show wheels installed on the base frames. It should be appreciated that the wheels may be removed from the base frames and stored within the collapsed grill cart for shipping and/or storage. Alternatively, wheels may be omitted entirely.

What is claimed is:

1. A collapsible cart system, comprising:
a back portion, wherein the back portion comprises opposing first and second ends, wherein the back portion further comprises first and second panels that are rotatably coupled to one another from a first position in which the first panel lies on top of the second panel to a second position in which the first and second panels are adjacent to one another along an edge;
a top portion having a third end rotatably coupled to the first end of the back portion;
a base portion having a fourth end, a fifth end, and a sixth end, wherein the fourth end is rotatably coupled to the second end of the back portion and the fifth end and the sixth end oppose one another;
a first side portion rotatably coupled to the fifth end; and
a second side portion rotatably coupled to the sixth end,
wherein the grill cart has (1) a folded configuration wherein the back portion, top portion, base portion, first side portion, and second side portion are essentially parallel to one another and (2) an expanded configuration wherein the base portion and the top portion oppose one another and the first side portion and second side portion oppose one another.

2. The collapsible cart system of claim 1, further comprising:
a first front portion rotatably coupled to the first side portion; and
a second front portion rotatably coupled to the second side portion.

3. The collapsible cart system of claim 2, further comprising a first door hingedly coupled to the first front portion, and a second door hingedly coupled to the second front portion.

4. The collapsible cart system of claim 3, wherein the top portion and the base portion are hingedly attached to the first and second ends of the back portion, respectively, wherein the first side portion is hingedly attached to the top portion and the first front portion is hingedly attached to the first side portion, wherein the second side portion is hingedly attached to the top portion and the second front portion is hingedly attached to the second side portion, and wherein the first door is hingedly attached to the first front portion and the second door is hingedly attached to the second front portion.

5. The collapsible cart system of claim 1, further comprising:
a first door rotatably coupled to the first side portion; and
a second door rotatably coupled to the second side portion.

6. The collapsible cart system of claim 1, further comprising a cooking unit.

7. The collapsible cart system of claim 6, wherein the cooking unit is selected from the group consisting of a grill, a grill insert, and a firebox.

8. The collapsible cart system of claim 6, wherein at the top portion comprises at least a portion of the cooking unit.

9. The collapsible cart system of claim 6, wherein the cooking unit comprises a lower surface, and wherein the lower surface is coupled to the top portion.

10. A collapsible grill cart, comprising:
a base portion comprising a first edge and a second edge, wherein the first edge and the second edge oppose one another;
a first frame comprising a first interface and a second interface, wherein the first interface is rotatably coupled to the first edge and the second interface opposes the first interface;
a second frame comprising a third interface and a fourth interface, wherein the third interface is rotatably coupled to the second edge and the third interface opposes the fourth interface;
a top portion configured to couple to the first frame at the second interface and to the second frame at the fourth interface;
a first side panel configured to couple to the first frame;
a second side panel configured to couple to the second frame; and
a back panel configured to couple to both the first frame and the second frame;
wherein the collapsible grill cart has (1) a first configuration in which the base portion, the first frame, the second frame, and the top portion are essentially parallel to one another and (2) a second configuration in which the top portion and the bottom portion oppose one another and the first frame and the second frame oppose one another.

11. The collapsible grill cart of claim 10, further comprising a first brace coupled to the first frame and the base portion.

12. The collapsible grill cart of claim 10, further comprising a second brace coupled to the second frame and the base portion.

13. The collapsible grill cart of claim 10, wherein the first and second side panels are coupled to the first and second frames, respectively, by a coupling device selected from the group consisting of a snap, a clip, and a hook and loop closure.

14. The collapsible grill cart of claim 10, wherein the back panel is coupled to the first frame and the second frame by a coupling device selected from the group consisting of a snap, a clip, and a hook and loop closure.

15. The collapsible grill cart of claim 10, further comprising a first door rotatably coupled to the first frame.

16. The collapsible grill cart of claim 10, further comprising a second door rotatably coupled to the second frame.

17. The collapsible grill cart of claim 10, further comprising a cooking unit selected from the group consisting of a grill, a grill insert, and a firebox.

18. The collapsible grill cart of claim 17, wherein the top portion comprises at least a portion of the cooking unit.

19. The collapsible grill cart of claim 17, wherein the cooking unit comprises a lower surface, and wherein the lower surface is coupled to the top portion.

20. The collapsible grill cart of claim 9, wherein the base portion further comprises two or more wheels.
